(19) United States
(12) Patent Application Publication
(10) Pub. No.: US 2025/0268950 A1
(43) Pub. Date: Aug. 28, 2025

(54) PRENATAL SUPPLEMENT

(71) Applicant: Arizona Board of Regents on Behalf of Arizona State University, Tempe, AZ (US)

(72) Inventors: James Adams, Tempe, AZ (US); Jacob Sorenson, Mesa, AZ (US); Elena Pollard, Colorado Springs, CO (US); Jasmine Kirby, Mesa, AZ (US)

(73) Assignee: Arizona Board of Regents on Behalf of Arizona State University, Tempe, AZ (US)

(21) Appl. No.: 18/701,114

(22) PCT Filed: Oct. 12, 2022
(86) PCT No.: PCT/US2022/046455

§ 371 Date: Apr. 12, 2024

Related U.S. Application Data
(60) Provisional application No. 63/254,855, filed on Oct. 12, 2021.

(51) Int. Cl. A61K 35/60; A61K 31/05; A61K 31/07; A61K 31/10; A61K 31/122; A61K 31/14; A61K 31/198; A61K 31/202; A61K 31/355; A61K 31/375; A61K 31/4188; A61K 31/4406; A61K 31/4415; A61K 31/51; A61K 31/525; A61K 31/593; A61K 31/714; A61K 33/04; A61K 33/10; A61K 33/14; A61K 33/18; A61K 33/26; A61K 33/30; A61K 33/34; A61P 3/02

(52) U.S. Cl. CPC A61K 35/60; A61K 31/05; A61K 31/07; A61K 31/10; A61K 31/122; A61K 31/14; A61K 31/198; A61K 31/202; A61K 31/355; A61K 31/375; A61K 31/4188; A61K 31/4406; A61K 31/4415; A61K 31/51; A61K 31/525; A61K 31/593; A61K 31/714; A61K 33/04; A61K 33/10; A61K 33/14; A61K 33/18; A61K 33/26; A61K 33/30; A61K 33/34; A61P 3/02

(57) ABSTRACT

Dietary supplement compositions and methods of use thereof in subjects who are pregnant, trying to become pregnant, nursing and/or lactating are provided.

### CROSS REFERENCE TO RELATED APPLICATIONS

The present application claims priority to and benefit of U.S. Provisional Patent Application No. 63/254,855, filed Oct. 12, 2021, the entire content of which are hereby incorporated by reference.

### FIELD OF THE INVENTION

The present disclosure provides dietary supplement compositions and methods of use thereof for subjects who are pregnant, trying to become pregnant, nursing and/or lactating.

### BACKGROUND OF THE INVENTION

Vitamins and certain minerals are essential for optimal health and development, and, a deficiency of any one vitamin can lead to chronic illness and even death in some cases. Although a diet rich in vegetables, fruits, whole grains, protein, and healthy fats can provide sufficient amounts of most vitamins, many people in the US do not consume an adequate diet. Nutritional needs in pregnancy increase and many pregnant women are at even higher risk of not consuming a diet sufficiently rich in essential nutrients to support optimal health of both mother and developing fetus. The levels of many vitamins decrease during pregnancy in the absence of supplements, with supplements of vitamins A, C, D, K, B1, B3, B5, B6, folate, biotin, and B12 being of special importance. Similarly, the levels of many essential minerals decrease during pregnancy if un-supplemented, including calcium, iron, magnesium, selenium, zinc, and possibly chromium and iodine. Prenatal supplements can reduce the risk of many pregnancy complications and infant health problems. More specifically, prenatal vitamin supplements may help to lower the risk of autism in children, even in mothers or families identified as high-risk. Studies have shown that prenatal vitamin supplements including folate (as folic acid), significantly lower the risk of developing autism spectrum disorder (ASD).

The possible advantages of prenatal dietary supplements including other components to reduce the risk of autism are not yet fully understood.

### SUMMARY OF THE INVENTION

One aspect of the present disclosure encompasses a nutritional supplement comprising a) at least two vitamins selected from: preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol and at least two minerals selected from: calcium, chromium, copper, iodine, iron, magnesium, manganese, molybdenum, selenium, and zinc; or (b) a sulfur containing compound, a carnitine, and/or lithium, and, optionally, at least one vitamin selected from preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol.

Another aspect of the present disclosure provides a nutritional supplement comprising (a) at least three vitamins selected from Vitamin C, Vitamin E, choline, DHA, inositol, Vitamin B3 (niacin/niacinamide), pantothenic acid, and Vitamin B6, and at least three minerals selected from calcium, magnesium, iron, and zinc; or (b) at least three vitamins selected from vitamin A, beta carotene, riboflavin, Vitamin D, thiamine, Vitamin K, biotin, folate, Vitamin B12 and at least three minerals selected from copper, iodine, manganese, chromium, molybdenum, and selenium. In one aspect, the nutritional supplement is provided as a pair of dosage forms comprising a first dosage form comprising (a) and a second dosage form comprising (b).

In another aspect, a nutritional supplement is provided comprising: (a) at least two vitamins selected from Vitamin C, choline, DHA, inositol and at least one mineral selected from calcium and magnesium; or (b) at least two vitamins selected from thiamine, Vitamin B3 (niacin/niacinamide), pantothenic acid, Vitamin B6, Vitamin A, beta carotene, riboflavin, Vitamin E and at least two minerals selected from iron, zinc, copper, and manganese; or (c) at least two vitamins selected from Vitamin D, Vitamin K, biotin, folate, Vitamin B12 and at least two minerals selected from chromium, iodine, molybdenum, and selenium. In one aspect, the nutritional supplement is provided as a triplet of dosage forms comprising a first dosage form comprising (a), a second dosage form comprising (b) and a third dosage form comprising (c).

In various aspects, a nutritional supplement provided herein may comprise: (a) preformed vitamin A, vitamin C, vitamin D, Vitamin E, Vitamin K, Vitamin B6, Vitamin B12, beta carotene, thiamine, riboflavin, Vitamin B3 (niacin/niacinamide), niacin, pantothenic acid, biotin, folate/folinic acid, choline, DHA, and inositol, calcium, chromium, copper, iodine, iron, magnesium, manganese, molybdenum, selenium, zinc and, optionally, DHA; or (b) Vitamin C, choline, inositol, Vitamin B3 (niacin/niacinamide), pantothenic acid, Vitamin B6, Vitamin E, calcium, magnesium, iron, zinc, and optionally DHA; or (c) preformed Vitamin A, beta carotene, thiamine, riboflavin, Vitamin D, Vitamin K, biotin, folate/folinic acid, Vitamin B12, copper, manganese, chromium, molybdenum, iodine, and selenium; or (d) Vitamin C, choline, inositol, calcium, magnesium, and, optionally, DHA; or (e) thiamine, Vitamin B3 (niacin/niacinamide), pantothenic acid, Vitamin B6, preformed Vitamin A, Vitamin E, beta carotene, riboflavin, iron, zinc, copper, and manganese; or (f) Vitamin D, Vitamin K, biotin, folate/folinic acid, Vitamin B12, chromium, molybdenum, iodine, and selenium. In various aspects, the nutritional supplement comprises at least one dosage form comprising any one of (a), (b). (c), (d), (e), or (f).

In various aspects, a nutritional supplement provided herein may comprise a sulfur containing compound, a-carnitine, and lithium. In various aspects, the sulfur containing compound may comprise n-acetylcysteine, sulforaphane, methyl-sufonyl-methane (MSM), thiamine tetrahydrofurfuryl disulfide (TTFD), benfotiamine, S-allyl cysteine, Epsom salts, or any combination thereof. In one aspect, the sulfur containing compound is present at a concentration of about 100 mg to about 1000 mg. In one aspect, the carnitine may comprise L-carnitine or acetyl-L-carnitine and/or may be present at a concentration of about 100 mg to about 2000 mg. In one aspect, the lithium may be present at a concentration of about 100 mcg to about 500 mcg. In one aspect, the nutritional supplement further comprises least one vitamin selected from preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol.

In various aspects, any of the nutritional supplements as disclosed herein may comprise any combination of MSM, N-acetylcysteine, and/or lithium.

According to another aspect of the present disclosure, a nutritional supplement as provided comprises from about 1000 to about 10000 IU of preformed Vitamin A, Beta carotene, and/or Vitamin D. For example. In one aspect, the nutritional supplement comprises about 4000 IU (1200 mcg) or about 1666 IU (about 500 mcg) of preformed Vitamin A, about 3333 IU (2000 mcg), 1666 IU (1000 mcg), or 2500 IU (1500 mcg) of Beta Carotene, and/or about 2000 IU (about 50 mcg), of Vitamin D.

According to another aspect of the present disclosure, a nutritional supplement is provided comprising from about 100 to about 1000 mg of DHA, Inositol, and/or choline. For example, a nutritional supplement provided herein may comprise about 500 mg or 600 mg of DHA, about 500 mg of Inositol, and/or about 350 mg or 600 mg of choline. In yet another aspect of the instant disclosure, a nutritional supplement provided herein may comprise inositol in an amount far more than 150 mg. In yet another aspect of the instant disclosure, a nutritional supplement provided herein may comprise inositol in any amount from about 100 mg to about 5000 mg. In yet another aspect of the instant disclosure, a nutritional supplement provided herein may comprise inositol in any amount from about 200 mg to about 5000 mg. In yet another aspect of the instant disclosure, a nutritional supplement provided herein may comprise inositol in any amount from about 200 mg to about 4000 mg. In yet another aspect of the instant disclosure, a nutritional supplement provided herein may comprise inositol in any amount from about 200 mg to about 3000 mg. In yet another aspect of the instant disclosure, a nutritional supplement provided herein may comprise inositol in any amount from about 200 mg to about 2500 mg. In yet another aspect of the instant disclosure, a nutritional supplement provided herein may comprise inositol in any amount from about 200 mg to about 2000 mg. In yet another aspect of the instant disclosure, a nutritional supplement provided herein may comprise inositol in any amount from about 200 mg to about 1500 mg. In yet another aspect of the instant disclosure, a nutritional supplement provided herein may comprise inositol in any amount from about 200 mg to about 1000 mg. In yet another aspect of the instant disclosure, a nutritional supplement provided herein may comprise inositol in any amount from about 200 mg to about 500 mg. In yet another aspect of the instant disclosure, a nutritional supplement provided herein may comprise inositol in an amount of about 214 mg, about 222 mg, about 250 mg, about 260 mg, about 270 mg, about 278 mg, about 280 mg, about 286 mg, about 290 mg, about 300 mg, about 320 mg, about 340 mg, about 360 mg, about 380 mg, about 400 mg, about 420 mg, about 440 mg, about 460 mg, about 480 mg, or about 500 mg.

In yet another aspect of the instant disclosure, a nutritional supplement provided herein may comprise MSM in any amount from about 50 to about 1000 mg, and/or n-acetylcysteine in any amount from about 20 mg-200 mg, and/or lithium in any amount from about 20 mcg to about 1000 mcg.

According to yet another aspect of the instant disclosure, a nutritional supplement is provided comprising from about 50 mcg to about 1000 mcg of Folate and/or Biotin. For example, a nutritional supplement provided herein may comprise about 400 mcg or 600 mcg of Folate and/or about 50 mcg or 100 mcg of Biotin. In any of the supplements herein, it should be understood that Folate may comprise or consist of activated folate, folinic acid, folic acid, or any combination thereof. In one aspect, Folate (in any form) is naturally occurring. In another aspect, the Folate is synthetic. In another aspect, the Folate is formulated to reduce gastrointestinal irritation. In yet another aspect of the instant disclosure, activated folate may comprise Calcium L-5-Methyltetrahydrofolate (5-MTHF). In yet another aspect, a nutritional supplement provided herein may comprise 5-MTHF in the amount of 267 mcg dietary folate equivalents (DFE) or about 156.9 mcg folic acid. In one aspect, a nutritional supplement comprises about 50 mcg to about 1000 mcg folinic acid. For example, a nutritional supplement provided herein may comprise about 100 mcg or about 200 mcg of folinic acid. In one aspect, a nutritional supplement comprises about 200 mcg to about 400 mcg folinic acid. For example, a nutritional supplement provided herein may comprise about 300 mcg or 500 mcg of folinic acid. In one aspect, a nutritional supplement comprises about 400 mcg to about 600 mcg folinic acid. For example, a nutritional supplement provided herein may comprise about 600 mcg or 700 mcg of folinic acid. In one aspect, a nutritional supplement comprises about 800 mcg to about 900 mcg folinic acid. For example, a nutritional supplement provided herein may comprise about 900 mcg or 1000 mcg of folinic acid.

In another aspect, a nutritional supplement provided herein may comprise about 100 to 1000 mg of Vitamin C. For example. In one aspect, the nutritional supplement may comprise about 100 mg, about 150 mg, about 175 mg, or about 200 mg of Vitamin C.

In another aspect, a nutritional supplement provided herein comprises about 10 to 100 mcg of Biotin, Vitamin K, and/or Vitamin B12. For example, the nutritional supplement may comprise about 50 mcg or 100 mcg of Biotin, about 60 mcg or about 90 mcg of Vitamin K, and/or about 18 mcg, about 24 mcg, about 25 mcg or about 36 mcg of Vitamin B12.

In yet another aspect, a nutritional supplement provided herein may comprise about 1 to 50 IU (about 0.67 mg to about 33.5 mg) of Vitamin E. For example, the nutritional supplement may comprise about 15 mg, about 16 mg, about 19 mg, or about 20 mg of Vitamin E.

In another aspect, a nutritional supplement provided herein may comprise about 1 to 50 mg of Pantothenic acid, vitamin B6, Thiamine, Riboflavin, and/or Vitamin B3 (niacin/niacinamide). For example, a nutritional supplement may comprise about 1 to 10 mg of pantothenic acid, vitamin B6, thiamine, and/or riboflavin and/or about 15 to 50 mg of Vitamin B3 (niacin/niacinamide). In another example, a nutritional supplement may comprise about 7 mg or 10 mg of pantothenic acid, about 10 mg of vitamin B6, about 1.4 mg or about 6 mg of thiamine, about 1.4 mg or about 2 mg of riboflavin and/or about 18 mg, about 30 mg, 35 mg or about 40 mg of Vitamin B3 (niacin/niacinamide.

In another aspect, a nutritional supplement provided herein may comprise about 100 to 1000 mg of calcium and/or about 100 to 1000 mg of magnesium. For example, the nutritional supplement may comprise about 200 mg, about 325 mg, about 425 mg, about 525 mg, or about 550 mg of calcium, about/or about 140 mg, about 180 mg, about 260 mg, or about 350 mg of magnesium.

In another aspect, a nutritional supplement provided herein may comprise about 10 to 100 mg of iron and/or about 10 to 100 mg zinc. For example, the nutritional supplement may comprise about 25 mg, about 30 mg, about 45 mg, or about 60 mg iron and/or about 10 mg, about 20 mg, about 25 mg, or about 30 mg of zinc.

In still another aspect, a nutritional supplement provided herein may comprise about 0.5 to 5 mg of copper and/or about 0.5 to 5 mg manganese. For example, the nutritional supplement may comprise about 0.5 mg, about 1.1 mg, about 1.2 mg, or about 1.3 mg of copper and/or about 1 mg of manganese.

In various aspects, the nutritional supplement provided herein may comprise about 10 to 500 mcg of chromium, about 10 to 500 mcg of molybdenum, about 10 to 500 mcg of selenium, and/or about 10 to 500 mcg of iodine. For example, the nutritional supplement may comprise about 50 mcg or 100 mcg of chromium, about 25 mcg of molybdenum, about 50 mcg, about 60 mcg or about 70 mcg of selenium, and/or about 150 or 220 mcg of iodine.

In any of the aspects provided herein, the nutritional supplement may comprise:
(I):
   (a) a single dosage form comprising at least two of the following: about 4000 IU (1200 mcg) or about 1666 IU (about 500 mcg) of preformed vitamin A, about 100 mg, about 150 mg, about 175 mg, or about 200 mg of vitamin C, about 2000 IU (about 50 mcg) of Vitamin D, about 15 mg, about 16 mg, about 19 mg, or about 20 mg of Vitamin E, about 60 mcg or about 90 mcg of Vitamin K, about 10 mg of Vitamin B6, about 25 mcg or about 36 mcg of Vitamin B12, about 3333 IU (about 2000 mcg), about 1666 IU (about 1000 mcg) or about 2500 IU (1500 mcg) of beta carotene, about 1.4 mg or about 6 mg of thiamine, about 1.4 mg or about 2 mg of riboflavin, 18 mg, about 30 mg. 35 mg or about 40 mg of Vitamin B3 (niacin/niacinamide), about 7 mg or 10 mg of pantothenic acid, about 50 mcg or about 100 mcg of biotin, about 400 mcg or 600 mcg of folate/folinic acid, about 350 mg or 600 mg of choline, about 500 mg or 600 mg of DHA, about 500 mg of inositol, about 200 mg, about 325 mg, about 425 mg, about 525 mg, or about 550 mg of calcium, about 50 mcg or 100 mcg of chromium, about 1.3 mg of copper, about 150 mcg or 220 mcg of iodine, about 25 mg, about 30 mg, about 45 mg, or about 60 mg of iron, about 140 mg, about 180 mg, about 260 mg, or about 350 mg of magnesium, about 1 mg of manganese, about 25 mcg of molybdenum, about 60 mcg or about 70 mcg of selenium, and about 10 mg, about 20 mg, about 25 mg, or about 30 mg of zinc; or
(II) a pair of dosage forms comprising:
   (b) a first dosage form comprising at least two of the following: about 100 mg, about 150 mg, about 175 mg, or about 200 mg of Vitamin C, about 350 mg or 600 mg of choline, about 500 or 600 mg of DHA, about 500 mg of inositol, about 18 mg, about 30 mg, 35 mg or about 40 mg of Vitamin B3 (niacin/niacinamide), about 15 mg, about 16 mg, about 19 mg, or about 20 mg of Vitamin E, about 7 mg or 10 mg of pantothenic acid, about 10 mg of Vitamin B6, about 200 mg, about 325 mg, about 425 mg, about 525 mg, or about 550 mg of calcium, about 140 mg, about 180 mg, about 260 mg, or about 350 mg of magnesium, about 25 mg, about 30 mg, about 45 mg, or about 60 mg of iron, and about 10 mg, about 20 mg, about 25 mg, or about 30 mg of zinc; and
   (c) a second dosage form comprising at least two of the following: about 4000 IU (1200 mcg) or about 1666 IU (about 500 mcg) of preformed Vitamin A, about 3333 IU (about 2000 mcg), about 1666 IU (about 1000 mcg) or about 2500 IU (1500 mcg) of beta carotene, about 1400 mcg (1.4 mg) or about 6000 mcg (6 mg) of thiamine, about 1400 mcg (1.4 mg) or 2000 mcg (2 mg) of riboflavin, about 2000 IU (about 50 mcg) of Vitamin D, about 60 mcg or about 90 mcg of Vitamin K, about 50 mcg or about 100 mcg of biotin, about 400 mcg or about 600 mcg of folate/folinic acid, about 25 mcg or about 36 mcg of Vitamin B12, about 1300 mcg (1.3 mg) of copper, about 1000 mcg (1 mg) of manganese, about 50 mcg or about 100 mcg of chromium, about 25 mcg of molybdenum, about 150 or about 220 mcg of iodine, and about 60 mcg or about 70 mcg of selenium; or
(III) a triplet of dosage forms comprising:
   (d) a first dosage form comprising about 100 mg, about 150 mg, about 175 mg, or about 200 mg of Vitamin C, about 350 mg or 600 mg of choline, about 500 or 600 mg of DHA, about 500 mg of inositol, about 200 mg, about 325 mg, about 425 mg, about 525 mg, or about 550 mg of calcium, and about 140 mg, about 180 mg, about 260 mg, or about 350 mg of magnesium; or
   (e) a second dosage form comprising about 1.4 mg or about 6 mg of thiamine, about 18 mg, about 30 mg, 35 mg or about 40 mg of Vitamin B3 (niacin/niacinamide), about 7 mg or about 10 mg of pantothenic acid, about 10 mg of Vitamin B6, about 4000 IU (1.2 mg) or about 1666 IU (about 0.5 mg) preformed Vitamin A, about 3333 IU (about 2000 mcg), about 1666 IU (about 1000 mcg) or about 2500 IU (1500 mcg) beta carotene, about 15 mg, about 16 mg, about 19 mg, or about 20 mg of Vitamin E, about 1.4 mg or about 2 mg of riboflavin, about 25 mg, about 30 mg, about 45 mg, or about 60 mg of iron, about 10 mg, about 20 mg, about 25 mg, or about 30 mg of zinc, about 1.3 mg of copper, and about 1 mg of manganese; and
   (f) a third dosage form comprising about 2000 IU (about 50 mcg) of Vitamin D, about 60 or 90 mcg of Vitamin K, about 50 mcg or about 100 mcg biotin, about 400 or about 600 mcg of folate/folinic acid, about 25 mcg or 36 mcg of Vitamin B12, about 50 mcg or 100 mcg of chromium, about 25 mcg of molybdenum, about 150 mcg or about 220 mcg of iodine, and about 60 mcg or about 70 mcg of selenium; or
(IV) any one dosage form according to any one of (b), (c), (d), (e), or (f).

For example, the nutritional supplement may comprise (a). In some cases, the nutritional supplement comprises (b). In other cases, the nutritional supplement may comprise (c). In still other cases, the nutritional supplement may comprise (d). In various case, the nutritional supplement may comprise (e). In various cases, the nutritional supplement may comprise (f).

In another aspect of the present disclosure a nutritional supplement is provided comprising: at least 500 mcg of retinol (preformed Vitamin A), at least 1000 mcg of beta carotene, at least 100 mg of Vitamin C, at least 50 mcg of Vitamin D, at least 46 mcg of Vitamin K, at least 30 mcg of Vitamin K2, at least 1.4 mg of Vitamin B1 (thiamine hydrochloride), at least 1.4 mg of Vitamin B2 (Riboflavin), at least 18 mg of Niacin, at least 10 mg of pyridoxine hydrochloride (Vitamin B6), at least 400 mcg folinic acid, at least 18 mcg of Vitamin B12, at least 50 mcg of Biotin, at least 7 mg of Pantothenic acid, at least 150 mg of iodine, at least 350 mg of choline, at least 200 mg of Calcium, at least 140 mg of magnesium, at least 10 mg of zinc, at least 50 mcg of selenium, at least 1 mg of manganese, at least 50 mcg of chromium, at least 25 mcg of molybdenum, at least 25 mg of iron, at least 0.5 mg of copper or a combination of any combination thereof.

In another aspect, a nutritional supplement is provided comprising: at least 1200 mcg of retinol (preformed Vitamin A), at least 2000 mcg of beta carotene, at least 150 mg of Vitamin C, at least 50 mcg of Vitamin D, at least 25 mg of Vitamin E, at least 90 mcg of Vitamin K, at least 6 mg of thiamine (Vitamin B1), at least 2 mg of riboflavin (Vitamin B2), at least 15 mg niacin, at least 15 mg niacinamide, at least 10 mg Vitamin B6, at least 200 mcg activated folate, at least 300 mcg folinic acid, at least 18 mcg Vitamin B12, at least 100 mcg Biotin, at least 10 mg pantothenic acid, at least 220 mcg iodine, at least 350 mg choline, at least 325 mg calcium, at least 180 mg of magnesium, at least 20 mg zinc, at least 50 mg selenium, at least 1 mg manganese, at least 100 mcg chromium, at least 25 mcg molybdenum, at least 30 mg of iron, at least 1.3 mg of copper, at least 500 mg of inositol, or a combination of any thereof.

In still another aspect, a nutritional supplement is provided comprising: at least 1200 mcg of retinol (preformed Vitamin A), at least 1500 mcg of beta carotene, at least 175 mg of Vitamin C, at least 50 mcg of Vitamin D, at least 20 mg of Vitamin E, at least 90 mcg of Vitamin K, at least 6 mg of thiamine (Vitamin B1), at least 2 mg of Riboflavin (Vitamin B2), at least 15 mg niacin, at least 20 mg niacinamide, at least 10 mg Vitamin B6, at least 300 mcg activated folate (MTHF), at least 300 mcg folinic acid, at least 24 mcg of Vitamin B12, at least 100 mcg of Biotin, at least 10 mg of pantothenic acid, at least 220 mcg of iodine, at least 350 mg of choline, at least 425 mg of calcium, at least 260 mg of magnesium, at least 25 mg of zinc, at least 60 mcg of selenium, at least 1 mg manganese, at least 100 mcg of chromium, at least 25 mcg of molybdenum, at least 45 mg of iron, at least 1.2 mg of copper, at least 500 mg of inositol or any combination thereof.

In still another aspect, a nutritional supplement is provided comprising: at least 1200 mcg of retinol (Vitamin A, preformed), at least 100 mcg of beta carotene, at least 200 mg of Vitamin C, at least 50 mcg of Vitamin D, at least 15 mg of Vitamin E, at least 90 mcg of Vitamin K, at least 6 mg of thiamine (Vitamin B1), at least 2 mg of riboflavin (Vitamin B2), at least 15 mg niacin, at least 25 mg niacinamide, at least 10 mg of Vitamin B6, at least 300 mcg activated folate (MTHF), at least 300 mcg of folinic acid, at least 36 mcg of Vitamin B12, at least 100 mcg of Biotin, at least 10 mg of pantothenic acid, at least 220 mcg of iodine, at least 600 mg of choline, at least 525 mg of calcium, at least 350 mg of magnesium, at least 30 mg of zinc, at least 70 mcg of selenium, at least 1 mg of manganese, at least 100 mcg of chromium, at least 25 mcg of molybdenum, at least 60 mg of iron, at least 1.1 mg of copper, at least 500 mg of inositol, or any combination thereof.

In various aspects, a nutritional supplement is provided comprising at least 1200 mcg of retinol (preformed Vitamin A), at least 1000 mcg of beta carotene, at least 200 mg Vitamin C, at least 50 mcg of Vitamin D, at least 19 mg of Vitamin E, at least 90 mcg of Vitamin K, at least 6 mg of Vitamin B1, at least 2 mg of Vitamin B2, at least 20 mg of Niacin, at least 15 mg of Niacinamide, at least 10 mg of Vitamin B6, at least 600 mcg of activated folate (MTHF), at least 25 mcg of Vitamin B12, at least 100 mcg of Biotin, at least 10 mg of Pantothenic acid, at least 220 mcg of iodine, at least 350 mg of choline, at least 525 mg Calcium, at least 350 mg magnesium, at least 30 mg of zinc, at least 60 mcg of selenium, at least 1 mg manganese, at least 100 mcg chromium, at least 25 mcg of molybdenum, at least 30 mg of iron, at least 1.3 mg of copper, at least 500 mg of inositol or any combination thereof.

In any of the aspects provided herein, the nutritional supplement may further comprise potassium. For example, the supplement may comprise at least 100 mg of potassium.

In various embodiments, the nutritional supplement further comprises DHA. For example, the nutritional supplement may comprise at least 500 mg of DHA.

In various aspects of the instant disclosure, any of the nutritional supplements may further comprise one or more sulfur containing compounds. In some instances, the one or more sulfur containing compounds are selected from the group consisting of cysteine, n-acetylcysteine, sulforaphane, methyl-sufonyl-methane, thiamine tetrahydrofurfuryl disulfide (TTFD), benfotiamine, S-allyl cysteine, and Epsom salts. For example, the one or more sulfur containing compounds may comprise (a) n-acetylcysteine and methyl-sufonyl-methane; (b) at least one of n-acetylcysteine, or sulforaphane; or (c) at least one of thiamine tetrahydrofurfuryl disulfide (TTFD), benfotiamine or S-allyl cysteine.

In various aspects, any of the nutritional supplements may further comprise a ribose. In some instances, the ribose comprises D-ribose.

In various aspects, any of the nutritional supplements may further comprise l-carnitine, acetyl-l-carnitine and/or lithium. For example, the nutritional supplement may further comprise l-carnitine. Alternatively, the nutritional supplement may further comprise lithium. Alternatively, the nutritional supplement may further comprise acetyl-l-carnitine.

In one aspect, a nutritional supplement may comprise Vitamin A at or about 1600 mcg (5,333 IU); Vitamin C at or about 75 mg; Vitamin D3 at or about 25 mcg (1,000 IU); Vitamin E at or about 12.5 mg; Vitamin K at or about 45 mcg; Vitamin B1 at or about 3 mg; Vitamin B2 at or about 1 mg; Vitamin B3 at or about 15 mg; Vitamin B6 at or about 5 mg; Folate at or about 300 mcg DFE (176.5 mcg folic acid); Vitamin B12 at or about 9 mcg; Biotin at or about 50 mcg; Pantothenic Acid at or about 5 mg; Choline at or about 175 mg; Calcium at or about 162.5 mg; Iron at or about 15 mg; Iodine at or about 110 mcg; Magnesium at or about 90 mg; Zinc at or about 10 mg; Selenium at or about 25 mcg; Copper at or about 0.65 mg; Manganese at or about 0.5 mg; Chromium at or about 50 mcg; Molybdenum at or about 12.5 mcg; Potassium at or about 50 mg; and Inositol at or about 250 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, a nutritional supplement as disclosed herein is administered to women preconception, or to women in the first trimester of pregnancy. In one aspect, the nutritional supplement is to be administered in the morning to women preconception, or to women in the first trimester of pregnancy. In one aspect, the nutritional supplement contains half a daily dosage as disclosed herein, and is administered twice daily, e.g., in the morning and in the evening.

In one aspect, a nutritional supplement comprises vitamin A at or about 1600 mcg (5.333 IU); Vitamin C at or about 75 mg; Vitamin D3 at or about 25 mcg (1,000 IU); Vitamin E at or about 12.5 mg; Vitamin K at or about 45 mcg; Vitamin B1 at or about 3 mg; Vitamin B2 at or about 1 mg; Vitamin B3 at or about 15 mg; Vitamin B6 at or about 5 mg; Folate at or about 300 mcg DFE (176.5 mcg folic acid); Vitamin B12 at or about 9 mcg; Biotin at or about 50 mcg; Pantothenic Acid at or about 5 mg; Choline at or about 175 mg; Calcium at or about 162.5 mg; Iron at or about 15 mg; Iodine at or about 110 mcg; Magnesium at or about 90 mg; Zinc at or about 10 mg; Selenium at or about 25 mcg; Copper at or about 0.65 mg; Manganese at or about 0.5 mg; Chromium at or about 50 mcg; Molybdenum at or about 12.5 mcg; Potassium at or about 50 mg; Fish Oil Concentrate at or about 1138 mg; Docosahexaenoic acid (DHA) at or about 500 mg; and Inositol at or about 250 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, the nutritional supplement is to be administered to a woman preconception or to a woman in the first trimester of pregnancy. In one aspect, the nutritional supplement is to be administered in the evening to women preconception, or to women in the first trimester of pregnancy. In one aspect, the nutritional supplement contains half a daily dosage as disclosed herein, and is administered twice daily, e.g., in the morning and in the evening.

In one aspect, a nutritional supplement comprises Vitamin A at or about 1157 mcg (3,857 IU); Vitamin C at or about 75 mg; Vitamin D3 at or about 21.4 mcg (856 IU); Vitamin E at or about 8.57 mg; Vitamin K at or about 38.6 mcg; Vitamin B1 at or about 2.57 mg; Vitamin B2 at or about 0.86 mg; Vitamin B3 at or about 15 mg; Vitamin B6 at or about 4.29 mg; Folate at or about 257 mcg DFE (151.3 mcg folic acid); Vitamin B12 at or about 10.3 mcg; Biotin at or about 42.9 mcg: Pantothenic Acid at or about 4.29 mg; Choline at or about 150 mg; Calcium at or about 182.14 mg; Iron at or about 19.29 mg; Iodine at or about 94.3 mcg; Magnesium at or about 111.43 mg; Zinc at or about 10.71 mg; Selenium at or about 25.7 mcg; Copper at or about 0.51 mg; Manganese at or about 0.43 mg; Chromium at or about 42.9 mcg; Molybdenum at or about 10.7 mcg; Potassium at or about 42.86 mg; and Inositol at or about 214 mg. In yet another aspect, a nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, a nutritional supplement as disclosed herein is to be administered in the morning to women preconception, or to women in the second trimester of pregnancy. In one aspect, the nutritional supplement contains half a daily dosage as disclosed herein, and is administered twice daily, e.g., in the morning and in the evening.

In one aspect, a nutritional supplement comprises Vitamin A at or about 1543 mcg (5143 IU); Vitamin C at or about 100 mg; Vitamin D3 at or about 28.6 mcg (1,144 IU); Vitamin E at or about 11.43 mg; Vitamin K at or about 51.4 mcg; Vitamin B1 at or about 3.43 mg; Vitamin B2 at or about 1.14 mg; Vitamin B3 at or about 20 mg; Vitamin B6 at or about 5.71 mg; Folate at or about 343 mcg DFE (201.7 mcg folic acid); Vitamin B12 at or about 13.7 mcg; Biotin at or about 57.1 mcg; Pantothenic Acid at or about 5.71 mg; Choline at or about 200 mg; Calcium at or about 242.86 mg; Iron at or about 25.71 mg; Iodine at or about 125.7 mcg; Magnesium at or about 148.57 mg; Zinc at or about 14.29 mg; Selenium at or about 34.3 mcg; Copper at or about 0.69 mg; Manganese at or about 0.57 mg; Chromium at or about 57.1 mcg; Molybdenum at or about 14.3 mcg; Potassium at or about 57.14 mg; Fish Oil Concentrate at or about 1138 mg; Docosahexaenoic acid (DHA) at or about 500 mg; and Inositol at or about 286 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, the nutritional supplement is to be administered to women in the second trimester of pregnancy. In one aspect, the nutritional supplement is to be administered in the evening to women in the second trimester of pregnancy. In one aspect, the nutritional supplement contains half a daily dosage as disclosed herein, and is administered twice daily, e.g., in the morning and in the evening.

In one aspect, a nutritional supplement comprises Vitamin A at or about 978 mcg (3,260 IU); Vitamin C at or about 89 mg; Vitamin D3 at or about 22.2 mcg (888 IU); Vitamin E at or about 6.67 mg; Vitamin K at or about 40 mcg; Vitamin B1 at or about 2.67 mg; Vitamin B2 at or about 0.89 mg; Vitamin B3 at or about 17.78 mg; Vitamin B6 at or about 4.44 mg; Folate at or about 267 mcg DFE (156.9 mcg folic acid); Vitamin B12 at or about 16 mcg; Biotin at or about 44.4 mcg; Pantothenic Acid at or about 4.44 mg; Choline at or about 266.67 mg; Calcium at or about 233.33 mg; Iron at or about 26.67 mg; Iodine at or about 97.8 mcg; Magnesium at or about 155.56 mg; Zinc at or about 13.33 mg; Selenium at or about 31.1 mcg; Copper at or about 0.49 mg; Manganese at or about 0.44 mg; Chromium at or about 44.4 mcg; Molybdenum at or about 11.1 mcg; Potassium at or about 44.4 mg; and Inositol at or about 222 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, the nutritional supplement is to be used on pregnant women in the third trimester. In one aspect, the nutritional supplement is to be administered in the morning to a pregnant woman in the third trimester. In one aspect, the nutritional supplement contains half a daily dosage as disclosed herein, and is administered twice daily, e.g., in the morning and in the evening.

In one aspect, the nutritional supplement comprises Vitamin A at or about 1222 mcg (4,073 IU); Vitamin C at or about 111 mg; Vitamin D3 at or about 27.8 mcg (1,112 IU); Vitamin E at or about 8.33 mg; Vitamin K at or about 50 mcg; Vitamin B1 at or about 3.33 mg; Vitamin B2 at or about 1.11 mg; Vitamin B3 at or about 22.22 mg; Vitamin B6 at or about 5.56 mg; Folate at or about 333 mcg DFE (196.1 mcg folic acid); Vitamin B12 at or about 20 mcg; Biotin at or about 55.6 mcg; Pantothenic Acid at or about 5.56 mg; Choline at or about 333.33 mg; Calcium at or about 291.67 mg; Iron at or about 33.33 mg; Iodine at or about 122.2 mcg; Magnesium at or about 194.44 mg; Zinc at or about 16.67 mg; Selenium at or about 38.9 mcg; Copper at or about 0.61 mg; Manganese at or about 0.56 mg; Chromium at or about 55.6 mcg; Molybdenum at or about 13.9 mcg; Potassium at or about 55.6 mg; Fish Oil Concentrate at or about 1138 mg; Docosahexaenoic acid at or about 500 mg; and Inositol at or about 278 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, the nutritional supplement is to be used on pregnant women in the third trimester. In one aspect, the nutritional supplement is to be administered in the evening to a pregnant woman in the third trimester. In one aspect, the nutritional supplement contains half a daily dosage as disclosed herein, and is administered twice daily, e.g., in the morning and in the evening.

In one aspect, the nutritional supplement comprises Vitamin A at or about 978 mcg (3,260 IU); Vitamin C at or about 89 mg; Vitamin D3 at or about 22.2 mcg (888 IU); Vitamin E at or about 6.67 mg; Vitamin K at or about 40 mcg; Vitamin B1 at or about 2.67 mg; Vitamin B2 at or about 0.89 mg; Vitamin B3 at or about 17.78 mg; Vitamin B6 at or about 4.44 mg; Folate at or about 267 mcg DFE (156.9 mcg folic acid); Vitamin B12 at or about 16 mcg; Biotin at or about 44.4 mcg; Pantothenic Acid at or about 4.44 mg; Choline at or about 266.67 mg; Calcium at or about 233.33 mg; Iron at or about 26.67 mg; Iodine at or about 97.8 mcg; Magnesium at or about 155.56 mg; Zinc at or about 13.33 mg; Selenium at or about 31.1 mcg; Copper at or about 0.49 mg; Manganese at or about 0.44 mg; Chromium at or about 44.4 mcg; Molybdenum at or about 11.1 mcg; Potassium at or about 44.4 mg; Fish Oil Concentrate at or about 569 mg; Docosahexaenoic acid (DHA) at or about 250 mg; and Inositol at or about 222 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, the nutritional supplement is to be used on pregnant women in the fourth trimester or post-natal care. In one aspect, the nutritional supplement is to be administered daily to a pregnant woman in the fourth trimester or in the post-natal care. In one aspect, the nutritional supplement contains half a daily dosage as disclosed herein, and is administered twice daily, e.g., in the morning and in the evening.

Any of the nutritional supplements provided herein may be provided by specific forms of the nutrients. These forms include, but not limited to Vitamin A as natural beta carotene and retinyl palmitate; Vitamin C from calcium ascorbate; Vitamin D3 as cholecalciferol; Vitamin E as natural mixed tocopherols; Vitamin K as phytonadione [Vitamin K1] and menaquinone-7 [Vitamin K2]; Vitamin B1 as thiamine hydrochloride; Vitamin B2 as riboflavin; Vitamin B3 as niacin and niacinamide; Vitamin B6 as pyridoxine hydrochloride; Folate as Calcium L-5-Methyltetrahydrofolate [5-MTHF]; Vitamin B12 as methylcobalamin; Pantothenic Acid as d-calcium pantothenate; Choline from choline bitartrate; Calcium from calcium carbonate; Iron from iron bisglycinate; Iodine from potassium iodide; Magnesium from magnesium bisglycinate and magnesium malate; Zinc from zinc sulfate and zinc amino acid chelate; Selenium from selenium amino acid chelate; Copper from copper bisglycinate; Manganese from manganese amino acid chelate; Chromium from chromium picolinate; Molybdenum from molybdenum glycinate; or Potassium from potassium chloride.

According to various aspects of the disclosure, a nutritional supplement as disclosed herein may be taken once, twice or three times per day. Administration as disclosed herein expressly contemplates taking a first dose of the supplement in the morning, a second dose of the supplement in the afternoon or evening, and optionally a third dose in the evening when a second dose is taken in the afternoon, thereby distributing the complete daily dose of the supplement over the course of a day. For example, a woman preconception or in the first trimester may take two or three doses of a nutritional supplement formulated such that the two or three doses combined provide a daily intake of vitamin A of 1600 mcg or about 1600 mcg (5.333 IU); Vitamin C at 75 mg or about 75 mg; Vitamin D3 at 25 mcg or about 25 mcg (1,000 IU); Vitamin E at 12.5 mcg or about 12.5 mg; Vitamin K at 45 mcg or about 45 mcg; Vitamin B1 at 3 mg or about 3 mg; Vitamin B2 at 1 mg or about 1 mg; Vitamin B3 at 15 mg or about 15 mg; Vitamin B6 at 5 mg or about 5 mg; Folate at 300 mg DFE or about 300 mcg DFE (176.5 mcg folic acid); Vitamin B12 at 9 mcg or about 9 mcg; Biotin at 50 mcg or about 50 mcg; Pantothenic Acid at 5 mg or about 5 mg; Choline at 175 mg or about 175 mg; Calcium at 162.5 mg or about 162.5 mg; Iron at 15 mg or about 15 mg; Iodine at 110 mcg or about 110 mcg; Magnesium at 90 mg or about 90 mg; Zinc at 10 mg or about 10 mg; Selenium at 25 mcg or about 25 mcg; Copper at 0.65 mg or about 0.65 mg; Manganese at 0.5 mg or about 0.5 mg; Chromium at 50 mg or about 50 mcg; Molybdenum at 12.5 mcg or about 12.5 mcg; Potassium at 50 mg or about 50 mg; Fish Oil Concentrate at 1138 mcg or about 1138 mg; Docosahexaenoic acid (DHA) at 50 mg or about 500 mg; and Inositol at 250 mg or about 250 mg. In yet another aspect, the nutritional supplement may further comprise (a) MSM in any amount from 50 mg to 1000 mg, or any amount from about 50 to about 1000 mg; (b) n-acetylcysteine in any amount from 20 mg t0 200 mg or about 20 mg to about 200 mg; and/or (c) lithium in any amount from 20 mcg to 1000 mcg, or about 20 mcg to about 1000 mcg. The supplement may further comprise one or more pharmaceutically acceptable carriers or excipients. In some instances, the supplement is formulated for oral administration. In some cases, the supplement is formulated as a tablet, a pill, a capsule, a gel, a softgel, a liquid, gummies, or a liquid suspension.

Any of the nutritional supplements provided herein are provided for the use as a dietary supplement for a subject who is pregnant, trying to become pregnant, nursing, and/or lactating.

According to another aspect of the present disclosure is a method of supplementing the diet of a subject who is pregnant, trying to become pregnant, nursing and/or lactating, the method comprising administering a nutritional supplement described herein to the subject.

In some instances, the concentration of one or more of the vitamins and/or minerals (including the amount of the sulfur containing compound, amount of carnitine, and/or amount of lithium) in the dietary supplement is adjusted depending on the stage of pregnancy of the subject (preconception to third trimester).

In various methods, the nutritional supplement may be administered daily.

According to another aspect of the present disclosure, a method is provided for supplementing the diet of a subject who is pregnant, trying to become pregnant, nursing and/or lactating. The method comprises administering to the subject about 4000 IU/day (1200 mcg/day) or about 1666 IU/day (about 500 mcg/day) of preformed vitamin A, about 100 mg/day, about 150 mg/day, about 175 mg/day, or about 200 mg/day of vitamin C, about 2000 IU/day (about 50 mcg/day) of Vitamin D, about 15 mg/day, about 16 mg/day, about 19 mg/day, or about 20 mg/day of Vitamin E, about 46 mcg/day or about 90 mcg/day of Vitamin K, about 10 mg/day of Vitamin B6, about 25 mcg/day or about 36 mcg/day of Vitamin B12, about 3333 IU/day (1000 mcg/day), about 6666 IU/day (about 2000 mcg/day) or about 5000 IU/day (1500 mcg/day) of beta carotene, about 1.4 mg/day or about 6 mg/day of thiamine, about 1.4 mg/day or about 2 mg/day of riboflavin, about 18 mg/day, about 30 mg/day, about 35 mg/day or about 40 mg/day of Vitamin B3 (niacin/niacinamide), about 7 mg/day or 10 mg/day of pantothenic acid, about 50 mcg/day or about 100 mcg/day of biotin, about 400 mcg/day or 600 mcg/day of folate/folinic acid, about 350 mg/day or 600 mg/day of choline, about 500 mg/day or 600 mg/day of DHA, about 500 mg/day of inositol, about 200 mg/day, about 325 mg/day, about 425 mg/day, about 525 mg/day, or about 550 mg/day of calcium, about 50 mcg/day or 100 mcg/day of chromium, about 1.3 mg/day of copper, about 150 mcg/day or 220 mcg/day of iodine, about 25 mg/day, about 30 mg/day, about 45 mg/day, or about 60 mg/day of iron, about 140 mg/day, about 180 mg/day, about 260 mg/day, or about 350 mg/day of magnesium, about 1 mg/day of manganese, about 25 mcg/day of molybdenum, about 60 mcg/day or about 70 mcg/day of selenium, and about 10 mg/day, about 20 mg/day, about 25 mg/day, or about 30 mg/day of zinc. In another aspect, the method comprises administering about 100 mg/day to about 1000 mg/day of at least one sulfur containing compound, about 100 mg/day to about 2000 mg/day of carnitine, and/or about 100 mcg/day to about 500 mcg/day of lithium. In some examples, the amount of preformed vitamin A, amount of Vitamin C, amount of vitamin D, amount of Vitamin E, amount of Vitamin K, amount of Vitamin B6, amount of Vitamin B12, amount of beta carotene, amount of thiamine, amount of riboflavin, amount of niacin, amount of pantothenic acid, amount of biotin, amount of folate, amount of choline, amount of DNA, amount of inositol, amount of calcium, amount of chromium, amount of copper, amount of iodine, amount of iron, amount of magnesium, amount of manganese, amount of molybdenum, amount of selenium, amount of zinc, amount of the sulfur containing compound, amount of carnitine, and/or amount of lithium may be adjusted depending on the stage of pregnancy of the subject (preconception to third trimester).

In various aspects, the method may comprise or further comprise administering one or more sulfur containing compounds to the subject. The one or more sulfur containing compounds may be selected from the group consisting of n-acetylcysteine, sulforaphane, methyl-sufonyl-methane, thiamine tetrahydrofurfuryl disulfide (TTFD), benfotiamine, S-allyl cysteine, and Epsom salts and/or the carnitine is selected from l-carnitine or acetyl-l-carnitine. For example, the one or more sulfur containing compounds may comprise (a) n-acetylcysteine and methyl-sufonyl-methane; (b) at least one of n-acetylcysteine, or sulforaphane; or (c) at least one of thiamine tetrahydrofurfuryl disulfide (TTFD), benfotiamine or S-allyl cysteine.

In various aspects, the method may comprise or further comprise administering l-carnitine, acetyl-l-carnitine and/or lithium to the subject. In one aspect, the method may further comprise administering potassium to the subject. In any of aspects described herein, the method may further comprise administering DHA to the subject.

In various aspects, the method may further comprise administering ribose to the subject. In some cases, the ribose may comprise D-ribose.

In any of the aspects herein, the method may comprise administering any nutritional supplement described herein or may comprise administering any single dosage form, any pair of dosage forms or any triplet of dosage forms described herein to the subject.

In any of the methods provided herein, the subject may be actively trying to become pregnant.

In other methods, the subject may be in the first trimester of pregnancy.

In other methods, the subject may be in the second trimester of pregnancy.

In other methods, the subject may be in the third trimester of pregnancy.

In yet another aspect, the present disclosure provides a method of recommending a nutritional supplement for a subject, comprising the steps of: (a) inputting or having obtained the pregnancy due date of the subject; (b) obtaining or having obtained the current date; (c) calculating the subject's current pregnancy stage; and (d1) recommending the nutritional supplement of claims 1-4, if the subject is in the 1st trimester; (d2) recommending the nutritional supplement of claims 6-9, if the subject is in the 2nd trimester; (d3) recommending the nutritional supplement of claims 11-14, if the subject is in the 3rd trimester; (d4) recommending the nutritional supplement of claims 16-17, if the subject is in the 4th trimester or postnatal care. In another aspect, the method may further comprising repeating steps (b) and (c) in a fixed cadence, and making an updated recommendations of (d1) through (d4). In another aspect, the fixed cadence is monthly calculated backward from the subject's due date. In another aspect, the method of recommending a nutritional supplement to a subject, and such method is implemented through website interaction or in an app.

### BRIEF DESCRIPTION OF DRAWINGS

FIG. 1 depicts percent of supplements with different vitamins and nutrients.

FIG. 2 depicts percent of supplements meeting or exceeding the inventors' recommendations.

FIG. 3 depicts percent of supplements with different minerals.

FIG. 4 depicts percent of mineral supplements meeting or exceeding the inventors' recommendations.

### DETAILED DESCRIPTION OF THE INVENTION

The present disclosure is based in part on the surprising discovery that the full dietary and nutritional needs of individuals who are pregnant or trying to become pregnant are much greater than previously believed, and that a nutritional dietary supplement can be formulated for administration to these individuals to meet their previously unmet dietary and nutritional needs. Advantageously, regular use of the compositions provided herein may significantly reduce a wide range of pregnancy complications (anemia, Cesarean section, depression, gestational diabetes, hypertension, infertility, preeclampsia, and premature rupture of membranes) and infant health problems (asthma/wheeze, autism, low birth weight, congenital heart defects, intellectual development, intrauterine growth restriction, miscarriage, neural tube defects, orofacial defects, and preterm birth), as well as reduce the risk of autism.

### I. Composition

One aspect of the present disclosure encompasses a nutritional supplement comprising vitamins and minerals tailored for the needs of a pregnant, lactating, breastfeeding individual or one who is actively trying to become pregnant (preconception). In various aspects, the nutritional supplement comprises (a) at least two first components selected from: preformed Vitamin A, Vitamin C, Vitamin D, Vitamin E, Vitamin K, Vitamin B6, and Vitamin B12; and (b) at least two second components selected from: beta carotene, thiamine, riboflavin, niacin, pantothenic acid, biotin, folate, choline, DHA, and inositol.

In various aspects, the nutritional supplement comprises preformed Vitamin A, Vitamin C, Vitamin D, Vitamin E, Vitamin K, Vitamin B6, Vitamin B12, beta carotene, thiamine, riboflavin, niacin, pantothenic acid, biotin, folate, choline, DHA, and/or inositol. In various aspects, the nutritional supplement comprises preformed Vitamin A, Vitamin C, Vitamin D, Vitamin E, Vitamin K, Vitamin B6, Vitamin B12, beta carotene, thiamine, riboflavin, niacin, pantothenic acid, biotin, folate, choline, DHA, and inositol. Optionally, the nutritional supplements may further comprise one or more sulfur containing vitamin or nutrient selected from cysteine, n-acetylcysteine, sulforaphane and methyl-sufonyl-methane. Optionally, the nutritional supplement may further comprise l-carnitine. Optionally, the nutritional supplement may further comprise ribose. Optionally, the nutritional supplement may further comprise potassium. Optionally, the nutritional supplement may further comprise DHA.

The amounts of each of the components in the nutritional supplement provided herein may be tailored for the unique nutritional needs of the intended subject. For example, in various aspects, the amount of each of the components may be tailored to the subject depending on her pregnancy status (e.g., pregnant or trying to become pregnant (preconception)), her stage of pregnancy (e.g., whether she is in her first trimester, second trimester or third trimester), or any other condition related to the prenatal or postnatal period (e.g., whether she is breastfeeding, lactating, or suffering from a particular pregnancy related complication). In other aspects, the amount of each component in the nutritional supplement may be tailored to the needs of the embryo, fetus, or newborn depending on its medical condition. For example, if a test performed during pregnancy indicates that the fetus is at risk of developing a medical condition, the components in the nutritional supplement provided herein may be adjusted to avoid, mitigate or otherwise prevent development of that medical condition.

In various aspects, accordingly, the nutritional supplement provided herein may comprise at least one, at least two, at least three, or at least four of the following components: preformed Vitamin A, Vitamin C, Vitamin D, Vitamin E, Vitamin K, Vitamin B6, Vitamin B12, beta carotene, thiamine, riboflavin, niacin, pantothenic acid, biotin, folate, choline, DHA, and/or inositol. Each are discussed below.

### (a) Preformed Vitamin A.

Vitamin A is an important fat-soluble antioxidant. It is crucial for the growth of most cells and organs, including the eyes, heart, and lungs. Low vitamin A during pregnancy is associated with night blindness and anemia in mothers. For infants born to mothers with lower levels of vitamin A, there is an increased risk of severe vision problems, heart defects, orofacial defects, delayed growth, and impaired lung function. Retinol levels decrease steadily during pregnancy if not supplemented.

Accordingly, in various aspects, the nutritional supplement may comprise from about 1000 to 5000 IU (international units, 1 IU is equivalent to about 0.3 mcg of retinol) of preformed vitamin A (i.e., not in the form of beta carotene). In various aspects, the nutritional supplement may comprise about 4000 IU (about 1200 mcg), or about 1666 IU (about 500 mcg) of preformed vitamin A. In some instances, the nutritional supplement may comprise about 1200 mcg of preformed vitamin A (in the form of retinol).

### (b) Beta Carotene

Beta carotene is another form of Vitamin A. It is also measured in international units, with 1 IU equivalent to about 0.6 mcg of beta-carotene. In one aspect, the nutritional supplement may, contain from about 1000 to 5000 IU of beta carotene. For example, the nutritional supplement may contain about 3333 IU (or about 2000 mcg), about 1666 IU (about 1000 mcg), or about 2500 IU (about 1500 mcg) of beta carotene. In one aspect, mixed carotenoids may be provided (e.g., α-Carotene, β-carotene, β-cryptoxanthin, lutein, zeaxanthin, and lycopene).

### (c) Vitamin C

Vitamin C is an important water-soluble antioxidant, and is a co-factor for many enzymatic reactions, including the production of collagen, carnitine, and neuropeptides. During pregnancy, vitamin C is important for the growth and repair of collagen and helps maintain strong bones and teeth. A deficiency in vitamin C during pregnancy may lead to premature rupture of membranes (PROM) and preterm birth due to PROM, preeclampsia, and urinary tract infections in the mother. Low gestational vitamin C may cause low birth weight, orofacial clefts, and decreased pulmonary functioning for infants.

Accordingly, the nutritional supplement may comprise from about 100 to about 1000 mg of Vitamin C. For example, the nutritional supplement may comprise about 100 mg about 150 mg, about 175 mg, or about 200 mg of Vitamin C. In some cases, Vitamin C is provided in the form of calcium ascorbate.

### (d) Vitamin D

Vitamin D is important for bone growth and immune function, together with vitamin K2. Low vitamin D can cause growth delays and bone deformation (rickets). Vitamin D deficiency during pregnancy is associated with a higher risk for miscarriage, preterm birth, and C-section, and a higher risk of the child developing asthma, language difficulties, and autism. Supplementing with additional vitamin D during pregnancy reduces the incidence of preeclampsia, preterm birth, infection, hypertensive disorders in pregnancy, and secondary hyperparathyroidism, and increases infant mental and psychomotor scores.

In various aspects, the nutritional supplement may comprise from about 1000 to 5000 IU (about 25 to 125 mcg) of Vitamin D. The international unit (IU) of vitamin D is equivalent to about 0.025 mcg. In some cases, the nutritional supplement may comprise from about 1000 to 4000 IU (about 25 to about 100 mcg) of Vitamin D. For example, the nutritional supplement may comprise about 2000 IU (about 50 mcg) of Vitamin D. In one aspect, Vitamin D comprises Vitamin D3.

### (e) Vitamin E

Vitamin E is an important fat-soluble antioxidant. In pregnancy, low vitamin E intake is associated with hyperglycemia, preterm births, preterm placental rupture of membranes (PROM), and placental abruption. The offspring of women who had low vitamin E levels had an increased risk of wheeze, orofacial clefts, and serious heart defects. There were troubling reports from several studies when very high dose vitamin E (400 IU) and vitamin C were combined, including an increase in fetal loss and perinatal death, abdominal pain, term PROM, and preterm PROM.

In various aspects, the nutritional supplement may comprise from about 1 to 50 IU (e.g., about 0.67 mg to about 33.5 mg) of Vitamin E. For example, the nutritional supplement may comprise about 28.5 IU (19 mg) of Vitamin E. In other instances, the nutritional supplement may comprise about 15 mg, about 16 mg, or about 20 mg of Vitamin E. Vitamin E may be provided in various forms called tocopherol. In various aspects, the vitamin E may be provided as a mixture of alpha-tocopherol and other tocopherols. For example, the nutritional supplement may comprise about 15 mg of alpha-tocopherol and 10 mg of other tocopherols (e.g., gamma). In some examples, the Vitamin E is provided as a mixture of various tocopherols primarily comprising gamma tocopherols. In some cases, the composition does not comprise any “d1” (synthetic) forms of tocopherol. Supplementation at the low doses recommended here may help reduce the risk of hyperglycemia, preterm births, preterm placental rupture of membranes (PROM), and placental abruption, and also decrease the risk of wheeze, orofacial clefts, and serious heart defects in their infants.

### (f) Vitamin K

Vitamin K aids in blood clotting and building strong bones. Vitamin K deficiency in pregnancy is common, in both the mother and infant shortly after birth. Preterm infants are especially at risk for excessive bleeding after birth, which often can result in intracranial bleeding. Supplementing with vitamin K right after birth is a common practice recommended by the American Academy of Pediatrics. The reason for low vitamin K levels in an infant is due to low levels of vitamin K in the mother, and very low transfer of vitamin K from the mother to the infant.

Accordingly, the nutritional supplement may comprise 10 to 100 mcg of Vitamin K. For example, the nutritional supplement may comprise about 60 mcg or about 90 mcg of Vitamin K. In various cases, the Vitamin K is provided in both the form of Vitamin K1 and Vitamin K2. For example, in some examples, the nutritional supplement may comprise about 45 mcg of Vitamin K1 and 45 mcg of Vitamin K2. In other instances, the nutritional supplement may comprise about 30 mcg of Vitamin K1 and about 30 mcg of Vitamin K2. In some cases, the amount of Vitamin K in the nutritional supplement may be higher, depending on maternal and fetal risk factors.

### (g) Vitamin B6 (Pyridoxine)

Vitamin B6 affects over 100 enzymatic reactions in the body, including the production of important neurotransmitters and hormones. Vitamin B6 deficiency is associated with an increased risk of preterm birth, nausea/vomiting during pregnancy, cleft lip/palate in infants, and neurodevelopmental behavior problems in infants. B6 supplementation may help decrease the severity of nausea, reduce the risk of cardiovascular malformation, reduce the risk of preeclampsia, and improve birth weight.

In various aspects, the nutritional supplement may comprise from about 1 to 50 mg of Vitamin B6. In one aspect, the nutritional supplement comprises from about 1 to 10 mg of Vitamin B6. In one aspect, the nutritional supplement comprises about 10 mg of vitamin B6. Including at least 10 mg of Vitamin B6 may reduce the risk of nausea, preeclampsia, maternal dental decay, preterm birth, low birth weight, cleft lip/palate, and cardiovascular malformation and higher doses (e.g., 25 mg) may reduce nausea. In various aspects, Vitamin B6 is provided in the form of pyridoxine hydrochloride.

### (h) Vitamin B12 (Cobalamin):

Vitamin B12 is involved in the formulation of red blood cells, cellular metabolism, and the synthesis of both DNA and myelin. Both folate and vitamin B12 are needed for recycling homocysteine to methionine, which is important for the production of SAM, the primary methyl donor in the body. It is important for reducing risk of infertility, miscarriage, gestational diabetes, preeclampsia, and preterm birth for the mother. For the infant, vitamin B12 deficiency is associated with low birth weight, neural tube defects, serious heart defect, and childhood diabetes.

Accordingly, the nutritional supplement provided herein may comprise about 10 to 100 mcg of Vitamin B12. For example, the nutritional supplement may comprise about 25 mcg (micrograms), about 18 mcg, about 24 mcg, or about 36 mcg of Vitamin B12. The nutritional supplement may also be tailored depending on various conditions of the mother (subject). For example, in a nutritional supplement intended for a vegetarian, the supplement may comprise about 50 mcg of Vitamin B12. In another case, when the intended recipient has a low intrinsic factor that prevents absorption of Vitamin B12, the supplement may comprise 100 to 1000 mcg Vitamin B12. In various aspects, Vitamin B12 is provided in the form of hydroxocobalamin.

### (i) Thiamine (Vitamin B1)

Thiamine, also known as Vitamin B1, helps the body metabolize food for energy and plays an important role in maintaining a healthy cardiovascular and nervous system. It is important during pregnancy to reduce the risk of maternal gestational diabetes and low-birth weight and anencephaly in infants. Thiamine is a co-factor for three critical enzymes for glucose metabolism, and thiamine deficiency results in an impairment of production and secretion of insulin, resulting in a reduction of glucose utilization.

In various aspects, the nutritional supplement may comprise from about 1 to 50 mg of thiamine. For example, the nutritional supplement may comprise about 1 to 10 mg of thiamine. In one aspect, the nutritional supplement may comprise about 6 mg of thiamine. In one aspect, the nutritional supplement may comprise about 1.4 mg of thiamine. In various aspects, the thiamine (Vitamin B1) is provided in the form of thiamin hydrochloride.

### (j) Riboflavin (Vitamin B2)

Riboflavin is important for the production of thyroid hormones, producing immune cells and red blood cells, and improving photoreceptor functioning. In pregnant women, riboflavin supplementation alone may prevent severe preeclampsia and hypertension. When riboflavin is given in conjunction with certain vitamins/minerals, it appears to increase its effectiveness, and is shown to help reduce anemia and night blindness. For infants, riboflavin deficiency may be associated with low birth weight, and an increased risk for serious birth defects (loss of limb and heart defect).

The nutritional supplement may comprise from about 1 to 50 mg of riboflavin. In one aspect, the nutritional supplement may comprise from about 1 to 10 mg of riboflavin. For example, the nutritional supplement may comprise about 1.4 mg of riboflavin. In some examples, the nutritional supplement may comprise about 2 mg of riboflavin. In some examples, the nutritional supplement may comprise about 2.5 mg of riboflavin. In some examples, the nutritional supplement may comprise from 2 to 15 mg of riboflavin. For example, in some cases the nutritional supplement may comprise about 15 mg of riboflavin.

### (k) Vitamin B3 (Niacin/Niacinamide)

Vitamin B3 (Niacin and/or niacinamide) is needed for many functions in the body, including energy production and development of the nervous system, digestive system, and skin. Low Vitamin B3 (e.g., niacin) is associated with an increased risk of birth defects (spina bifida, serious heart defect).

Accordingly, the nutritional supplement may comprise about 1 to 50 mg of Vitamin B3. In one aspect, the nutritional supplement may comprise about 15 to 50 mg of Vitamin B3. For example, the supplement may comprise about 18 mg, about 30 mg, about 35 mg or about 40 mg of Vitamin B3. In any of the aspects described herein, Vitamin B3 may be provided as niacin, niacinamide or a combination thereof. For example, In one aspect, the supplement may comprise about 18 mg of niacin. In other aspects, the supplement may comprise about 15 mg niacin and about 15 mg of niacinamide. In still other aspects, the supplement may comprise about 15 mg niacin and about 25 mg of niacinamide. In various aspects, the supplement may comprise about 20 mg niacin and about 20 mg of niacinamide.

(l) Pantothenic acid (Vitamin B5)

Pantothenic acid is needed to produce Coenzyme A, which has many functions in the body, including energy production from fats, carbohydrates, and protein. A deficiency of pantothenic acid during pregnancy is associated with low birth weight in offspring. Blood levels of pantothenic acid decrease substantially during pregnancy.

Accordingly, the nutritional supplement may comprise from about 1 to 50 mg of pantothenic acid. In some cases, the nutritional supplement comprises about 1 to 10 mg of pantothenic acid. For example, the nutritional supplement may comprise about 10 mg of pantothenic acid. In other examples, the nutritional supplement may comprise about 7 mg of pantothenic acid. In various aspects, the pantothenic acid is provided in the form of calcium d-pantothenate.

### (m) Biotin (Vitamin B7)

Biotin is necessary for several enzymes involved in energy metabolism from fats and carbohydrates. During pregnancy, animal studies demonstrate that biotin deficiency may result in birth defects that include malformations to the face and extremities, impaired fetal development, or miscarriage.

Accordingly, the nutritional supplement may comprise about 10 to 100 mcg of biotin. In one aspect, the nutritional supplement may comprise about 100 to 1000 mcg of biotin. For example, in some cases, the nutritional supplement may comprise about 100 mcg of biotin. In other examples, the nutritional supplement may comprise about 50 mcg of biotin. In further cases, for example when the supplement is intended for women with bariatric surgery or major gastrointestinal problems, the nutritional supplement may comprise a further 50 to 100 mcg of biotin. Accordingly, in some cases, the supplement may comprise about 150 to 200 mg of biotin.

### (n) Folate (Vitamin B9)

Folate is important for DNA synthesis and methylation, which is important for the modulation of gene expression. Folate is also important for the metabolism of several amino acids. It is essential for normal cell growth and replication. Folate supplementation during pregnancy is proven to reduce the risk of neural tube disorders and megaloblastic anemia. It also reduces the rate of other birth defects, preterm birth, and (if taken preconception) small-for-gestational-age. Low levels of folate are associated with a greater risk of having a child with autism. High levels of unmetabolized folic acid are associated with a greater risk of autism and food allergies.

In various aspects, the nutritional supplement comprises from about 100 to 1000 mcg of Folate. For example, the nutritional supplement may comprise about 400 mcg of Folate. In one aspect, the nutritional supplement may comprise about 600 mcg of Folate. In some cases, the nutritional supplement may comprise a higher concentration of Folate (e.g., up to 4 mg), particularly if intended for administration to a woman with a previous birth with a neural defect. In some cases, the folate may be provided as folic acid or a natural form of folate (e.g., folinic acid or 5-methyl-tetrahydrofolate (5-MTHF, also known as “activated folate”). Accordingly, In one aspect, the nutritional supplement may comprise about 600 mcg of activated folate (5-MTHF). In some other aspect, the nutritional supplement may comprise about 400 mcg of folinic acid. In some instances, the nutritional supplement comprises about 300 mcg of MTHF and 300 mcg of folinic acid.

### (o) Choline

Choline aids in the production of phosphatidylcholine (the main component of cell membranes) and acetylcholine (an important neurotransmitter involved in muscle control, memory, cognition, and cardiovascular regulation). In addition, choline is the primary dietary source of methyl groups (after it is converted to betaine), which modulates the DNA of all cells. It is important for optimal fetal brain development as well as possibly reducing the risk of neural tube defects, autism, and Down syndrome in the infant.

In one aspect, the nutritional supplement may comprise 100 to 1000 mg of choline. For example, the nutritional supplement may comprise about 350 mg of choline. In other aspects, the nutritional supplement may comprise about 600 mg of choline. In some cases, a nutritional supplement formulated for women in the first or second trimester of pregnancy may comprise about 350 mg of choline. A nutritional supplement formulated for women in the third trimester of pregnancy may comprise about 600 mg of choline.

### (p) Docosahexaenoic Acid (DHA)

Docosahexaenoic acid (DHA) is an essential part of the brain, eyes, and of the membrane of every cell. It is an essential fatty acid that needs to be consumed as part of a healthy diet. The primary source of DHA is from fish, but humans also have a limited ability to convert about 9% of alpha-linolenic acid to DHA and 21% to EPA. During pregnancy, DHA is especially important for reducing the risk of preterm birth and preeclampsia, and for treating gestational diabetes.

In various aspects, the nutritional supplement may comprise about 100 to 1000 mg of DHA. In some cases, the nutritional supplement may comprise about 600 mg of DHA. In some cases, the nutritional supplement comprises about 500 mg of DHA. In some cases, nutritional supplements for women at risk of developing prenatal or postnatal depression may further comprise about 1000 mg or more of EPA.

### (q) Inositol

Inositol is a nutrient similar to glucose that is synthesized in the kidneys and present in the highest concentrations in the brain and heart. It acts as a second messenger to various hormones such as insulin, follicle stimulating hormone, and thyroid stimulating hormone. It also controls fat and sugar metabolism, nervous system cellular functions, and gene expression. Supplementation in pregnant women demonstrated improved insulin resistance in those with gestational diabetes, lower incidence of neural tube defects (NTDs) in those with folate resistant NTDs, and improve fertility in women with Polycystic Ovarian Syndrome (PCOS).

There are nine different stereoisomers of inositol, with myo-inositol (MI) being the most common natural form. MI has been shown to be important in regulating a variety of cellular processes, including those related to gamete development, fertilization, and early embryonic development.

In various aspects, the nutritional supplement may comprise from about 100 to 1000 mg of inositol. For example, in some cases, the nutritional supplement may comprise about 500 mg of inositol. In various cases, the inositol is provided in the form of myo-inositol (MI). In some cases, the nutritional supplement may comprise higher amounts of inositol (e.g., up to 4000 mg), particularly when formulated for use by women at risk for gestational diabetes or with previous neural tube defects (NTDs).

### (r) Calcium

Calcium is essential for bone and tooth growth, so a lack of calcium in infants causes growth delays and bone deformations, otherwise known as rickets [1,2]. Calcium is also important for control of blood pressure, nerve impulses, muscle contraction, and secretion of some hormones.

In various aspects, the nutritional supplement may comprise from about 100 to 1000 mg of calcium. In one aspect, the nutritional supplement comprises about 550 mg or about 1000 mg of calcium. In one aspect, the nutritional supplement comprises about 200 mg, about 325 mg, about 425 mg, or about 525 mg calcium. In one aspect, the supplement comprises at least about 200 mg, at least about 325 mg, at least about 425 mg, at least about 525 mg or at least about 550 mg of calcium. In one aspect, the calcium may be provided as calcium carbonate.

### (s) Chromium

Chromium is recommended to control blood sugar levels, and low levels are associated with diabetes. Supplementation may improve glycemic control, reduced triglycerides, and increase HDL-C (high density lipoprotein-cholesterol) levels.

Accordingly, in various aspects, the nutritional supplement may comprise 10 to about 500 mcg of chromium. In one aspect, the nutritional supplement may comprise about 50 or about 100 mcg of chromium. In one aspect, the nutritional supplement may comprise at least about 50 mcg or at least about 100 mcg of chromium. In various aspects, the chromium may be provided as chromium picolinate.

### (t) Copper

Copper is needed for several functions, including iron absorption, formation of connective tissue, energy metabolism, oxidative stress, and brain development. Copper is recommended to prevent miscarriages and is necessary to prevent anemia because copper-based enzymes are needed for iron absorption.

In various aspects, the supplement comprises about 0.5 mg to about 5 mg of copper. For example, a nutritional supplement may comprise about 0.5 mg, about 1.1 mg, about 1.2 mg or about 1.3 mg of copper. In one aspect, the copper is provided as copper glycinate.

### (u) Iodine

Low iodine is strongly associated with iodine deficiency disorders, including hypothyroidism in mothers and infants and intellectual disability in infants. Low iodine is possibly related to preeclampsia and autism. Low iodine results in reduced thyroid hormone synthesis, which causes increased pituitary TSH production, which stimulates thyroid growth and can result in maternal or fetal goiter.

In various aspects, the nutritional supplement may comprise about 10 to 500 mcg of iodine. For example, in some instances the nutritional supplement may comprise about 150 or about 220 mcg of iodine. In various aspects, the iodine is provided as potassium iodide.

### (v) Iron

Iron is primarily needed for hemoglobin to transport oxygen in red blood cells, as well as several other roles. Low iron levels cause anemia (low hemoglobin), which causes weakness, fatigue, reduced cognitive performance, and diminished immune response in the mother and substantially impairs brain development of the fetus, which can have life-long effects on intellectual ability.

In various aspects, the nutritional supplement may comprise about 10 to about 100 mg of iron. In one aspect, the nutritional supplement comprises about 25 mg, about 30 mg, about 45 mg, or about 60 mg of iron. The iron may be provided as iron glycinate.

### (w) Magnesium

Magnesium is needed as an enzymatic co-factor for hundreds of reactions in the body and has many functions including cell signaling, ion transport, energy production, and synthesis of nucleic acids and proteins. It is also an important part of bones, cell membranes, and chromosomes.

In various aspects, the nutritional supplement comprises about 100 to about 1000 mg of magnesium. For example, the nutritional supplement may comprise about 140 mg, about 180 mg, about 260 mg, or about 350 mg of magnesium. In one aspect, the magnesium is provided in two forms (e.g., half as magnesium glycinate, half as magnesium malate). Accordingly, in some instances, the nutritional supplement may comprise about 70 mg of magnesium glycinate and 70 mg of magnesium malate; about 90 mg of magnesium glycinate and 90 mg of magnesium malate; about 130 mg of magnesium glycinate and 130 mg of magnesium malate, and about 170 mg of magnesium glycinate and 170 mg of magnesium malate.

### (x) Manganese

Manganese is vital for healthy brain and nervous system function as well as maintaining metabolism and hormone production. Manganese is one of the least-studied micronutrients for pregnancy, and at present, no supplementation trial for pregnancy has been published. Manganese is an essential mineral, but an excessive amount can cause neurological disorders.

In various aspects, the nutritional supplement comprises about 0.5 to 5 mg of manganese. For example, in various aspects, the nutritional supplement comprises about 1 mg of manganese. In one aspect, the manganese is provided as manganese aspartate.

### (y) Molybdenum

Molybdenum is an essential co-factor for three enzymes and may be related to autism and psychomotor development in infants.

In various aspects, the nutritional supplement may comprise from about 10 to about 500 mcg of molybdenum. For example, the nutritional supplement may comprise about 25 mcg of molybdenum. In one aspect, the molybdenum is provided in the form of molybdenum nicotinate glycinate.

### (z) Selenium

Selenium has many functions in the body, primarily as selenocysteine-containing proteins (selenoproteins). Selenium supplementation has been shown to reduce hypothyroidism, pregnancy-induced hypertension, and preeclampsia, as well as postpartum depression, in pregnant women. It has been found that selenium stores in the body are depleted throughout pregnancy, with most depletion occurring at the end of pregnancy.

In various aspects, the nutritional supplement may comprise about 10 to about 500 mcg of selenium. For example, the nutritional supplement may comprise about 60 mcg or about 70 mcg of selenium. In one aspect, the selenium is provided in the form of selenomethionine.

### (aa) Zinc

Zinc has many roles in the body, including immune function, growth and development, nerve function, vision, and fertility.

In various aspects, the nutritional supplement may comprise about 10 to 100 mg of zinc. For example, the nutritional supplement may comprise about 10 mg, about 20 mg, about 25 mg, or about 30 mg of zinc. In some cases, the zinc is provided in the form of zinc sulfate. In some cases, the zinc is provided in the form of an amino acid chelate. In some cases, the zinc is provided in two forms (e.g, half as zinc sulfate, half as an amino acid chelate).

### (Bb) Sulfur Containing Compounds

Some sulfur containing compounds may have beneficial effects in preventing or treating autism. Accordingly, the nutritional supplement may further comprise one or more sulfur containing compounds. These antioxidants may be selected from the group consisting of cysteine, n-acetylcysteine, sulforaphane, and methyl-sufonyl-methane. In some cases, the nutritional supplement comprises n-acetylcysteine and methyl-sufonyl-methane. In some instances, the nutritional supplement comprises n-acetylcysteine, or sulforaphane. Other sulfur containing compounds that may be included in the nutritional supplement herein include thiamine tetrahydrofurfuryl disulfide (TTFD), benfotiamine, S-allyl cysteine, and/or Epsom salts. In one aspect, the one or more sulfur containing compound comprises a sulfur containing antioxidant.

Accordingly, in some instances, the nutritional supplement comprises the one or more sulfur containing compounds selected from the group consisting of cysteine, n-acetylcysteine, sulforaphane, methyl-sufonyl-methane, thiamine tetrahydrofurfuryl disulfide (TTFD), benfotiamine, S-allyl cysteine, and Epsom salts. For example, the nutritional supplement may comprise one or more sulfur containing compounds such as (a) n-acetylcysteine and methyl-sufonyl-methane; (b) at least one of cysteine, n-acetylcysteine, sulforaphane; or (c) at least one of thiamine tetrahydrofurfuryl disulfide (TTFD), benfotiamine or S-allyl cysteine.

In one aspect, the nutritional supplement comprises about 100 mg to about 1000 mg of the sulfur containing compound.

### (cc) Carnitine

Carnitine is a quaternary ammonium compound involved in metabolism. In support of energy metabolism, carnitine transports long-chain fatty acids into mitochondria to be oxidized for energy production, and also participates in removing products of metabolism from cells.

The carnitine may be selected from L-carnitine or Acetyl-L-carnitine. Accordingly, in various aspects, the nutritional supplement provided herein may further comprise L-carnitine and/or acetyl-L-carnitine. In one aspect, the nutritional supplement comprises about 100 mg to about 2000 mg of the carnitine (e.g., L-carnitine and/or Acetyl-L-carnitine).

### (dd) Lithium

In various aspects, the nutritional supplement provided herein may further comprise lithium as a mood stabilizer. In one aspect, the nutritional supplement may comprise about 100 mcg to about 500 mcg of lithium.

### (ee) Ribose

D-ribose is a naturally occurring pentose monosaccharide that is a key structural component of DNA, RNA, NADH, NADPH, FADH, ATP, GTP, riboflavin, co-enzyme A and other nucleotides. NAD+ and NADH are important co-enzymes for transport of electrons for many reactions: NAD+ is an oxidizing agent, and NADH is a reducing agent. NADPH is an anabolic cofactor which is necessary for regeneration of glutathione, thioredoxin, and peroxiredoxins NADPH is also required for detoxifying pathways such as cytochromes P450 and catalase as well as NADPH oxidase, which catalyzes the “oxidative burst” as part of the immune response. ATP is the primary energy source for many metabolic reactions in the body.

Accordingly, in various aspects, the nutritional supplement provided herein may further comprise ribose. In some cases, the ribose comprises D-ribose. In some instances, the nutritional supplement may comprise about 1 to 5 grams of ribose. In some cases, the nutritional supplement comprises about 5 grams of ribose.

### (ff) Potassium

In some cases, the supplement may further comprise potassium. For example, the supplement may comprise about 100 mg of potassium. In various cases, the potassium may be provided in the form of potassium chloride.

### II. Exemplary Dietary/Nutritional Supplements

In various aspects, the nutritional supplement may comprise a combination of one or more of the components described above. For example, in one aspect, a supplement is provided comprising at least two vitamins selected from: preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol and at least two minerals selected from calcium, chromium, copper, iodine, iron, magnesium, manganese, molybdenum, selenium, and zinc.

In one aspect, the nutritional supplement may comprise (a) at least three vitamins selected from Vitamin C, Vitamin E, choline, DHA, inositol, Vitamin B3 (niacin/niacinamide), pantothenic acid, and Vitamin B6, and at least three minerals selected from calcium, magnesium, iron, and zinc; or (b)) at least three vitamins selected from vitamin A, beta carotene, riboflavin, Vitamin D, thiamine, Vitamin K, biotin, folate, Vitamin B12 and at least three minerals selected from copper, iodine, manganese, chromium, molybdenum, and selenium. In one aspect, the nutritional supplement comprises a pair of dosage forms comprising a first dosage form comprising (a) and a second dosage form comprising (b).

In further aspects, the nutritional supplement may comprise (a) at least two vitamins selected from Vitamin C, choline, DHA, inositol and at least one mineral selected from calcium and magnesium; or (b) at least two vitamins selected from thiamine, Vitamin B3 (niacin/niacinamide), pantothenic acid, Vitamin B6, Vitamin A, beta carotene, riboflavin, Vitamin E and at least two minerals selected from iron, zinc, copper, and manganese. In one aspect, the nutritional supplement comprises a triplet of dosage forms comprising a first dosage form comprising (a), a second dosage form comprising (b), and a third dosage form comprising (c).

Accordingly, in various nonlimiting aspects, the nutritional supplement may comprise one of the formulations (a) to (f) as described herein:
(a) preformed vitamin A, vitamin C, vitamin D, Vitamin E, Vitamin K, Vitamin B6, Vitamin B12, beta carotene, thiamine, riboflavin, Vitamin B3 (niacin/niacinamide), pantothenic acid, biotin, folate/folinic acid, choline, inositol, calcium, chromium, copper, iodine, iron, magnesium, manganese, molybdenum, selenium, zinc and, optionally, DHA; or
(b) Vitamin C, choline, inositol, Vitamin B3 (niacin/niacinamide), pantothenic acid, Vitamin B6, Vitamin E, calcium, magnesium, iron, zinc, and optionally DHA; or
(c) preformed Vitamin A, beta carotene, thiamine, riboflavin, Vitamin D, Vitamin K, biotin, folate/folinic acid, Vitamin B12, copper, manganese, chromium, molybdenum, iodine, and selenium; or
(d) Vitamin C, choline, inositol, calcium, magnesium, and, optionally, DHA; or
(e) thiamine, Vitamin B3 (niacin/niacinamide), pantothenic acid, Vitamin B6, preformed Vitamin A, Vitamin E, beta carotene, riboflavin, iron, zinc, copper, and manganese; or
(f) Vitamin D, Vitamin K, biotin, folate/folinic acid, Vitamin B12, chromium, molybdenum, iodine, and selenium.

In any of the nutritional supplements of (a) to (f), the nutritional supplement may comprise at least one dosage form comprising any one of (a), (b), (c), (d), (e), or (f).

In some exemplary supplements the nutritional supplement may comprise a sulfur containing compound, a carnitine (e.g., l-carnitine and/or acetyl-I-carnitine) and/or lithium. In some cases, the sulfur containing antioxidant comprises n-acetylcysteine, sulforaphane, methyl-sufonyl-methane, thiamine tetrahydrofurfuryl disulfide (TTFD), benfotiamine, S-allyl cysteine, Epsom salts, or any combination thereof and/or is present at a concentration of about 100 to about 1000 mg; the carnitine comprises L-carnitine or acetyl-L-carnitine and/or is present at a concentration of about 100 mg to about 2000 mg; and/or the supplement comprises about 100 mcg to about 500 mcg of lithium. In one aspect, the supplement comprising a sulfur containing antioxidant, carnitine (e.g., l-carnitine and/or acetyl-l-carnitine) and lithium further comprises at least one vitamin selected from preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol.

In some exemplary supplements, the nutritional supplement may comprise 1000 to about 10000 IU of preformed Vitamin A, Beta carotene, and/or Vitamin D. In some cases, the nutritional supplement comprises about 4000 IU (1200 mcg) or about 1666 IU (about 500 mcg) of preformed Vitamin A, about 3333 IU (about 2000 mcg), about 1666 IU (1000 mcg) of Beta Carotene, and/or about 2000 IU (e.g., 50 mcg) of Vitamin D. For example, the nutritional supplement may comprise about 4000 IU (1200 mcg) or about 1666 IU (about 500 mcg) of preformed Vitamin A, about 3333 IU (about 2000 mcg), about 1666 IU (1000 mcg) of Beta Carotene, and about 2000 IU (e.g., 50 mcg) of Vitamin D.

In various aspects, the nutritional supplement may comprise about 100 to about 1000 mg of DHA, Inositol, and/or choline. In some cases, the nutritional supplement may comprise about 500 mg or 600 mg of DHA, about 500 mg of Inositol, and/or about 350 mg of choline. For example, the nutritional supplement may comprise 500 mg or 600 mg of DHA, about 500 mg of Inositol, and about 350 mg or 600 mg of choline.

In various aspects, the nutritional supplement may comprise about 50 to 1000 mcg of Biotin and/or folate. In some cases, the nutritional supplement may comprise about 50 mcg or about 100 mcg of Biotin and/or about 400 mcg or 600 mcg of Folate. For example, the nutritional supplement may comprise about 50 mcg or about 100 mcg of Biotin and 400 mcg of Folate.

In further aspects, the nutritional supplement may comprise about 100 to 1000 mg of Vitamin C. For example, the nutritional supplement may comprise about 100 mg, about 150 mg, about 175 mg, or about 200 mg of Vitamin C.

In various aspects, the nutritional supplement may comprise about 10 to 100 mcg of Biotin, Vitamin K, and/or Vitamin B12. In some cases, the supplement may comprise about 50 mcg or about 100 mcg of Biotin, about 60 mcg or about 90 mcg of Vitamin K, and/or about 25 mcg or about 36 mcg of Vitamin B12.

In various aspects, the nutritional supplement may comprise about 1 to 50 IU (about 0.67 mg to about 33.5 mg) of Vitamin E. For example, the nutritional supplement may comprise about 28.5 IU (about 19 mg) of Vitamin E. In other aspects, the nutritional supplement may comprise about 15 mg, about 16 mg, or about 20 mg of Vitamin E.

In various aspects, the nutritional supplement may comprise about 1 to 50 mg of Pantothenic acid, vitamin B6, Thiamine, Riboflavin, and/or Niacin. In some cases, the nutritional supplement comprises about 1 to 10 mg of pantothenic acid, vitamin B6, thiamine, and/or riboflavin and/or about 25 to 50 mg of Vitamin B3 (niacin/niacinamide). For example, the nutritional supplement may comprise about 7 mg or about 10 mg of pantothenic acid, about 10 mg of vitamin B6, about 1.4 mg or about 6 mg of thiamine, about 1.4 mg or about 2 mg of riboflavin and/or about 18 mg, 30 mg, 35 mg or about 40 mg of Vitamin B3 (niacin/niacinamide).

In various aspects, the nutritional supplement may comprise about 100 to 1000 mg of calcium and/or about 100 to 1000 mg magnesium. For example, the nutritional supplement may comprise about 200 mg, about 325 mg, about 425 mg, about 525 mg, or about 550 mg of calcium, about/or about 140 mg, about 180 mg, about 260 mg, or about 350 mg of magnesium. For example, the nutritional supplement may comprise about 200 mg, about 325 mg, about 425 mg, about 525 mg, or about 550 mg of calcium, and about 140 mg, about 180 mg, about 260 mg, or about 350 mg of magnesium.

In various aspects, the nutritional supplement may comprise about 10 to 100 mg of iron and/or about 10 to 100 mg zinc. For example, In one aspect, the nutritional supplement may comprise about 25 mg, about 30 mg, about 45 mg, or about 60 mg iron and/or about 10 mg, about 20 mg, about 25 mg, or about 30 mg of zinc. For example, the nutritional supplement may comprise about 25 mg, about 30 mg, about 45 mg, or about 60 mg iron and about 10 mg, about 20 mg, about 25 mg, or about 30 mg of zinc.

In further aspects, the nutritional supplement may comprise about 0.5 to 5 mg of copper and/or about 0.5 to 5 mg of manganese. For example, the nutritional supplement may comprise about 0.5 mg, about 1.1 mg, about 1.2 mg, or about 1.3 mg of copper and/or about 1 mg of manganese. For example, the nutritional supplement may comprise 0.5 mg, about 1.1 mg, about 1.2 mg, or about 1.3 mg of copper and about 1 mg of manganese.

In various aspects, the nutritional supplement may comprise about 10 to 500 mcg of chromium, about 10 to 500 mcg of molybdenum, about 10 to 500 mcg of selenium, and/or about 10 to 500 mcg of iodine. For example, the supplement may comprise about 50 mcg or 100 mcg of chromium, about 25 mcg of molybdenum, about 50 mcg, about 60 mcg or about 70 mcg of selenium, and/or about 150 or 220 mcg of iodine. As another example, the supplement can comprise about 50 mcg or 100 mcg of chromium, about 25 mcg of molybdenum, about 50 mcg, about 60 mcg or about 70 mcg of selenium, and about 150 or 220 mcg of iodine.

In accordance with various aspects of the present disclosure the following illustrative compositions are provided in the table 1 below. In each case, exemplary compositions for each component are provided. If none are provided for a given formulation (e.g., A, B, C etc. . . . ) then, in some cases, the formulation may be prepared without that component.

Also provided are formulations optimized for a given time period in the preconception or pregnancy period. Exemplary formulations providing ideal concentration of each component for each period are provided in Table 2 below. Note that in Table 2, the formulations provided may comprise at least 1, at least 2, at least 3 (etc) of the components listed, and may not comprise every component listed. Further, the amounts provided in Table 1 may be further guided by the amounts in Table 2 to prepare various nutritional supplements containing optimal amounts of each nutrient for each stage of pregnancy in a pharmaceutically suitable formulation.

In various aspects, illustrative formulations (A), (B), (C), (D), (E) and (F) may be provided as one or more dosage forms. As used herein, the term “dosage form” refers to a single formulation intended to be administered at one time to a subject. For example, a dosage form can comprise a pill, a capsule, a suppository, a liquid dose, or any other pharmaceutical dosage form known in the art. A dosage form will include at least the components of the formulation, and optionally one or more pharmaceutically acceptable carriers, excipients, diluents, and/or coatings. Accordingly, In one aspect, the nutritional supplement may comprise a single dosage form comprising at least two components from the illustrative formulation A (provided in Table 1). In other aspects, the nutritional supplement may comprise a pair of dosage forms comprising a first dosage form comprising at least two components from “Illustrative Formulation B” and a second dosage form comprising at least two components from “Illustrative Formulation C”. In other aspects, the nutritional supplement may comprise a triplet of dosage forms comprising a first dosage form comprising at least two components from “Illustrative Formulation D”, a second dosage form comprising at least two components from “Illustrative Formulation E” and a third dosage form comprising at least two components from “Illustrative Formulation F”. Alternatively, individual dosage forms comprising at least two components from any one of Illustrative Formulations A, B, C, D, E, or F are also provided.

TABLE 1
Illustrative Formulations - General Use

| | | | Illustrative Formulations | | | | | | | | | | | |
|---|---|---|---|---|---|---|---|---|---|---|---|---|---|---|
| Nutrients | RANGES | | A | | B | | C | | D | | E | | F | |
| Vitamin A | 1000-10,000 | IU | 1200 | mcg | — | | 1200 | mcg | — | | 1200 | mcg | — | |
| Pre-Formed | 300-3000 | mcg | 500 | mcg | — | | 500 | mcg | — | | 500 | mcg | — | |
| (IU [mcg]) | | | | | | | | | | | | | | |
| Beta | 1000-10,000 | IU | 2000 | mcg | — | | 2000 | mcg | — | | 2000 | mcg | — | |
| Carotene (IU | 670 -6700 | mcg | 1000 | mcg | | | 1000 | mcg | | | 1000 | mcg | | |
| [mcg]) | | | 1500 | mcg | | | 1500 | mcg | | | 1500 | mcg | | |
| Vitamin C | 100-1000 | mg | 100 | mg | 100 | mg | — | | 100 | mg | — | | — | |
| (mg) | | | 150 | mg | 150 | mg | | | 150 | mg | | | | |
| | | | 175 | mg | 175 | mg | | | 175 | mg | | | | |
| | | | 200 | mg | 200 | mg | | | 200 | mg | | | | |
| Vitamin D (IU | 1000-10,000 | IU | 50 | mcg | — | | 50 | mcg | — | | — | | 50 | mcg |
| [mcg]) | 25-250 | mcg | | | | | | | | | | | | |
| Vitamin E (IU | 1-50 | IU | 15 | mg | 15 | mg | — | | — | | 15 | mg | — | |
| [mg]) | 0.67-33.5 | mg | 16 | mg | 16 | mg | | | | | 16 | mg | | |
| | | | 19 | mg | 19 | mg | | | | | 19 | mg | | |
| | | | 20 | mg | 20 | mg | | | | | 20 | mg | | |
| Vitamin K | 10-100 | mcg | 60 | mcg | — | | 60 | mcg | — | | — | | 60 | mcg |
| (mcg) | | | 90 | mcg | | | 90 | mcg | | | | | 90 | mcg |
| Thiamine | 1-10 | mg | 1.4 | mg | — | | 1.4 | mg | — | | 1.4 | mg | — | |
| (mg) | | | 6 | mg | | | 6 | mg | | | 6 | mg | | |
| Riboflavin | 1-10 | mg | 1.4 | mg | — | | 1.4 | mg | — | | 1.4 | mg | — | |
| (mg) | | | 2 | mg | | | 2 | mg | | | 2 | mg | | |
| Vitamin B3 | 15-50 | mg | 18 | mg | 18 | mg | — | | — | | 18 | mg | — | |
| (Niacin/m | | | 30 | mg | 30 | mg | | | | | 30 | mg | | |
| (mg) | | | 35 | mg | 35 | mg | | | | | 35 | mg | | |
| | | | 40 | mg | 40 | mg | | | | | 40 | mg | | |
| Pantothenic | 1-50 | mg | 7 | mg | 7 | mg | — | | — | | 7 | mg | — | |
| Acid (mg) | | | 10 | mg | 10 | mg | | | | | 10 | mg | | |
| Vitamin B6 | 1-50 | mg | 10 | mg | 10 | mg | — | | — | | 10 | mg | — | |
| (mg) | | | | | | | | | | | | | | |
| Biotin (mcg) | 10-100 | mcg | 50 | mcg | — | | 50 | mcg | — | | | | 50 | mcg |
| | | | 100 | mcg | | | 100 | mcg | | | | | 100 | mcg |
| Folate (inc. | 50-1000 | mcg | 400 | mcg | — | | 400 | mcg | — | | | | 400 | mcg |
| MTHF, or | | | 600 | mcg | | | 600 | mcg | | | | | 600 | mcg |
| folinic acid) | | | | | | | | | | | | | | |
| (mcg) | | | | | | | | | | | | | | |
| Vitamin B12 | 10-100 | mcg | 25 | mcg | — | | 25 | mcg | — | | — | | 25 | mcg |
| (mcg) | | | 36 | mcg | | | 36 | mcg | | | | | 36 | mcg |

| | | | | | | | | | | | |
|---|---|---|---|---|---|---|---|---|---|---|---|
| Choline (mg) | 100-1000 | mg | 350 | mg | 350 | mg | — | 350 | mg | — | — |

| | | | | | |
|---|---|---|---|---|---|
| 600 | mg | 600 | mg | 600 | mg |

| | | | | | | | | | | | |
|---|---|---|---|---|---|---|---|---|---|---|---|
| DHA (mg) | 100-1000 | mg | 500 | mg | 500 | mg | — | 500 | mg | — | — |

| | | | | | |
|---|---|---|---|---|---|
| 600 | mg | 600 | mg | 600 | mg |

| | | | | | | | | | | | |
|---|---|---|---|---|---|---|---|---|---|---|---|
| Inositol (mg) | 100-1000 | mg | 500 | mg | 500 | mg | — | 500 | mg | — | — |
| Calcium | 100-1000 | mg | 200 | mg | 200 | mg | — | 200 | mg | — | — |

| | | | | | |
|---|---|---|---|---|---|
| 325 | mg | 325 | mg | 325 | mg |
| 425 | mg | 425 | mg | 425 | mg |
| 525 | mg | 525 | mg | 525 | mg |
| 550 | mg | 550 | mg | 550 | mg |

| | | | | | | | | | | | |
|---|---|---|---|---|---|---|---|---|---|---|---|
| Chromium | 10-500 | mcg | 50 | mcg | — | 50 | mcg | — | — | 50 | mcg |

| | | | | | |
|---|---|---|---|---|---|
| 100 | mcg | 100 | mcg | 100 | mcg |

| | | | | | | | | | | | | |
|---|---|---|---|---|---|---|---|---|---|---|---|---|
| Copper | 0.5-5 | mg | 1.3 | mg | — | 1.3 | mg | — | 1.3 | mg | | |
| Iodine | 10-500 | mcg | 150 | mcg | — | 150 | mcg | — | | | 150 | mcg |

| | | | | | |
|---|---|---|---|---|---|
| 220 | mcg | 220 | mcg | 220 | mcg |

| | | | | | | | | | | | |
|---|---|---|---|---|---|---|---|---|---|---|---|
| Iron | 10-100 | mg | 25 | mg | 25 | mg | — | — | 25 | mg | — |

| | | | | | |
|---|---|---|---|---|---|
| 30 | mg | 30 | mg | 30 | mg |
| 45 | mg | 45 | mg | 45 | mg |
| 60 | mg | 60 | mg | 60 | mg |

| | | | | | | | | | | | |
|---|---|---|---|---|---|---|---|---|---|---|---|
| Magnesium | 100-1000 | mg | 150 | mg | 150 | mg | — | 150 | mg | — | — |

| | | | | | |
|---|---|---|---|---|---|
| 180 | mg | 180 | mg | 180 | mg |
| 260 | mg | 260 | mg | 260 | mg |
| 350 | mg | 350 | mg | 350 | mg |

| | | | | | | | | | | | |
|---|---|---|---|---|---|---|---|---|---|---|---|
| Manganese | 0.5-5 | mg | 1 | mg | — | 1 | mg | — | 1 | mg | — |

| | | | | | | | | | | | |
|---|---|---|---|---|---|---|---|---|---|---|---|
| Molybdenum | 10-500 | mcg | 25 | mcg | — | 25 | mcg | — | — | 25 | mcg |
| Selenium | 10-500 | mcg | 60 | mcg | — | 60 | mcg | — | — | 60 | mcg |

| | | | | | |
|---|---|---|---|---|---|
| 70 | mcg | 70 | mcg | 70 | mcg |

| | | | | | | | | | | | |
|---|---|---|---|---|---|---|---|---|---|---|---|
| Zinc | 10-100 | mg | 10 | mg | 10 | mg | — | — | 10 | mg | — |

| | | | | | |
|---|---|---|---|---|---|
| 20 | mg | 20 | mg | 20 | mg |
| 25 | mg | 25 | mg | 25 | mg |
| 30 | mg | 30 | mg | 30 | mg |

TABLE 2
Exemplary Concentrations for Stage of Pregnancy

| | | | General | | | | 1^{st} | | 2^{nd} | | 3^{rd} | |
|---|---|---|---|---|---|---|---|---|---|---|---|---|
| Nutrients | RANGES | | Prenatal | | Preconception | | trimester | | trimester | | trimester | |
| Vitamin A | 1000-10,000 | IU | 1200 | mcg | 500 | mcg | 1200 | mcg | 1200 | mcg | 1200 | mcg |
| Pre-Formed | 300-3000 | mcg | | | | | | | | | 500 | mcg |
| (IU [mcg]) | | | | | | | | | | | | |
| Beta | 1000-10,000 | IU | 1000 | mcg | 1000 | mcg | 2000 | mcg | 1500 | mcg | 1000 | mcg |
| Carotene (IU | 670-6700 | mcg | | | | | | | | | | |
| [mcg]) | | | | | | | | | | | | |
| Vitamin C | 100-1000 | mg | 200 | mg | 100 | mg | 150 | mg | 175 | mg | 200 | mg |
| (mg) | | | | | | | | | | | | |
| Vitamin D (IU | 1000-10,000 | IU | 50 | mcg | 50 | mcg | 50 | mcg | 50 | mcg | 50 | mcg |
| [mcg]) | 25-250 | mcg | | | | | | | | | | |
| Vitamin E (IU | 1-50 | IU | 19 | mg | 16 | mg | 25 | mg | 20 | mg | 15 | mg |
| [mg]) | 0.67-33.5 | mg | | | | | | | | | | |
| Vitamin K | 10-100 | mcg | 45 mcg K1 + | | 30 mcg K1 + | | 45 mcg K1 + | | 45 mcg K1 + | | 45 mcg K1 + | |
| (mcg) | | | 45 mcg K2 | | 30 mcg K2 | | 45 mcg K2 | | 45 mcg K2 | | 45 mcg K2 | |
| Thiamine | 1-10 | mg | 6 | mg | 1.4 | mg | 6 | mg | 6 | mg | 6 | mg |
| (mg) | | | | | | | | | | | | |
| Riboflavin | 1-10 | mg | 2 | mg | 1.4 | mg | 2 | mg | 2 | mg | 2 | mg |
| (mg) | | | | | | | | | | | | |
| Vitamin B3 | 15-50 | mg | 20 mg | | 18 mg Niacin | | 15 mg | | 15 mg | | 15 mg | |
| (Niacin + | | | niacin + | | | | niacin + | | niacin + 20 mg | | niacin + | |
| Niacinamide) | | | 15 mg | | | | 15 mg | | niacinamide | | 25 mg | |
| (mg) | | | niacinamide | | | | niacinamide | | | | niacinamide | |
| Pantothenic | 1-50 | mg | 710 | mg | 7 | mg | 10 | mg | 10 | mg | 10 | mg |
| Acid (mg) | | | | | | | | | | | | |
| Vitamin B6 | 1-50 | mg | 10 | mg | 10 | mg | 10 | mg | 10 | mg | 10 | mg |
| (mg) | | | | | | | | | | | | |
| Biotin (mcg) | 10-100 | mcg | 100 | mcg | 50 | mcg | 100 | mcg | 100 | mcg | 100 | mcg |
| Folate (inc. | 50-1000 | mcg | 600 mcg | | 400 mcg | | 300 mcg | | 300 mcg | | 300 mcg | |
| MTHF, | | | MTHF | | folinic acid | | MTHF | | MTHF | | MTHF | |
| and/or | | | (activated | | | | 300 mcg | | 300 mcg | | 300 mcg | |
| folinic acid) | | | folate) | | | | folinic acid | | folinic acid | | folinic acid | |
| (mcg) | | | | | | | | | | | | |
| Vitamin B12 | 10-100 | mcg | 25 | mcg | 18 | mcg | 18 | mcg | 24 | mcg | 36 | mcg |
| (mcg) | | | | | | | | | | | | |
| Choline (mg) | 100-1000 | mg | 350 | mg | 350 | mg | 350 | mg | 350 | mg | 600 | mg |
| DHA (mg) | 100-1000 | mg | 500 | mg | 500 | mg | 500 | mg | 500 | mg | 500 | mg |
| (may be | | | | | | | | | | | | |
| prepared in a | | | | | | | | | | | | |
| separate soft | | | | | | | | | | | | |
| gel) | | | | | | | | | | | | |
| Inositol (mg) | 100-1000 | mg | 500 | mg | — | | 500 | mg | 500 | mg | 500 | mg |
| Calcium | 100-1000 | mg | 525 | mg | 200 | mg | 325 | mg | 425 | mg | 525 | mg |
| Chromium | 10-500 | mcg | 100 | mcg | 50 | mcg | 100 | mcg | 100 | mcg | 100 | mcg |
| Copper | 0.5-5 | mg | 1.3 | mg | 0.5 | mg | 1.3 | mg | 1.2 | mg | 1.1 | mg |
| Iodine | 10-500 | mcg | 220 | mcg | 150 | mcg | 220 | mcg | 220 | mcg | 220 | mcg |
| Iron | 10-100 | mg | 30 | mg | 25 | mg | 30 | mg | 45 | mg | 60 | mg |
| Magnesium | 100-1000 | mg | 350 | mg | 140 | mg | 180 | mg | 260 | mg | 350 | mg |
| (half as | | | | | | | | | | | | |
| magnesium | | | | | | | | | | | | |
| glycinate | | | | | | | | | | | | |
| (MG), half as | | | | | | | | | | | | |
| magnesium | | | | | | | | | | | | |
| malate | | | | | | | | | | | | |
| (MM)) | | | | | | | | | | | | |
| Manganese | 0.5-5 | mg | 1 | mg | 1 | mg | 1 | mg | 1 | mg | 1 | mg |
| Molybdenum | 10-500 | mcg | 25 | mcg | 25 | mcg | 25 | mcg | 25 | mcg | 25 | mcg |
| Selenium | 10-500 | mcg | 60 | mcg | 50 | mcg | 50 | mcg | 60 | mcg | 70 | mcg |
| Zinc | 10-100 | mg | 30 | mg | 10 | mg | 20 | mg | 25 | mg | 30 | mg |

Further, each of the nutritional supplements provided herein (including those provided in Table 1 and Table 2) may further comprise at least one sulfur containing compound (e.g., cysteine, n-acetylcysteine, sulforaphane, methyl-sufonyl-methane, thiamine tetrahydrofurfuryl disulfide (TTFD), benfotiamine, S-allyl cysteine, or Epsom salts) (e.g., at a concentration of about 100 mg to about 1000 mg). Likewise, the supplement may also further comprise potassium (e.g., at a concentration of about 100 mg). In one aspect, the supplement also comprises ribose (e.g., D-ribose). In one aspect, the supplement also comprises a carnitine (e.g., l-carnitine and/or acetyl-l-carnitine) and/or lithium. In one aspect, the supplement may comprise about 100 mg to about 2000 mg of the carnitine and/or about 100 mcg to about 500 mcg of the lithium. In one aspect, the supplement comprises at least one sulfur containing compound (e.g., N-acetyl cysteine), -a carnitine (e.g., l-carnitine and/or acetyl-l-carnitine) and/or lithium.

### III. Formulations

The nutritional supplement provided herein may be formulated with pharmaceutically acceptable excipients or carriers. Such a formulation may be referred to herein as a pharmaceutical composition. Likewise, each of the components that make up the nutritional supplement as described above, may be provided in a pharmaceutical grade form. This form is mandated by the FDA for certain standards for quality and purity as understood in the art.

Pharmaceutical compositions comprising the components that make up the nutritional supplement described above may be manufactured by means of conventional mixing, dissolving, granulating, dragee-making levigating, emulsifying, encapsulating, entrapping or lyophilization processes. The compositions may be formulated in conventional manner using one or more physiologically acceptable carriers, diluents, excipients or auxiliaries which facilitate processing of the compounds into preparations which can be used pharmaceutically. The exact nature of the carrier, diluent, excipient or auxiliary will depend upon the desired use for the composition and may range from being suitable or acceptable for veterinary uses to being suitable or acceptable for human use. The composition may optionally include one or more additional compounds.

Each of the components described above may be formulated in the pharmaceutical composition per se, or in the form of a hydrate, solvate, N-oxide or pharmaceutically acceptable salt, or other predecessor that may be metabolized by the body to form the component. Typically, such salts are more soluble in aqueous solutions than the corresponding free acids and bases, but salts having lower solubility than the corresponding free acids and bases may also be formed.

In one embodiment, the nutritional supplement described above and herein may be administered orally. For oral administration, the nutritional supplement may take the form of, for example, lozenges, tablets or capsules prepared by conventional means with pharmaceutically acceptable excipients such as binding agents (e.g., pregelatinized maize starch, polyvinylpyrrolidone or hydroxypropyl methylcellulose); fillers (e.g., lactose, microcrystalline cellulose or calcium hydrogen phosphate); lubricants (e.g., magnesium stearate, talc or silica); disintegrants (e.g., potato starch or sodium starch glycolate); or wetting agents (e.g., sodium lauryl sulfate). The tablets may be coated by methods well known in the art with, for example, sugars, films or enteric coatings.

Liquid preparations for oral administration may take the form of, for example, elixirs, solutions, syrups or suspensions, or they may be presented as a dry product for constitution with water or other suitable vehicle before use. Such liquid preparations may be prepared by conventional means with pharmaceutically acceptable additives such as suspending agents (e.g., sorbitol syrup, cellulose derivatives or hydrogenated edible fats); emulsifying agents (e.g., lecithin or acacia); non-aqueous vehicles (e.g., almond oil, oily esters, ethyl alcohol, Cremophore™ or fractionated vegetable oils); and preservatives (e.g., methyl or propyl-p-hydroxybenzoates or sorbic acid). The preparations may also contain buffer salts, preservatives, flavoring, coloring and sweetening agents as appropriate.

Preparations for oral administration may be suitably formulated to give controlled release of the compound, as is well known. For buccal administration, the compositions may take the form of tablets or lozenges formulated in conventional manner.

Alternatively, other pharmaceutical delivery systems may be employed. Liposomes and emulsions are well-known examples of delivery vehicles that may be used to deliver components in the nutritional supplement. Certain organic solvents such as dimethyl sulfoxide (DMSO) may also be employed, although usually at the cost of greater toxicity.

The pharmaceutical compositions may, if desired, be presented in a pack or dispenser device which may contain one or more unit dosage forms containing the compound(s). The pack may, for example, comprise metal or plastic foil, such as a blister pack. The pack or dispenser device may be accompanied by instructions for administration.

### IV. Methods

In accordance with various aspects of the present disclosure, methods of supplementing the diet of a subject in need thereof are provided. The method comprises administering a nutritional supplement, as provided herein, to the subject.

In various aspects, the subject is a prenatal or postnatal subject. For example, the subject may be actively trying to achieve pregnancy (trying to become pregnant) and therefore considered to be in a “preconception” time frame. In other aspects, the subject may be pregnant. The subject may be at various stages of pregnancy (i.e., first trimester, second trimester, third trimester). Alternatively, the subject may be postnatal or postpartum. In one aspect, the subject may be 1 to 7 days postpartum, 1 to 6 weeks postpartum, or 1 to 12 months postpartum. The subject may be breastfeeding and/or lactating.

In further aspects, the subject may have a prenatal or postnatal risk factor or condition. For example, the subject may have or be at risk of developing gestational diabetes. The subject may have had to be planning to have bariatric surgery or may have another gastrointestinal problem. The subject may be experiencing or be at risk of developing prenatal or postnatal depression or anxiety.

In further aspects, the subject may have an at-risk pregnancy or have previously had an at-risk pregnancy where the fetus is at a higher risk of developmental defects. For example, the subject may have previously had a neural tube defect (NTD) in a previous pregnancy. In some cases, the fetus may be at risk of a developmental abnormality.

Administration of the nutritional supplement may be done daily, weekly, biweekly, monthly or according to another dosing schedule as determined by a person of skill in the art. In certain aspects, the nutritional supplement may be administered daily. In various aspects, the nutritional supplement may be administered in more than one dose so that, for example, a daily dose of each component is achieved. For example, the nutritional supplements provided above each provide a suggested amount for each component. In various aspects, the method may comprise administering the amount provided (e.g., 350 mg choline) in more than one dose (e.g., as two doses of 170 mg each) per day. Different pharmaceutical compositions containing divisions of the compositions provided above may be envisioned by one of ordinary skill in the art to achieve a palatable dosing schedule.

Accordingly, a method for supplementing the diet of a subject who is pregnant, trying to become pregnant, breastfeeding and/or lactating, the method comprising administering the nutrients and/or vitamins as described in the nutritional supplements above. Dosage amounts for each of the components will depend on each component. In some instances, exemplary doses for each component in the nutritional supplement supplied to the subject according to the methods of the present disclosure are provided in the table below.

| Nutrient | Dose per day | |
|---|---|---|
| Vitamin A Pre-Formed | 4000 | IU/day |
| Beta Carotene (IU) | 3333 | IU/day |
| Vitamin C (IU) | 200 | IU/day |
| Vitamin D (IU) | 2000 | IU/day |
| Vitamin E (IU) | 28.5 | IU/day |
| Vitamin K (mcg) | 90 | mcg/day |
| Thiamine (mg) | 6 | mg/day |
| Riboflavin (mg) | 2 | mg/day |
| Niacin (mg) | 35 | mg/day |
| Pantothenic Acid (mg) | 10 | mg/day |
| Vitamin B6 (mg) | 10 | mg/day |
| Biotin (mcg) | 100 | mcg/day |
| Folate (mcg) | 400 | mcg/day |
| Vitamin B12 (mcg) | 25 | mcg/day |
| Choline (mg) | 350 | mg/day |
| DHA (mg) | 600 | mg/day |
| Inositol (mg) | 500 | mg/day |
| Calcium | 525 | mg/day |
| Chromium | 100 | mcg/day |
| Copper | 1.3 | mg/day |
| Iodine | 220 | mcg/day |
| Iron | 30 | mg/day |
| Magnesium | 350 | mg/day |
| Manganese | 1 | mg/day |
| Molybdenum | 25 | mcg/day |
| Selenium | 60 | mcg/day |
| Zinc | 30 | mg/day |

Likewise, each of the recommended dosages provided in Table 2 may be administered to the subject, according to the methods of the present disclosure. For example, a subject who is trying to conceive (preconception) may be administered daily doses of each component as provided in Table 2. Likewise, a subject in the first, second or third trimester of pregnancy may be administered daily doses of each component as provided in Table 2. Any of the recommended doses of any of the components provided herein may be administered to a subject in need thereof, according to the methods of the present disclosure. This includes providing to the subject a nutritional supplement that is divided into one, two, or three dosage forms as provided herein. It would be of ordinary skill in the art to apply any of the suggested doses in Table 2 into a formulation and/or dosage form as provided in Table 1.

In various aspects, the method comprises administering to the subject, (a) about 4000 IU/day (1200 mcg/day) or about 1666 IU/day (about 500 mcg/day) of preformed vitamin A, about 100 mg/day, about 150 mg/day, about 175 mg/day, or about 200 mg/day of vitamin C, about 2000 IU/day (about 50 mcg/day) of Vitamin D, about 28.5 IU/day (about 19 mg/day), about 16 mg/day, about 20 mg/day, or about 15 mg/day of Vitamin E, about 46 mcg/day or about 90 mcg/day of Vitamin K, about 10 mg/day of Vitamin B6, about 25 mcg/day or about 36 mcg/day of Vitamin B12, about 3333 IU/day (1000 mcg/day), about 6666 IU/day (about 2000 mcg/day) or about 5000 IU/day (1500 mcg/day) of beta carotene, about 1.4 mg/day or about 6 mg/day of thiamine, about 1.4 mg/day or about 2 mg/day of riboflavin, about 18 mg/day, about 30 mg/day, about 35 mg/day or about 40 mg/day of Vitamin B3 (niacin/niacinamide), about 7 mg/day or 10 mg/day of pantothenic acid, about 50 mcg/day or about 100 mcg/day of biotin, about 400 mcg/day or 600 mcg/day of folate/folinic acid, about 350 mg/day or 600 mg/day of choline, about 500 mg/day or 600 mg/day of DHA, about 500 mg/day of inositol, about 200 mg/day, about 325 mg/day, about 425 mg/day, about 525 mg/day, or about 550 mg/day of calcium, about 50 mcg/day or 100 mcg/day of chromium, about 1.3 mg/day of copper, about 150 mcg/day or 220 mcg/day of iodine, about 25 mg/day, about 30 mg/day, about 45 mg/day, or about 60 mg/day of iron, about 140 mg/day, about 180 mg/day, about 260 mg/day, or about 350 mg/day of magnesium, about 1 mg/day of manganese, about 25 mcg/day of molybdenum, about 60 mcg/day or about 70 mcg/day of selenium, and about 10 mg/day, about 20 mg/day, about 25 mg/day, or about 30 mg/day of zinc. In other aspects, the method may comprise administering a daily dose of at least one sulfur containing compound, -carnitine, and/or lithium to the subject. In one aspect, the method comprises administering about 100 mg/day to about 1000 mg/day of a sulfur containing compound, about 100 mg/day to about 2000 mg/day of a carnitine (e.g., l-carnitine or acetyl-l-carnitine) and/or about 100 mcg/day to about 500 mcg/day of lithium to the subject.

In various aspects, the method may comprise administering one or more of the nutritional supplements provided herein to the subject. In one aspect, more than one supplement may be administered to achieve the recommended dosages of every component. For example, turning to Table 1, illustrative formulations (A) to (F) are provided. In one aspect, Formulation A is administered to the subject. In another aspect, Formulation B and Formulation C are administered to the subject. In other aspects, Formulation D, Formulation E, and Formulation F are administered to the subject. Further, In one aspect, a single dosage form comprising at least two components from Formulation A is administered to the subject, In another aspect, a pair of dosage forms comprising a first dosage form comprising at least two components of Formulation B, and a second dosage form comprising at least two components of Formulation C are administered to the subject. In another aspect, a triplet of dosage forms comprising a first dosage form comprising at least two components of Formulation D, a second dosage form comprising at least two components of Formulation E, and third dosage form comprising at least two components of Formulation F are administered to the subject.

Likewise, turning to Table 2, illustrative formulations are provided for each stage of pregnancy. In one aspect, a formulation designed as a general prenatal as provided in Table 2 is administered to the subject. In other aspects, a formulation designed for the first trimester, as provided in Table 2, is administered to the subject. In still other aspects, a formulation designed for the second trimester, as provided in Table 2, is administered to the subject. In still other aspects, a formulation designed for the third trimester, as provided in Table 2, is administered to the subject.

In various aspects, the method may comprise, or further comprise administering one or more sulfur containing compounds to the subject. The one or more sulfur containing compounds may be selected from the group consisting of n-acetylcysteine, sulforaphane, methyl-sufonyl-methane, thiamine tetrahydrofurfuryl disulfide (TTFD), benfotiamine, S-allyl cysteine, and Epsom salts. For example, the one or more sulfur containing compounds may comprise (a) n-acetylcysteine and methyl-sufonyl-methane; (b) at least one of n-acetylcysteine, sulforaphane; or (c) at least one of thiamine tetrahydrofurfuryl disulfide (TTFD), benfotiamine or S-allyl cysteine.

In various aspects, the method may comprise or further comprise administering l-carnitine and/or lithium to the subject. In one aspect, the method may further comprise administering potassium. In one aspect, the method may further comprise administering ribose.

In one aspect, the method may comprise administering DHA in a separate formulation.

### Definitions

Unless defined otherwise, all technical and scientific terms used herein have the meaning commonly understood by a person skilled in the art to which this invention belongs. The following references provide one of skill with a general definition of many of the terms used in this disclosure: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above-described cells and methods without departing from the scope of the invention, it is intended that all matter contained in the above description and in the examples given below, shall be interpreted as illustrative and not in a limiting sense.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Administration of Nutritional Supplement to Pregnant Women

A subject group of preconception, pregnant, and postnatal women will be assembled. Each person in the group will be provided the following nutrients according to the doses in the Table below (the Test group) or will be administered a standard Prenatal vitamin (Control) daily.

| Nutrient | Dose per day | |
|---|---|---|
| Vitamin A Pre-Formed | 4000 | IU/day |
| Beta Carotene (IU) | 3333 | IU/day |
| Vitamin C (IU) | 200 | IU/day |
| Vitamin D (IU) | 2000 | IU/day |
| Vitamin E (IU) | 28.5 | IU/day |
| Vitamin K (mcg) | 90 | mcg/day |
| Thiamine (mg) | 6 | mg/day |
| Riboflavin (mg) | 2 | mg/day |
| Niacin (mg) | 35 | mg/day |
| Pantothenic Acid (mg) | 10 | mg/day |
| Vitamin B6 (mg) | 10 | mg/day |
| Biotin (mcg) | 100 | mcg/day |
| Folate (mcg) | 400 | mcg/day |
| Vitamin B12 (mcg) | 25 | mcg/day |
| Choline (mg) | 350 | mg/day |
| DHA (mg) | 600 | mg/day |
| Inositol (mg) | 500 | mg/day |

Each group will be monitored for the following outcomes. The preconception group will be monitored for timeframe for achieving conception/successful pregnancy in addition to the following. Preconception and pregnancy groups will be monitored for: overall health of the pregnancy, growth of the fetus, fetal heartbeat or other physiological measurements, maternal health and physiology (glucose tolerance, cardiac activity, blood pressure), maternal mental health (depression, anxiety, etc). Development of any birth defects, pregnancy complications, loss of pregnancy, or any adverse effect will be noted. The postnatal/postpartum group will be monitored for the health of the mother and baby (cardiac activity, respiratory activity, neural activity, blood pressure, glucose tolerance, etc), maternal mental health (depression and/or anxiety), development of the baby (presence of any birth defects upon birth, growth trajectory). Additional features may be noted or monitored according to standard practice to gain a complete understanding of the health of the mother and baby from preconception, through pregnancy, and through the postnatal period when administered the nutritional supplement provided herein.

It is expected that the test group that is administered the nutrients at the doses provided above will experience more positive outcomes both for maternal and fetal/newborn health, as compared to the control group (receiving the standard prenatal vitamin).

### Example 2. Formulation of Nutrient Supplement

An oral dose of a nutrient supplement having the concentrations of each nutrient described in the table 4 below will be prepared.

TABLE 4

| Nutrients | Concentration |
|---|---|
| Vitamin A Pre-Formed | 4000 |
| (IU) | |
| Beta Carotene (IU) | 3333 |
| Vitamin C (mg) | 200 |
| Vitamin D (IU) | 2000 |
| Vitamin E (IU) | 28.5 |
| Vitamin K (mcg) | 90 |
| Thiamine (mg) | 6 |
| Riboflavin (mg) | 2 |
| Niacin (mg) | 35 |
| Pantothenic Acid (mg) | 10 |
| Vitamin B6 (mg) | 10 |
| Biotin (mcg) | 100 |
| Folate (mcg) | 400 |
| Vitamin B12 (mcg) | 25 |
| Choline (mg) | 350 |
| DHA (mg) | 600 |
| Inositol (mg) | 500 |

The oral dose will be prepared in a tablet and/or as a liquid formulation. Different methods of preparing the tablet will be used, including wet granulation, dry granulation or direct compression. Tablets formed in each method will be administered to human subjects and blood levels of each component will be measured at standard time points after administration. Standard methods of assaying blood levels of each nutrient will be used. Blood levels of each nutrient will be measured in pregnant and nonpregnant subjects to determine differences in absorption between pregnant and non-pregnant subjects.

### Example 3. Administration of Optimized Supplements to Women Based on Stage of Pregnancy

A subject group of preconception and pregnant (first, second and third trimester) women will be assembled. Each person in the group will be provided the following nutrients according to the doses in Table 4 (the Test group) or will be administered a standard Prenatal vitamin (Control) daily. The standard Prenatal vitamin will contain the Recommended Dietary Allowance (RDA) for pregnancy as provided in Table 5. Additional control groups (e.g., nonpregnant women) will be provided doses according to the Recommended Dietary Allowance (RDA) for women (Table 5).

TABLE 5

| | | | | | | | | | RDA - | RDA - |
|---|---|---|---|---|---|---|---|---|---|---|
| General | | | 1^{st} | | 2^{nd} | | 3^{rd} | | women | pregnancy |
| Prenatal | Preconception | | Trimester | | Trimester | | Trimester | | 19-30 yr | 10-30 yr |
| 1200 mcg | mcg as | | 1200 mcg | | 1200 mcg | | 1200 mcg | | 700 | 770 |
| Vitamin A as | retinol and | | as retinol | | as retinol; | | as retinol; | | | |
| retinol | 1000 mcg as | | 2000 mcg as | | 1500 mcg as | | 1000 mcg as | | | |
| 1000 mcg as | carotenoids | | carotenoids | | carotenoids | | carotenoids | | | |
| carotenoids | | | | | | | | | | |
| from LycoRed | | | | | | | | | | |
| Caromix | | | | | | | | | | |
| 200 mg | 100 | | 150 | | 175 | | 200 | | 75 | 85 |
| Vitamin C (as | | | | | | | | | | |
| calcium | | | | | | | | | | |
| ascorbate) | | | | | | | | | | |
| 2000 IU | Same | | Same | | Same | | same | | 15 mg | 15 mg |
| Vitamin D3 | | | | | | | | | (600 IU) | (600 IU) |
| (50 mg) | | | | | | | | | | |
| 19 mg Vitamin | 16 | | 25 | mg | 20 | mg | 15 | mg | 15 | 15 |
| E | | | | | | | | | | |
| as mixed | | | | | | | | | | |
| tocopherols | | | | | | | | | | |
| (primarily | | | | | | | | | | |
| gamma | | | | | | | | | | |
| tocopherols; | | | | | | | | | | |
| prefer sourced | | | | | | | | | | |
| from Organic | | | | | | | | | | |
| Technologies - | | | | | | | | | | |
| TC-45 P); | | | | | | | | | | |
| 45 mcg K1, 45 | 30 mcg K1, | | 45 mcg K1, | | 45 mcg K1, | | 45 mcg K1, | | 90 | 90 |
| mcg K2 | 30 mcg K2 | | 45 mcg K2 | | 45 mcg K2 | | 45 mcg K2 | | | |
| 6 mg Vitamin | 1.4 | mg | 6 | mg | 6 | mg | 6 | mg | 1.1 | 1.4 |
| B1 (as thiamin | | | | | | | | | | |
| hydrochloride) | | | | | | | | | | |
| 2 mg Vitamin | 1.4 | mg | Same | | Same | | same | | 1.1 | 1.4 |
| B2 | | | | | | | | | | |
| (Riboflavin) | | | | | | | | | | |
| 35 mg Vitamin | 18 mg as | | 15 mg | | 15 mg | | 15 mg | | 14 | 18 |
| B3 (20 mg as | Niacin | | niacin/15 mg | | niacin/20 mg | | niacin/25 mg | | | |
| Niacin, 15 mg | | | niacinamide | | niacinamide | | niacinamide | | | |
| as | | | | | | | | | | |
| Niacinamide) | | | | | | | | | | |
| 10 mg | 10 | mg | 10 | mg | 10 | mg | 10 | mg | 1.3 | 1.9 |
| pyridoxine | | | | | | | | | | |
| hydrochloride | | | | | | | | | | |
| (VITAMIN B6) | | | | | | | | | | |
| 600 mcg | 400 mcg | | 300 mcg | | 300 mcg | | 300 mcg | | 400 (+400 | 600 + 400 |
| MTHF | folinic | | MTHF | | MTHF | | MTHF | | supplemented | supplemented |
| (methyl-tetra- | acid | | 300 mcg | | 300 mcg | | 300 mcg | | if possibility | |
| hydrofolate) | | | folinic | | folinic | | folinic | | of pregnancy) | |
| (activated | | | | | | | | | | |
| folate) | | | | | | | | | | |
| 25 mcg as | 18 | | 18 | | 24 | | 36 | | 2.4 | 2.6 |
| hydroxocobala | | | | | | | | | | |
| min (vitamin | | | | | | | | | | |
| b12) | | | | | | | | | | |
| 100 mcg | 50 | | Same | | Same | | same | | 30 | 30 |
| Biotin | | | | | | | | | | |
| 10 mg | 7 | mg | 10 | | 10 | | 10 | | 5 | 6 |
| Pantothenic | | | | | | | | | | |
| acid (as | | | | | | | | | | |
| calcium d- | | | | | | | | | | |
| pantothenate) | | | | | | | | | | |
| 220 mcg | 150 | | 220 | | 220 | | 220 | | 150 | 220 |
| iodine (as | | | | | | | | | | |
| potassium | | | | | | | | | | |
| iodide) | | | | | | | | | | |
| 350 mg | same | | Same | | Same | | 600 | mg | 425 | 450 |
| Choline (as | | | | | | | | | | |
| choline | | | | | | | | | | |
| bitartrate) | | | | | | | | | | |
| 525 mg | 200 | | 325 | | 425 | | 525 | | 1000 | 1000 |
| Calcium (as | | | | | | | | | | |
| calcium | | | | | | | | | | |
| carbonate) | | | | | | | | | | |
| 350 mg | 70 mg Mg | | 90 mg Mg | | 130 mg | | 175 Mg mg | | 310 | 350 |
| Magnesium | glycinate, 70 | | glycinate, | | Mg | | glycinate, | | | |
| (half as | mg Mg malate | | 90 mg Mg | | glycinate, | | 175 Mg mg | | | |
| magnesium | | | malate | | 130 mg | | malate | | | |
| glycinate, half | | | | | Mg malate | | | | | |
| as magnesium | | | | | | | | | | |
| malate) | | | | | | | | | | |
| 30 mg zinc | 10 | | 20 | | 25 | | 30 | | 8 | 11 |
| (half as | | | | | | | | | | |
| sulfate, half as | | | | | | | | | | |
| amino acid | | | | | | | | | | |
| chelate) | | | | | | | | | | |
| 60 mcg | 50 | | 50 | | 60 | | 70 | | 55 | 60 |
| Selenium (as | | | | | | | | | | |
| selenomethionine) | | | | | | | | | | |
| 1 mg | same | | Same | | Same | | same | | 1.8 | 2.0 |
| Manganese | | | | | | | | | | |
| (as | | | | | | | | | | |
| manganese | | | | | | | | | | |
| aspartate) | | | | | | | | | | |
| 100 mcg | 50 | | Same | | Same | | Same | | 25 | 30 |
| Chromium (as | | | | | | | | | | |
| chromium | | | | | | | | | | |
| picolinate) | | | | | | | | | | |
| 25 mcg | same | | Same | | Same | | Same | | 45 | 50 |
| Molybdenum | | | | | | | | | | |
| (as | | | | | | | | | | |
| molybdenum | | | | | | | | | | |
| nicotinate | | | | | | | | | | |
| glycinate) | | | | | | | | | | |
| 100 mg | same | | Same | | Same | | Same | | 4700 | 4700 |
| Potassium | | | | | | | | | | |
| (potassium | | | | | | | | | | |
| chloride) | | | | | | | | | | |
| 30 mg iron as | 25 | | 30 | | 45 | | 60 | | 18 | 27 |
| iron glycinate | | | | | | | | | | |
| 1.3 mg copper | 0.5 | | 1.3 | | 1.2 | | 1.1 | | 0.9 | 1.0 |
| as copper | | | | | | | | | | |
| glycinate | | | | | | | | | | |
| 500 mg | none | | same | | same | | same | | | |
| inositol | | | | | | | | | | |

| | | | | | | | | |
|---|---|---|---|---|---|---|---|---|
| DHA - 500 mg | ( [symbol] ate softgel) | 500 | mg | 5 [symbol] | 500 | mg | Same | Same |

Each group will be monitored for the following outcomes. The preconception group will be monitored for timeframe for achieving conception/successful pregnancy in addition to the following. Preconception and pregnancy groups will be monitored for: overall health of the pregnancy, growth of the fetus, fetal heartbeat or other physiological measurements, maternal health and physiology (glucose tolerance, cardiac activity, blood pressure), maternal mental health (depression, anxiety, etc). Development of any birth defects, pregnancy complications, loss of pregnancy, or any adverse effect will be noted. The postnatal/postpartum group will be monitored for the health of the mother and baby (cardiac activity, respiratory activity, neural activity, blood pressure, glucose tolerance, etc), maternal mental health (depression and/or anxiety), development of the baby (presence of any birth defects upon birth, growth trajectory). Additional features may be noted or monitored according to standard practice to gain a complete understanding of the health of the mother and baby from preconception, through pregnancy, and through the postnatal period when administered the nutritional supplement provided herein.

It is expected that the test group that is administered the nutrients at the doses provided above will experience more positive outcomes both for maternal and fetal/newborn health, as compared to the control group (receiving the standard prenatal vitamin).

### Example 4. Improved Prenatal Vitamin/Mineral Supplements for Women in the US

The blood levels of most vitamins decrease during pregnancy if un-supplemented, including vitamins A, C, D, K, B1, B3, B5, B6, folate, biotin, and B12. Sub-optimal intake of vitamins from preconception through pregnancy increases the risk of many pregnancy complications and infant health problems. In the U.S., dietary intake of vitamins is often below recommended intakes, especially for vitamin D, choline and DHA. Many studies suggest that insufficient vitamin intake is associated with a wide range of pregnancy complications (anemia, Cesarean section, depression, gestational diabetes, hypertension, infertility, preeclampsia, and premature rupture of membranes) and infant health problems (asthma/wheeze, autism, low birth weight, congenital heart defects, intellectual development, intrauterine growth restriction, miscarriage, neural tube defects, orofacial defects, and preterm birth). The primary goal of the inventors was to determine the optimal level of prenatal supplementation for each vitamin for most women in the United States. A secondary goal was to compare these new recommendations with the levels of vitamins in over 180 commercially available prenatal supplements. The inventors' analysis found that prenatal supplements vary enormously in content, often contain only a subset of essential vitamins and those at levels below the inventors' recommendations. The inventors' analysis indicates that increasing prenatal vitamin supplementation to the levels recommended herein by the inventors may reduce the incidence of many pregnancy complications and infant health problems which currently occur.

Vitamins are by definition essential for optimal health and development, and a deficiency of any one vitamin can lead to serious illness. Although a very healthy diet rich in vegetables, fruits, whole grains, protein, and healthy fats can provide sufficient amounts of most vitamins, analysis of the National Health and Nutrition Examination Survey (NHANES) finds that diet quality in the United States is generally “poor”. During pregnancy, there are increased nutritional demands including an increased need for vitamins to promote a healthy pregnancy and a healthy baby. The blood levels of many vitamins decrease during pregnancy unless supplemented. Therefore, prenatal supplements are necessary to assure adequate intake during preconception, pregnancy and breastfeeding.

The US Food and Drug Administration (FDA) has established Recommended Dietary Allowances (RDA) for total vitamin intake from food and supplements, but there is no national consensus on the optimal level of most vitamins for a prenatal supplement. Therefore, there is a wide variation in the content of prenatal supplements on the market today.

Pregnancy complications are common in the US, as shown in Table 6, and many children born in the US have significant health problems, as shown in Table 7. The present disclosure demonstrates that low levels of vitamin intake during pregnancy contribute to many of these problems, and that appropriate prenatal vitamin supplementation may reduce their risk.

TABLE 6
Rates of Pregnancy and Birth Complications in the US

| Complication | Rate |
|---|---|
| Infertility (women) | 6% |
| Miscarriages | 15-20% # |
| Gestational diabetes | 8% |
| Preeclampsia | 4% |
| Iron deficiency anemia in mother | 27.5% in third trimester |
| Caesarean sections | 32% |
| Still births | 1% |
| Low birth weight | 8% |
| Preterm births | 10% |
| Postpartum depression | 11.5% |

# The estimated rate of miscarriages after a woman knows she is pregnant is 15-20%, but the actual number of fertilized eggs that spontaneously abort is estimated to be up to 50%

TABLE 7
Incidence of some mental and physical
health disorders in children in the US:

| Disorder | Incidence |
|---|---|
| Autism | 2% |
| Birth Defect (heart, other) | 3% |
| ADHD | 9.4% |
| Learning Disabilities | 8% |
| Asthma | 7.5% |
| Food Allergies | 5.1% |
| Skin Allergies | 12.5% |
| Respiratory Allergies | 17.0% |
| Childhood Obesity | 18.5% |

This disclosure provides recommendations for the optimal level of prenatal supplementation for each vitamin and related nutrients (for example, but not limited to choline, inositol, and DHA) for most pregnant women in the United States

It should be noted that the recommendations disclosed herein are based in part on the inventors' analysis of the NHANES data of daily intake by women in the US, so the recommendations are intended for women in the US. Similar recommendations could be determined for other parts of the world based upon the inventors' analysis as applied to a known average daily intake of vitamins.

### Example 6. Optimal Prenatal Vitamin/Mineral Supplement for Women in the US: Methods

The present disclosure focuses on selected vitamins and three related nutrients (choline, inositol, and DHA) and each vitamin/nutrient was evaluated separately for background, current recommended daily dietary intake (as estimated from the National Health and Nutrition Examination Survey-NHANES), Recommended Dietary Allowance, the inventors' interpretation of the data, and statistics on prenatal supplements currently on the market.

Since the available information was vast, the inventors developed an approach that primarily focused on available information about so-called “optimal” dosage such as treatment studies on the effects of different doses on outcomes and biomarkers. Greater consideration was given to larger studies with a more rigorous design such as randomized, double-blind, placebo-controlled studies. When available, meta-analyses and systematic reviews were included; however, the limitation of those studies was that they generally asked whether or not a symptom was related to a vitamin deficiency or improved due to vitamin supplementation but generally did not attempt to estimate the optimal level of supplementation. The inventors' analysis considered: (1) the associations of low levels of vitamins with health problems, (2) changes in vitamin levels during pregnancy if un-supplemented or supplemented, and (3) clinical trials on the effect of vitamin supplementation on certain health problems. Each of these three considerations involved separate analyses for each vitamin/nutrient.

The NHANES data as referenced herein was used for dietary intake only (not supplements) of each nutrient, since it was assumed that most women will stop other vitamin/mineral supplements when they start a prenatal supplement. The inventors focused on data for women ages 20-39 years, since that is the most common time for pregnancy in the US, and averages for other ages were generally similar. The 2017-2018 NHANES data for the nutrients were used, and otherwise the 2009-2010 reported data was used. The NHANES data on dietary intake for each vitamin/nutrient was useful for comparing to the RDA, to determine if the average intake is sufficient for most women. However, it is important to note that only the averages were reported, and some women did have higher or lower intake.

The RDA was based on the levels required to meet the nutritional needs of 97.5% of healthy individuals, as opposed to the Estimated Average Requirements (EAR) which was set at the level needed to meet the needs of 50% of the population. Therefore, the RDA was focused, as the goal is to meet the nutritional needs of most pregnant women. In the cases where the RDA was higher than the NHANES intake, the difference provided an estimate of the needs for nutritional supplementation during pregnancy. However, in some cases literature review suggested that higher levels were needed to reduce the risk of pregnancy complications and infant health problems.

The ultimate goal was to determine recommendations for the optimal level of each vitamin for a prenatal supplement based on the inventor's meta-analysis of currently available information. A key point is trying to balance the benefit of additional supplementation for those women with the lowest levels of vitamins vs. the risk of adverse effects for women with the highest levels of vitamins. No single formulation is ideal for every person. However, because personalized testing to determine individualized prenatal supplementation is rare, it is important to develop objectively based recommendations for the general population while encouraging physicians and nutritionists to personalize recommendations to the extent possible.

In most cases the inventors' recommendations were for a constant amount of nutrient supplementation during pregnancy, as the effect of varying dosage during pregnancy has generally not been explored. However, for iron and choline increasing levels of supplementation during pregnancy were recommended, for reasons discussed elsewhere herein.

A comprehensive list of 188 prenatal supplements currently on the market was built primarily using two databases created by The National Institutes of Health (NIH): The Dietary Supplement Label Database (DSLD) and DailyMed. Although both databases include an extensive list of prenatal supplements, some products listed were outdated and can no longer be purchased or have changed ingredients. Therefore, the list was updated using information on manufacturer websites (when available) or from labels on retail websites such as Amazon. The contents of these prenatal supplements were then analyzed and compared against the inventors' recommendations as disclosed herein.

Tables 8-9 provide a list of the pregnancy complications and infant health conditions, respectively, associated with one or more nutrients. Tables 10-11 show the same information, but organized by nutrient instead of by health condition.

TABLE 8
Relationship of maternal health problems to vitamin status. A “M”
is added to studies which are meta-analyses or systematic reviews.

| Maternal Outcome | Substantial Evidence | Limited Evidence |
|---|---|---|
| Abdominal Pain | | Vitamin C |
| Anemia | Riboflavin | |
| | Vitamin A | |
| Cesarean Section | Vitamin D | |
| Dental Decay | | Pyridoxine |
| Depression | DHA | |
| Eclampsia | | Vitamin A; |
| | | Vitamin E |
| Gestational Diabetes | Cobalamin | Inositol |
| | DHA | |
| Glucose Levels | Inositol | |
| Hospitalization | | Vitamin C |
| Hyperglycemia | | Vitamin E |
| Hypertension | Vitamin D | Riboflavin |
| Infection | | Vitamin D |
| Infertility | Cobalamin | Inositol |
| Insulin Resistance | | Vitamin E |
| Megaloblastic Anemia | | Folate |
| Nausea/Vomiting during | | Pyridoxine |
| Pregnancy | | |
| Night Blindness | Riboflavin | Vitamin A |
| Pernicious Anemia | | Cobalamin |
| Polycystic Ovarian | | Inositol |
| Syndrome | | |
| Preeclampsia | Cobalamin; | Pyridoxine |
| | Vitamin D; | Riboflavin |
| | DHA | Vitamin A |
| | | Vitamin C |
| | | Vitamin E |
| Premature Rupture of | Vitamin C | |
| Membranes (PROM) | Vitamin E | |
| Secondary | | Vitamin D |
| Hyperparathyroidism | | |
| Urinary Tract Infection | | Vitamin C |

TABLE 9
Relationship of infant health problem to maternal vitamin status.

| Infant Outcome | Significant Evidence | Limited Evidence |
|---|---|---|
| Alzheimer's | | Choline |
| Asthma/Wheeze | Vitamin D | Vitamin C |
| | Vitamin E | |
| Autism | Folate | Vitamin B12 |
| | Vitamin D | |
| Birth Weight | Pantothenic Acid | Vitamin C |
| | Pyridoxine | Thiamine |
| | Cobalamin | Niacin |
| | | DHA |
| Cardiovascular | | Pyridoxine |
| malformation | | |
| Congenital Heart | Cobalamin | Vitamin A; |
| Defects | Vitamin E | Niacin; |
| | | Riboflavin |
| Down Syndrome | | Choline |
| Gestational Length | | DHA |
| Hyperbilirubinemia | | DHA |
| Insulin resistance | | Cobalamin |
| Intellectual Development | DHA | Cobalamin |
| Intrauterine Growth | Cobalamin | Thiamine |
| Restriction | | |
| Language Difficulties | | Vitamin D |
| | | Folate |
| Leanness | | DHA |
| Lung Function | | Vitamin A |
| | | Vitamin C |
| Memory | | Choline |
| | | Cobalamin |
| Miscarriage | Cobalamin | Vitamin D |
| Neonatal Care | | DHA |
| Admissions | | |
| Neural Tube Defects | Cobalamin | Choline |
| | Folate; | Niacin |
| | Inositol | Thiamine |
| Neurodevelopmental | | Pyridoxine |
| Behavior Problem | | |
| Orofacial Defects | Folate | Vitamin A |
| | | Vitamin C |
| | | Vitamin E |
| | | Biotin |
| | | Pyridoxine |
| Learning Disabilities | | Thiamine |
| Perinatal Death | | DHA |
| Placental Abruption | Vitamin E | |
| Preterm Birth | DHA | Pyridoxine |
| | Vitamin D | Folate |
| | Vitamin E | |
| | Cobalamin | |
| Psychomotor | | DHA; |
| Scores/Skills | | Vitamin D |
| Risk for Serious Birth | Folate | Riboflavin |
| Defects | | |
| Small for Gestational | Cobalamin | |
| Age | Folate | |
| Vitamin K Deficient | Vitamin K | |
| Bleeding (Often | | |
| intercranial hemorrhage) | | |

TABLE 10
Relationship of vitamins to maternal health problems.

| Vitamin | Significant Evidence | Limited Evidence |
|---|---|---|
| Vitamin A | Anemia | Night Blindness |
| | | Preeclampsia |
| | | Eclampsia |
| Vitamin C | Premature Rupture of | Abdominal Pain; |
| | Membrane | Hospitalizations |
| | | Preeclampsia |
| | | Urinary Tract Infection |
| Vitamin D | Cesarean section | Hypertension |
| | Preeclampsia | Infection |
| | | Secondary Hyperparathyroidism |
| Vitamin E | Premature Rupture of | Eclampsia; |
| | Membrane | Hyperglycemia; |
| | | Insulin Resistance; |
| | | Preeclampsia |
| Vitamin K | | |
| Vitamin B1 | | Glucose Tolerance |
| (Thiamine) | | |
| Vitamin B2 | Anemia | Hypertension |
| (Riboflavin) | Night blindness | Preeclampsia |
| Vitamin B3 | | |
| (Niacin) | | |
| Vitamin B5 | | |
| (Pantothenic | | |
| Acid) | | |
| Vitamin B6 | | Dental Decay, |
| (Pyridoxine) | | Nausea/Vomiting Preeclampsia |
| Vitamin B7 | | |
| (Biotin) | | |
| Vitamin B9 | Megaloblastic Anemia | |
| (Folate) | | |
| Vitamin B12 | Gestational Diabetes | |
| (Cobalamin) | Infertility | |
| | Pernicious Anemia | |
| | Preeclampsia | |
| Choline | | |
| DHA | Depression | |
| | Gestation Diabetes | |
| | Preeclampsia | |
| Inositol | Glucose Levels | Polycystic Ovarian Syndrome |
| | Infertility | Gestational Diabetes |

TABLE 11
Relationship of maternal vitamin status to infant health problems.

| Vitamin | Significant Evidence | Limited Evidence |
|---|---|---|
| Vitamin A | | Heart Defects |
| | | Orofacial Defects |
| | | Impaired Lung Function |
| Vitamin C | | Wheeze |
| | | Low Birth Weight; |
| | | Orofacial Clefts; |
| | | Infant Pulmonary Function |
| Vitamin D | Autism | Miscarriage; |
| | Preterm Birth; | Language Difficulties |
| | Asthma/Wheeze | Psychomotor Skills |
| Vitamin E | Congenital Heart Defects; | |
| | Orofacial Clefts | |
| | Preterm Birth | |
| | Placental Abruption | |
| | Wheeze | |
| Vitamin K | Vitamin K Deficient Bleeding | |
| | (Often intercranial hemorrhage) | |
| Vitamin B1 | | Anencephaly |
| (Thiamine) | | Low Birth Weight; |
| | | Intrauterine growth retardation |
| | | Learning Disabilities |
| Vitamin B2 | | Low Birth Weight; |
| (Riboflavin) | | Birth defects; |
| | | Heart defects |
| Vitamin B3 | | Spina Bifida, |
| (Niacin) | | Heart Defect; |
| | | Birth Weight |
| Vitamin B5 | Low Birth Weight | |
| (Pantothenic | | |
| Acid) | | |
| Vitamin B6 | Birth Weight | Orofacial Defect; |
| (Pyridoxine) | | Neurodevelopmental Behavior |
| | | Problem; |
| | | Cardiovascular Malformation |
| | | Preterm Birth |
| Vitamin B7 | | Orofacial Defect |
| (Biotin) | | |
| Vitamin B9 | Cleft Lip/Palate Defect | Preterm Birth; |
| (Folate) | Heart Defects; | Severe Language Delay |
| | Limb Defects; | |
| | Neural Tube Defects; | |
| | Autism; | |
| | Small for Gestational Age | |
| Vitamin B12 | Heart defect; | Memory; |
| (Cobalamin) | Intrauterine Growth Restriction; | Insulin resistance |
| | Low birth weight | |
| | Miscarriage; | |
| | Neural Tube Defects | |
| | Preterm birth; | |
| | Small for Gestational Age | Autism |
| | Spontaneous Abortion | |
| Choline | | Alzheimer's; |
| | | Down Syndrome; |
| | | Memory Scores; |
| | | Neural Tube defects |
| DHA | Brain Development; | Psychomotor skills; |
| | Gestational Length; | Gestational Size; |
| | Macrosomia; | Leanness; |
| | Preterm Birth | Perinatal Death; |
| | Hyperbilirubinemia | Neonatal Care Admissions; |
| | | Wheeze |
| Inositol | Neural tube defects; | |
| | Spina Bifida | |

### Example 6. Optimal Prenatal Vitamin/Mineral Supplement for Women in the US: Vitamin A

### Research:

Vitamin A is an important fat-soluble antioxidant. It is crucial for the growth of most cells and organs, including the eyes, heart, and lungs. Low vitamin A during pregnancy is associated with night blindness and anemia in mothers (see Table 10). For infants born to mothers with lower levels of vitamin A, there is an increased risk of severe vision problems, heart defects, orofacial defects, delayed growth, and impaired lung function (see Table 11).

Retinol levels decrease steadily during pregnancy if not supplemented. According to two US studies, pregnant women are more likely to be deficient in vitamin A than healthy non-pregnant women, even after supplementation. Baker et al. found that 33% of un-supplemented pregnant women in the US were vitamin A deficient, vs. 17% of women who supplemented with 4000-6000 IU; none in either group were deficient in beta-carotene. Another large US study investigated supplementation with 5000 IU/day of vitamin A (50% as beta carotene). They found that despite supplementation vitamin A levels were 27% lower in pregnant women during first, second, and third trimesters compared to healthy non-pregnant controls. In contrast, beta-carotene levels were only slightly lower during the first trimester, and increased to slightly above normal by the end of pregnancy. Overall, these studies suggest that higher levels of supplementation of vitamin A, but not carotenoids, are needed during pregnancy.

According to the World Health Organization, 4.4% of pregnant women in North and South America experience night blindness during pregnancy. In Nepal, 7000 mcg/week of vitamin A reduced the occurrence of night blindness during pregnancy by 67%; beta-carotene had about half as much benefit. Since night blindness still occurred in some women during the study, a higher dose is likely needed.

One small study found that women who had preeclampsia and eclampsia had much lower levels of vitamin A and beta-carotene.

A meta-analysis of 8 studies found that vitamin A or beta-carotene supplementation significantly improved hemoglobin levels and thus modestly reduced the risk of anemia (RR=0.81 [0.69, 0.94]).

Near the end of gestation, it is important to have adequate maternal vitamin A status to maximize the vitamin A transferred to the fetus Vitamin A stores are recommended to be replenished in late gestation to prepare for breastfeeding. One study has shown that high vitamin A levels were associated with more efficient lung function of offspring. Another study found that the risk of orofacial clefts was significantly lower in mothers with higher dietary intakes (1677-2019 mcg/day) of beta carotene (OR 0.6). Researchers in the US found that the lowest quartile of dietary intake of vitamin A was associated with a significantly higher risk of a serious heart defect in the offspring (OR=3.4).

### Daily Intake and RDA:

The NHANES study found that from 2009 to 2010, the average daily dietary intake of vitamin A of US women ages 20-39 years was 596 mcg/day, which is less than the RDA of 770 mcg for pregnant women ages 19-30 years. The Tolerable Upper Limit of pre-formed vitamin A is 3000 mcg, and there is no upper limit on beta-carotene or other carotenoids.

Discussion: Vitamin A levels decrease during pregnancy, the average intake is below the RDA, and 2500 IU (750 mcg)/day of retinol was insufficient for women in the US to increase levels to that of non-pregnant US women. Therefore, higher levels of retinol are needed. Beta-carotene or mixed carotenoids may also be helpful, but are insufficient even at normal levels to normalize levels of retinol (active form of vitamin A).

### Recommendation:

For US women, the inventors recommend that prenatal supplements contain 1200 mcg of pre-formed vitamin A (as retinol), and 1000 mcg as mixed carotenoids (mixed carotenoids are probably preferred over beta-carotene, since human food contains a mixture of about 40-50 carotenoids, including primarily α-Carotene, β-carotene, β-cryptoxanthin, lutein, zeaxanthin, and lycopene). Giving mixed carotenoids alone is insufficient to maintain normal vitamin A levels, so it is important that about 1200 mcg be provided as pre-formed vitamin A to maintain normal vitamin A levels. Re. pre-formed vitamin A, both retinol and retinyl forms are available, but the inventors recommend retinol since retinyl needs to be transformed into retinol. This recommendation appears likely to reduce the risk of night blindness and anemia in mothers, and may reduce the risk of vision problems, heart defects, orofacial defects, and impaired lung function in their infants.

### Excessive Vitamin A:

High doses of vitamin A are used in certain medications for treating acne, psoriasis, and aging, including isotretinoin (Accutane), etretinate (Tegison), or retinol. Women should wait at least 6-12 months after stopping these medications before conceiving a child as there are concerns about these forms of vitamin A storing in the body for prolonged periods, leading to a wide array of birth defects and spontaneous abortions.

### Comparative Prenatal Supplements:

Pre-formed Vitamin A (retinol) is included in 35% of prenatal supplements ranging from 500 to 8000 IU, and the median level is 2487. IU (Q1: 1962.5/Q3: 4000). Only 13% of prenatals meet or exceed our recommendation for pre-formed Vitamin A.

Beta Carotene is included in 73% of prenatal supplements ranging from 80 to 10000 IU, and the median level is 3040.0 IU (Q1: 2000/Q3: 4000). 34% of prenatals meet or exceed our recommendation.

### Example 7. Optimal Prenatal Vitamin/Mineral Supplement for Women in the US: Vitamin C

### Research:

Vitamin C is an important water-soluble antioxidant, and is a co-factor for many enzymatic reactions, including the production of collagen, carnitine, and neuropeptides. During pregnancy, vitamin C is important for the growth and repair of collagen and helps maintain strong bones and teeth. A deficiency in vitamin C during pregnancy may lead to premature rupture of membranes (PROM) and preterm birth due to PROM, preeclampsia, and urinary tract infections in the mother (see Table 10). Low gestational vitamin C may cause low birth weight, orofacial clefts, and decreased pulmonary functioning for infants (see Table 11).

According to the NHANES study, vitamin C deficiency or depletion existed in 32% of women ages 25-44 in the US. Vitamin C levels decrease about 30% during pregnancy if not supplemented. One study measured vitamin C levels during pregnancy after supplementation with 120 mg, and found that about 10% were still deficient, suggesting more is needed. Researchers found that 100 mg supplementation of vitamin C was enough to maintain a constant leukocyte concentration (storage) of vitamin C, but not enough to maintain plasma concentrations. A detailed pharmacokinetic analysis by Levine et al. in 2001 of non-pregnant women found that steady-state doses of 100, 200, 400, and 1000 mg/day achieved plasma levels approximately 79%, 88%, 95%, and 97%, respectively of the dosage at 2500 mg. Similar but slightly higher percentages were found for cells (neutrophils). They recommend an RDA of 90 mg to achieve 80% of the saturated value of vitamin C in most women (not accounting for pregnancy when nutrient demands are higher).

A Cochrane meta-analysis found that vitamin C supplementation alone was associated with a 34% reduced risk of preterm PROM (RR 0.66, 1282 participants from five studies) and 45% reduced risk of term PROM (RR 0.55, 170 participants). Preterm PROM is important because about ⅓ of all preterm births are due to this pregnancy complication. The present inventors observed that vitamin C only reduced the risk of PROM, but not the risk of preterm birth or other pregnancy outcomes. Two of the studies which found an effect on PROM involved doses of 100 mg/day, and two studies that used higher doses (500-1000 mg) found non-significant lower rates of PROM. So. 100 mg/day seems sufficient to reduce the risk of PROM, and much higher doses are probably not better.

A study in Uganda found that 400 mg of vitamin C significantly reduced hospitalization during pregnancy (42% vs. 28% for placebo), where hospitalization during pregnancy is common (primarily for anemia and respiratory infections). In Mexico, researchers found that 100 mg/day of vitamin C significantly reduced the rate of urinary tract infections during pregnancy (13% vs. 29%, p=0.03).

Another meta-analysis of 10 trials of antioxidants (mostly combined vitamin C and E) found no significant difference between treatment and control groups for the risk of preeclampsia, severe preeclampsia, preterm birth, small-for-gestational-age infants, or any baby death. The treatment group were more likely to report abdominal pain late in pregnancy (RR 1.61; one trial, 1745 women), need antihypertensive therapy (RR 1.77; two trials, 4272 women), and need hospital admission due to hypertension (RR 1.54, 95% CI 1.00 to 2.39; one trial, 1877 women). So, vitamin C therapy alone seems more helpful than vitamin C combined with alpha-tocopherol; we hypothesize that the problem may be due to the use of only alpha-tocopherol, instead of a mixture of tocopherols. However, another study of 160 women at high risk for preeclampsia found a much lower risk of preeclampsia in the group supplemented with vitamins C and E, compared to the placebo group (8% vs. 26%, respectively). Another double-blind multicenter trial (17 centers in Canada and 10 in Mexico) of 2647 women found that daily treatment of Vitamin C (1 g) and Vitamin E (400 IU) did not affect gestational hypertension or preeclampsia, but increased the risk of fetal loss or perinatal death as well as preterm prelabor rupture of membranes. So, these studies provide additional evidence that the combination of high-dose vitamin C and high-dose vitamin E are not helpful and are likely harmful.

In regard to infant outcomes, researchers found that 500 mg/day of vitamin C improved infant pulmonary function and significantly decreased wheezing through age 1 year. The risk of orofacial clefts was significantly lower in mothers with dietary intakes of 110-129 mg/day of vitamin C (OR 0.4) or 129-300 mg/day (OR 0.6). Children with birth weight in the lowest decile were associated with women consuming diets low in vitamin C (OR 0.79, P=0.028).

### Daily Intake and RDA:

The NHANES study found that from 2017 to 2018, the average daily dietary intake of vitamin C of US women aged 20-39 was 71 mg/day. The current RDA is 85 mg/day for pregnant women. The Tolerable Upper Limit for pregnant women is 2000 mg/day.

Discussion: Vitamin C levels decrease significantly during pregnancy unless supplemented, and average dietary intake is slightly below the RDA. 32% of women in the US have vitamin C deficiency or depletion. Two supplementation studies found that 100-120 mg/day was not quite sufficient during pregnancy to normalize biomarkers of insufficiency. Dosages of 100-1000 mg/day were effective for treating PROM, a dosage of 100 mg/day reduced risk of urinary track infections, a dosage of 400 mg/day reduced risk of hospitalization, and 500 mg/day improved pulmonary function. Altogether, the data suggests that 100 mg/day is effective, and somewhat more may be beneficial.

### Recommendation:

For US women, the inventors recommend that prenatal supplements contain approximately 200 mg of vitamin C. This recommendation appears likely to reduce the risk of premature rupture of membranes and may reduce the risk of anemia, preeclampsia, urinary tract infections, and orofacial clefts, and may improve pulmonary function in infants.

Comparison with Commercial Prenatal Supplements:

Vitamin C is included in 96% of prenatal supplements; when included, the median level is 100 mg (Q1: 60/Q3: 120). Only 8% meet or exceed our recommendation for Vitamin C.

### Example 7. Optimal Prenatal Vitamin/Mineral Supplement for Women in the US: Vitamin D

### Research:

Vitamin D is important for bone growth and immune function, together with vitamin K2. Low vitamin D can cause growth delays and bone deformation (rickets). Vitamin D deficiency during pregnancy is associated with a higher risk for miscarriage, preterm birth, and C-section, and a higher risk of the child developing asthma, language difficulties, and autism (see Tables 10 and 11). Supplementing with additional vitamin D during pregnancy reduces the incidence of preeclampsia, preterm birth, infection, hypertensive disorders in pregnancy, and secondary hyperparathyroidism, and increases infant mental and psychomotor scores.

Vitamin D levels decrease substantially at the start of pregnancy if not supplemented, and remain low during pregnancy. One study of 494 pregnant women in the southern part of the US at less than 14 weeks gestation measured 25 hydroxyvitamin D levels by radioimmunoassay and found that 41% of pregnant women were deficient (25 (OH) D levels<20 ng/ml) in addition another 41% were insufficient (25 (OH) D levels 20-32 ng/ml). The rate of vitamin D deficiency/insufficiency was highest in African Americans (97%) and Hispanic women (81%) and lowest in Caucasian women (67%). Low vitamin D during pregnancy is strongly associated with birth complications and gestational disorders for the mother if not corrected. A vitamin D deficiency is linked to: a greater than double the risk of a miscarriage in the first trimester; tripling the risk of preterm birth if low in the 3rd] trimester (p=. 01); double the risk of preeclampsia; and increased risk of C-section (56). Vitamin D supplementation of 400-600 IU/day during pregnancy has been shown to significantly reduce the risk of preeclampsia by 29% after cofounder adjustment. Supplementation with 800 IU/day greatly decreased the rate of maternal secondary hyperparathyroidism, from 27% of women to 10%. Supplementation of 2000-4000 IU/day resulted in higher blood levels than just 400 IU/day, and higher levels of vitamin D were associated with substantially lower risks of preeclampsia, preterm birth, infection, hypertensive disorders of pregnancy, and other health problems. A blood level of 40 ng/ml or higher results in a 57% lower risk of preterm birth compared to women with levels below 20 ng/ml.

Low vitamin D in pregnant women doubled the risk of the child developing significant language difficulties. Gestational vitamin D deficiency was associated with an almost 4 times greater likelihood of autism-related traits in a large population-based sample of over 8,000 mothers, and a deficiency at birth was associated with an increased risk of autism in another smaller study analyzing blood samples from children with autism and their typical sibling pairs. When mothers have a circulating concentration greater than 30 ng/ml of 25 (OH) D, their infants have higher mental and psychomotor scores than compared to mothers with concentrations of 20 ng/ml.

A meta-analysis of 32 studies found that higher maternal vitamin D intake (OR=0.58) was associated with lower odds of wheeze during childhood. Another study found a causal relationship between vitamin D deficiency during pregnancy and asthma at 6 years of age, but only in boys. A combined analysis of two treatment studies (using doses of 2400 IU/day and 4000 IU/day) found that maternal vitamin D supplementation significantly reduced the risk of asthma/recurrent wheeze at 0-3 yrs: adjusted odds ratio (OR)=0.74 (95% CI, 0.57-0.96), p=0.02. The effect was strongest for women with initial vitamin D levels above 30 ng/ml compared to those with initial levels below 30 ng/ml, suggesting a need for levels above 30 ng/ml.

### Daily Intake and RDA:

The NHANES study found that the average daily dietary intake of vitamin D of US women aged 20-39 was 136 IU/day, which is much less than the RDA recommendation of 600 IU/day for pregnant women. Women receive about 26% of their vitamin D from their diets. The Tolerable Upper Limit is 4000 IU/day. Note that vitamin D is also produced by the body after exposure to direct sunlight, but clothing, sunscreen lotion and, windows block the part of the sunlight needed to produce vitamin D. Thus, many people receive insufficient vitamin D from sunlight, especially those that are darker-skinned, have less exposure to direct sunlight or live farther from the equator, so they are at greater risk of vitamin D deficiency.

### Discussion:

Vitamin D levels decrease significantly during pregnancy unless supplemented, and most US women consume much less than the RDA. Most women in the US have vitamin D deficiency/insufficiency during pregnancy, especially those with dark skin (Hispanic and Black). Supplementation of 2000-4000 IU/day resulted in higher blood levels than just 400 IU/day, and higher levels of vitamin D were associated with substantially lower risks of preeclampsia, preterm birth, infection, hypertensive disorders of pregnancy, and other health problems. The RDA is only 600 IU/day, but that seems insufficient during pregnancy.

### Recommendation:

Therefore, the inventors recommend at least 2000-4000 IU/day, measuring blood levels of vitamin D (as 25 (OH) D) and aiming for a level of at least 30 ng/ml, and preferably 40 ng/ml. Women with darker skin (Hispanic and especially Black) are at highest risk and likely to need more vitamin D.

Comparison with Commercial Prenatal Supplements:

Vitamin D is included in 98% of prenatal supplements; when included, the median level is 550 IU (Q1: 400/Q3: 1000). Only 6% meet or exceed our recommendation for Vitamin D.

### Example 8. Optimal Prenatal Vitamin/Mineral Supplement for Women in the US: Vitamin E

### Research:

Vitamin E is an important fat-soluble antioxidant. In pregnancy, low vitamin E intake is associated with hyperglycemia, preterm births, preterm placental rupture of membranes (PROM), and placental abruption (see Table 5). The offspring of women who had low vitamin E levels had an increased risk of wheeze, orofacial clefts, and serious heart defects (see Table 6). There were troubling reports from several studies when very high dose vitamin E (400 IU) and vitamin C were combined, including an increase in fetal loss and perinatal death, abdominal pain, term PROM, and preterm PROM.

A study in the Netherlands found that levels of alpha-tocopherol approximately doubled during pregnancy. A study in the US found that supplementing with 30 IU of vitamin E was sufficient to increase levels 50% by the third trimester, which is likely beneficial since most women in the US consume only about half of the RDA. Lower vitamin E intake during the second trimester was related to hyperglycemia and insulin resistance later in pregnancy. One small study found that women who had preeclampsia and eclampsia had lower vitamin E levels.

A large non-randomized population-based study found that pregnant women consuming high doses (about 450 mg/day, or about 675 IU/day) of vitamin E had a lower rate of preterm births (6.6% vs. 9.3%) than those not consuming high-dose vitamin E. A similar analysis found that if a woman had preeclampsia during pregnancy and then supplemented with very high doses of vitamin E (approximately 200-600 mg/day), there was a decreased risk in preterm births (8.6% vs. 10.4% for unsupplemented women with preeclampsia). Due to the non-randomized nature of these studies, the results need to be interpreted cautiously.

Vitamin E intake during pregnancy affects some childhood health conditions as well. A meta-analysis of 32 studies of maternal dietary intake found that higher maternal intake of vitamin E (OR=0.6, 95% CI=0.46-0.78) was associated with lower odds of wheeze during childhood (but not necessarily asthma). Mothers of children with orofacial clefts had significantly lower levels of intake of vitamin E (9% lower, P=0.04). Mothers with the highest dietary intake of vitamin E (15-22 mg) were 40% less likely to have a child with orofacial clefts (OR 0.6; 95% CI, 0.3-1.3, p=0.14).

Two studies found conflicting evidence for the role of vitamin E intake and risk of congenital heart defects (CHD). A case-control study of 276 mothers of infants with congenital heart defects and 324 controls found that for the subset of mothers who did not take a prenatal with vitamin E, there was no significant effect of vitamin E intake on the risk of CHD. However, for the small subset of mothers (36 cases, 39 controls), who took a prenatal with vitamin E (of unknown amount) there was a 5-9 times higher risk of CHD if dietary intake of vitamin E was in the upper half (12.6-33.8 mg/day). Conversely, Shaw et al. examined nutrient intakes of 318 mothers of infants with congenital heart defects and 700 control mothers. For the subset who did not use prenatal vitamins supplements (52 cases of dGTA, 66 cases of tetralogy of fallot (TOF), 251 controls), they found that the lowest quartile of dietary intake of vitamin E (<11.6 mg) was associated with significantly increased risk of a d-transposition of great arteries (dGTA heart defect) (OR 3.3; 95% CI, 1.3-8.1), but no increased risk for a TOF heart defect. For the subset who did use prenatal vitamins, they did not find an increased risk of either heart defect in the highest quartile of vitamin E consumption. Due to the conflicting results of a serious heart defect, it is unclear whether supplementing with vitamin E would be beneficial or harmful.

A Cochrane meta-analysis on vitamin E reviewed 17 studies using high dose alpha-tocopherol (200-800 IU), but it was given with other supplements, so it needs to be interpreted cautiously. There was a decreased risk of having a placental abruption (RR 0.64, 7 trials, 14,922 participants, high-quality evidence). There was no significant effect on the risk of stillbirth, neonatal death, preeclampsia, preterm birth, intrauterine growth restriction, or preterm PROM. However, supplementation with high dose vitamin E (400 IU) and high-dose vitamin C (1000 mg) was associated with an increased risk of term PROM (RR 1.77, 2504 participants, two trials. A meta-analysis of studies of supplementing with only vitamin C found that it reduced the risk of preterm PROM (5 studies) and term PROM (1 study).

Another study found that supplementation with high-dose vitamin E (400 IU) and vitamin C (1000 mg) increased abdominal pain (RR 1.63; 1877 participants).

One large multi-center study (2640 women) investigated the effect of 1000 mg of vitamin C and 400 IU of vitamin E, and found that it did not result in any benefit compared to placebo. However, it did result in an increased risk of PROM (10.17% in the vitamin group vs. 6.15% in the placebo group; RR, 1.65; 95% CI, 1.23-2.22) and PPROM (5.97% in the vitamin group vs. 3.03 in the placebo group; RR, 1.97; 95% CI, 1.31-2.98) and an increased risk of “fetal loss or perinatal death” (1.69% vs. 0.78%; RR, 2.20), which included spontaneous abortion, stillbirth and neonatal death before discharge. This study planned to enroll 10,000 women but stopped prematurely due to the adverse outcomes.

Overall, the studies of high-dose vitamin E and vitamin C suggest that these doses are too high. Therefore, it appears that supplementation with high-dose vitamin C alone decreases the risk of term PROM, but the addition of high dose alpha-tocopherol increases the risk of term PROM.

### Daily Intake and RDA:

The NHANES study found that from 2009 to 2010, the average daily dietary intake of vitamin E of US women aged 20-39 was 7 mg/day, which is half of the RDA of 15 mg for pregnant women. The Tolerable Upper Limit is 1000 mg.

### Discussion:

US women consume only about half the RDA of vitamin E, and low maternal intake is associated with increased risk of infant wheeze, orofacial clefts, and heart defects Supplementation with 30 IU of vitamin E was found to be sufficient to increase levels 50% in pregnant women in a small study. However, supplementation with high levels of vitamin E (400 IU) is linked to adverse effects and is not recommended.

### Recommendation:

For US women, the inventors recommend that prenatal supplements contain at least 19 mg of vitamin E (28.5 IU). Without being bound by theory, the inventors believe that mixed tocopherols are preferred vs. only alpha-tocopherol, since the human diet includes primarily gamma tocopherols, and gamma tocopherols have higher anti-oxidant capacity than alpha-tocopherol. So, we hypothesize that a mixture of approximately 15 mg of alpha-tocopherol and 10 mg of other tocopherols (primarily gamma) may be best. “dl” forms (synthetic forms) should be avoided since they have little biological activity, and instead only “d” forms which are from natural sources should be used. This recommendation appears likely to reduce the current rate of wheeze in children in the US, and possibly help with hyperglycemia, preterm births, and placental abruption. It is possible that higher doses may be beneficial, but more research is needed, and there appears to be harm with very high doses such as increased rate of abdominal pain or PROM, fetal loss and perinatal death, and congenital heart defects, although the research is inconsistent. More research is needed on the effect of low dose vitamin E supplementation, as the Baker study found that only 30 IU was sufficient to substantially increase levels of vitamin E, and all the other studies used very high doses (200-800 IU). Supplementation at the low doses recommended here may help reduce the risk of hyperglycemia, preterm births, preterm placental rupture of membranes (PROM), and placental abruption, and also decrease the risk of wheeze, orofacial clefts, and serious heart defects in their infants.

Comparison with Commercial Prenatal Supplements:

Vitamin E is included in 94% of prenatal supplements; when included, the median level is 30 IU (Q1: 23.6/Q3: 31.6). 61% of prenatal supplements meet or exceed our recommendation for Vitamin E. 20 had levels above 100 IU which may be a concern.

### Example 9. Optimal Prenatal Vitamin/Mineral Supplement for Women in the US: Vitamin K

### Research:

Vitamin K aids in blood clotting and building strong bones. Vitamin K deficiency in pregnancy is common, in both the mother and infant shortly after birth. Preterm infants are especially at risk for excessive bleeding after birth, which often can result in intracranial bleeding (see Table 6). Supplementing with vitamin K right after birth is a common practice recommended by the American Academy of Pediatrics.

Infants are generally born with low vitamin K stores, and the vitamin K content of human milk is low, so vitamin K deficiency in infants is common. This can lead to a risk of intracranial hemorrhage (bleeding in the brain), which can cause serious damage and death. One study in the US found that 48% of cord blood samples tested at birth were positive for a marker of vitamin K deficiency, prior to injection with vitamin K. The American Academy of Pediatrics recommends 0.5-1 mg of vitamin K be injected intramuscularly at birth to all infants to prevent Vitamin K Deficient Bleeding (VKDB), (often intracranial bleeding), and recommends research on the optimal oral dosing after birth to prevent late VKDB (at 2-12 weeks of life). An injection is preferred over oral dosing due to better absorption, especially in infants with biliary atresia (low production of bile acids needed to absorb vitamin K) or similar conditions (Witt 2016). The initial vitamin K injection appears to be enough to last for about 1 month, but is insufficient and results in low vitamin K in breastfed infants by 1 month, and vitamin K levels drop even lower in following months. Between 1 and 3 months, a treatment study found that infants need slightly more than 25 mcg/day to maintain normal levels. Some countries like the Netherlands have used oral dosing up to 150 mcg/day. One study found that supplementing lactating mothers with 5 mg/day of phylloquinone was sufficient to achieve 50% of the plasma vitamin K levels of formula-fed infants (levels which are 10× that of adults), after the infants received 1 mg of phylloquinone intramuscularly at birth—it is unclear if that much supplementation is needed.

The reason for low vitamin K levels in an infant is due to low levels of vitamin K in the mother, and very low transfer of vitamin K from the mother to the infant. A small study found that 70% of Belgian women develop low vitamin K in their first trimester (average of 0.64 nmol/L, vs. a reference range for non-pregnant adults of 0.8-5.3 nmol/L). One study found that vitamin K dosing only slowly and slightly crossed the placenta, so that one or more doses of 10 mg led to only a 2 times higher level in the infant despite a 100 times higher level in the mother compared to un-supplemented controls. Among pregnant women with previous bariatric surgery, 88% had low levels (since gut bacteria produce about half of a person's normal vitamin K intake). In the bariatric surgery group, levels were measured later in pregnancy, and they remained low if they did not supplement with extra vitamin K, but those who supplemented with vitamin K (10 mg per week) had a normal or above-normal level of vitamin K.

For women at imminent risk of very preterm birth, vitamin K may reduce VKDB. A meta-analysis of 7 studies found that vitamin K therapy (a dose of 5-10 mg, usually repeated) led to a significant reduction in severe brain bleeding (RR 0.58; 95% CI 0.37 to 0.91) and a non-significant reduction of brain bleeding (risk ratio (RR) 0.76; 95% confidence interval (CI) 0.54 to 1.06). There was speculation that the decrease of vitamin K levels during pregnancy is protective to regulate growth and prevent the growth of cancerous cells. However, a meta-analysis of 6 studies of vitamin K supplementation studies found no risk of childhood cancer associated with infantile supplementation with vitamin K.

In general, we speculate that instead of waiting until birth, it may be beneficial to provide some vitamin K supplementation during pregnancy, in addition to injections at birth, since a study of lactating mothers found that 5 mg/day resulted in a substantial increase in vitamin K levels in their breastmilk. However, research is needed to determine if this level of prenatal supplementation is beneficial or not.

### Intake:

The NHANES study found that from 2017 to 2018 the average daily intake of vitamin K of US women aged 20-39 was 146 mcg/day, which is somewhat more than the RDA recommendation of 90 mcg/day for pregnant women. Vitamin K is well-tolerated even at high doses, and no Tolerable Upper Limit has been established.

### Discussion:

Vitamin K intake is somewhat above the RDA, but levels decrease substantially during pregnancy (limited evidence), so modest supplementation may be useful to keep levels constant during pregnancy. However, clinical trials are needed to determine if modest supplementation is beneficial. Since transport of vitamin K from mother to fetus is minimal, vitamin K injections to the baby upon birth are needed, and there is extensive evidence of their benefit.

### Recommendation:

The inventors recommend that prenatal supplements contain at least 90 mcg of vitamin K, but research is needed to determine if higher levels are needed, since most infants are born with insufficient levels of vitamin K.

Also, in women of imminent risk of preterm birth, the inventors recommend high dose maternal vitamin K therapy (10 mg, possibly repeated) to reduce the risk of severe intracranial bleeding, which can cause brain damage, including cerebral palsy, based on the meta-analysis of 8 studies.

Women with previous bariatric surgery may need 10 mg/week.

The inventors recommend following the American Academy of Pediatrics recommendation of injection of 0.5-1 mg at birth, and further suggest additional supplementation of at least 25 mcg/day to the infant if the infant is breastfeeding unless the mother is highly supplemented (5 mg/day).

Comparison with Commercial Prenatal Supplements:

Vitamin K is included in 31% of prenatal supplements; when included, the median level is 90 mcg (Q1: 52.5/Q3: 90) of 5+/−200 mcg. Only 16% meet or exceed our recommendation for Vitamin K.

### Example 10. Optimal Prenatal Vitamin/Mineral Supplement for Women in the US: B1

### Research:

Thiamine, also known as vitamin B1, helps the body metabolize food for energy and plays an important role in maintaining a healthy cardiovascular and nervous system. It is important during pregnancy to reduce the risk of maternal gestational diabetes and low-birth weight and anencephaly in infants (see Table 11).

Thiamine is a co-factor for three critical enzymes for glucose metabolism, and thiamine deficiency results in an impairment of production and secretion of insulin, resulting in a reduction of glucose utilization. During pregnancy, a study in the US found an approximately 40% decrease in thiamine levels, and a study in the Netherlands found about a 10% decrease. One study of 174 pregnant women in the US found that at birth, 53% of women not taking a vitamin supplement had a deficient level of thiamine, and 30% of women taking a supplement of 1.5-15 mg of thiamine were deficient, suggesting that significantly more than 1.5 mg of thiamine is needed. One study of 563 pregnant women taking a multi-vitamin containing 3 mg of thiamine found thiamine levels were approximately 31% lower than non-pregnant women not taking a vitamin supplement, and 17-20% had a thiamine deficiency; this suggests that much higher levels, perhaps 6 mg or more, are needed during pregnancy, consistent with the study. Compared with other vitamins, thiamine deficiency was the second most common vitamin deficiency, after niacin deficiency, in women taking a prenatal vitamin supplement.

Thiamine supplementation in pregnant women improves their glucose tolerance, and stimulates intra-uterine growth, thereby preventing low birth weight. Thiamine deficiency may also be a cause of intrauterine growth retardation. During normal pregnancies, the thiamine values in blood cells fall in the 28th to the 39th week of gestation from 230 nmol/l to 170 nmol/l. Women with severe intrauterine growth retardation had much lower levels, 140 nmol/l in the 30th week of gestation and 130 nmol/l in the 39th week of gestation, (p=0.0001 and p=0.0005, respectively) again suggesting that thiamine supplementation is needed during pregnancy.

Among non-users of prenatal supplements, thiamine intake in the highest quartile (above 1.67 mg) was associated with a significantly reduced risk of anencephaly (OR 0.47). Animal studies suggest that thiamine deficiency in infancy can result in permanent learning disability, even if corrected later in infancy.

### Intake:

The NHANES study found that from 2017 to 2018, the average daily dietary intake of thiamine of US women aged 20-39 was 1.4 mg/day, which on average meets the RDA recommendation of 1.4 mg/day for pregnant women. Thiamine is very safe at these dosages, and it is so safe that no tolerable upper limit has been determined.

### Discussion:

Thiamin levels decrease substantially during pregnancy unless supplemented, and half of US women develop thiamin deficiency after birth unless supplemented. One study found that doses of 3 mg were insufficient to fully prevent thiamin deficiency, so somewhat higher doses are needed.

### Recommendation:

The inventors recommend that prenatal supplements contain approximately 6 mg of thiamine, and more may be needed pending further research. Women with intrauterine growth restriction may need additional thiamine, and in those cases, the inventors recommend checking thiamine levels in blood cells, not plasma, since plasma was not sensitive. This recommendation may reduce the maternal glucose intolerance, risk of anencephaly, and intrauterine growth restriction/low birth weight, although more research is needed to verify these effects.

Comparison with Commercial Prenatal Supplements:

Thiamine is included in 85% of prenatal supplements; when included, the median level is 1.8 mg (Q1: 1.6/Q3: 5). Only 16% meet or exceed our recommendation for Thiamine.

### Example 11. Optimal Prenatal Vitamin/Mineral Supplement for Women in the US: B2 (Riboflavin)

### Research:

Riboflavin is important for the production of thyroid hormones, producing immune cells and red blood cells, and improving photoreceptor functioning. In pregnant women, riboflavin supplementation alone may prevent severe preeclampsia and hypertension (see Table 10). When riboflavin is given in conjunction with certain vitamins/minerals, it appears to increase its effectiveness, and is shown to help reduce anemia and night blindness. For infants, riboflavin deficiency may be associated with low birth weight, and an increased risk for serious birth defects (loss of limb and heart defect) (see Table 11).

A study by Baker et al. in the US suggests that riboflavin levels decrease slightly (about 7%) during healthy pregnancies, similar to results of a study in the Netherlands which seemed to show only a slight decrease, although another study in the Netherlands found a slight increase of about 7% by the end of pregnancy. A study in the US found that 3.4 mg of riboflavin during pregnancy was enough to slightly increase riboflavin levels above that of healthy-non-pregnant women, so somewhat less is needed. Another study of riboflavin-deficient pregnant and lactating women in Gambia found that riboflavin supplementation of 5 mg/day led to improvements in riboflavin levels within 3-6 weeks, and reduction of symptoms of riboflavin deficiency, namely angular stomatitis (inflammation at the corners of the mouth) and papular atrophy (eye damage) within 6 weeks, but a worsening of symptoms in those not receiving supplementation, suggesting that pregnancy and lactation worsened riboflavin deficiency. Bates et al. found that increasing total daily intake from 0.5 to 1.5 mg/day in pregnant Gambian women was enough to partially reduce a biomarker for the need for riboflavin (EGRAC), but not enough to normalize it. Another Gambian study by Bates et al. found that a total intake of 2.5 mg/day of riboflavin (0.5 mg/day from food, 2 mg/day from supplements) was sufficient for lactation-note that demands during lactation are similar or somewhat less than during pregnancy, suggesting similar amounts or slightly more is needed during pregnancy.

Other studies demonstrate the need for much higher amounts of riboflavin to achieve significant results. One such study in Gambia, found that giving 15 mg of riboflavin every 10 days had some benefit compared to placebo, but symptoms of riboflavin deficiency continued to worsen during pregnancy, so higher and/or more frequent dosing may be needed. Another such study in Venezuela found that 15 mg/day of riboflavin supplementation led to a significant decrease in the number of cases of severe preeclampsia, and less severe hypertensive symptoms (lower blood pressure).

When riboflavin is given with some other supplements, it appears to have a synergistic effect, increasing the effectiveness of each. In two studies where riboflavin was given in conjunction with iron-folate supplements, it increased their effectiveness in reducing anemia in pregnancy, 1 mg riboflavin; 5 mg riboflavin). Another study found that riboflavin (6 mg) and iron, when added to vitamin A had a greater benefit than vitamin A alone in reducing night blindness.

For infants, low riboflavin intake was associated with low birth weight in one study. In two separate studies, riboflavin intake in the lowest quartile was associated with a nearly 3× risk of partial or complete loss of an arm or leg (OR 2.94), and significantly increased risk of a serious heart defect (OR 3.7).

### Intake:

The NHANES study found that from 2017 to 2018, the average daily dietary intake of riboflavin of US women aged 20-39 was 1.8 mg/day, which is slightly more than the RDA recommendation of 1.4 mg/day for pregnant women. Riboflavin is very safe even at high doses, and no Tolerable Upper Limit has been established.

### Discussion:

Riboflavin levels decrease slightly during pregnancy, and on average US women consume slightly more than RDA, so only modest levels of supplementation seem to be required. Data from several studies in Gambia suggests that a total intake of 1.5 mg/day is insufficient, 5 mg is more than sufficient, and 2.5 mg seems to be sufficient. Similarly, a US study found that supplementing with 3.4 mg was more than enough, suggesting that in the US, supplementation of about 2 mg is probably sufficient, even if dietary consumption is well below the average intake of 1.9 mg. The Venezuela study suggests that 15 mg provided clinical benefit (unclear if lower doses would provide that benefit).

### Recommendation:

For US women, the inventors recommend that prenatal supplements contaat or about 2 mg of riboflavin, but some women may need as much as 2.5 mg/day if they have a very poor diet. If hypertension occurs, doses of 15 mg may be helpful, but further research is needed to determine if 15 mg has more clinical benefit than lower doses. This recommendation should reduce the risk of mouth sore, eye damage, anemia, and possibly reduce the risk of severe preeclampsia, night blindness, heart defect, loss of the infant's arm or leg, and low birth weight.

Comparison with Commercial Prenatal Supplements:

Riboflavin is included in 84% of prenatal supplements; when included, the median level is 2 mg (Q1: 1.7/Q3: 5) of 0.2+/−50 mg. 52% of prenatal supplements meet or exceed our recommendation for Riboflavin.

### Example 12. Optimal Prenatal Vitamin/Mineral Supplement for Women in the US: B3 (Niacin)

### Research:

Niacin is needed for many functions in the body, including energy production and development of the nervous system, digestive system, and skin. Low niacin is associated with an increased risk of birth defects (spina bifida, serious heart defect) (see Table 11).

In a study of 563 pregnant women in the US, supplementation of 20 mg/day of niacin resulted in blood levels of niacin that were 29%, 35%, and 38% lower during the first, second, and third trimester respectively, compared to healthy non-pregnant controls, suggesting that much higher levels are needed during pregnancy. One US study found that about 5% of unsupplemented pregnant women had levels below that of all healthy non-pregnant controls.

In a case-control study of 287 pregnant women, researchers found that low dietary intake of niacin (estimated from food diaries) at preconception resulted in an increased risk for spina bifida (OR=2.5 for lowest quartile), with levels below 20 mg/day having an increased risk. One study in the US found that the lowest quartile of dietary intake of niacin was associated with a significantly increased risk of a serious heart defect (OR 3.8). Another US study found that low birthweight infants had cord blood levels that were non-significantly lower (15% lower) than normal birth-weight infants.

### Intake:

The NHANES study found that from 2017 to 2018 the average daily dietary intake of Niacin of US women aged 20-39 was 22 mg/day, which is slightly more than the RDA recommendation of 18 mg/day for pregnant women. The Tolerable Upper Limit for Niacin is 35 mg/day.

### Discussion:

Niacin levels decrease substantially during pregnancy unless supplemented, and one large US study found that 20 mg/day was insufficient to prevent that decrease, so somewhat higher doses are probably needed.

### Recommendation:

The inventors recommend that prenatal supplements contain approximately 35 mg/day, although more research is needed to verify that amount. This recommendation may reduce the risk of spina bifida and heart defects.

Comparison with Commercial Prenatal Supplements:

Niacin is included in 88% of prenatal supplements; when included the median level is 20 mg (Q1: 18/Q3: 20) of 1.8+/−100 mg. 7% of prenatal supplements meet or exceed our recommendation for Niacin.

### Example 13. Optimal Prenatal Vitamin/Mineral Supplement for Women in the US: B5 (Pantothenic Acid)

### Research:

Pantothenic acid is needed to produce Coenzyme A, which has many functions in the body, including energy production from fats, carbohydrates, and protein. A deficiency of pantothenic acid during pregnancy is associated with low birth weight in offspring (see table 11). Blood levels of pantothenic acid decrease substantially during pregnancy.

One study found that pregnant women and pregnant teens have 36% lower levels of pantothenic acid in the blood than non-pregnant women. Similarly, one small US study found that pregnant teenagers (n=17) had about 45% lower levels of total pantothenic acid in blood compared to non-pregnant controls (n=4), despite 12 of 17 of them consuming 2-5 mg/day of supplemental pantothenic acid, providing a total of dietary plus supplemental intake of about 7.2 mg/day. One US study found that pantothenic acid levels in whole blood were 24% lower in the third trimester compared to non-pregnant women, none of whom were supplemented, and who had dietary intakes of about 5 mg/day.

Four studies found that low birth weight was associated with low pantothenic acid intake/levels or low blood levels of pantothenic acid.

One study found that 10 mg/day of calcium pantothenate resulted in slightly higher blood levels of pantothenic acid compared to non-pregnant controls, so somewhat less pantothenic acid is sufficient to maintain constant blood levels; however, since US women consume only about half of the RDA of pantothenic acid, increasing their levels somewhat above baseline is likely beneficial.

One small study investigated supplementation with 60 mg of calcium pantothenate (which is 92% pantothenic acid) starting at 4.5 months gestation. Note that most pantothenic acid exists bound in blood, and only about 12% is free; both were measured. Bound pantothenic acid is important for producing co-enzyme A, and free pantothenic acid is important for transporting certain amino acids like glycine and serine into cells. Prior to supplementation, bound levels were only 64% of the level in healthy non-pregnant women. At 7.5 months, despite supplementation, bound levels were slightly lower (59% of levels in controls), but at term, they had reached normal levels (104% of levels in healthy controls). For free pantothenic acid, levels were 17% lower at 4.5 months, and after treatment, they were 2× higher at 7.5 months and at term compared to controls. So, it appears that bound levels decrease more than free levels during pregnancy, and higher levels of supplemental pantothenic acid are needed to normalize bound levels, especially early in pregnancy.

### Intake:

The NHANES study found that from 2009 to 2010, the average daily intake of pantothenic acid of US women aged 20-39 was 4 mg, substantially less than the RDA recommendation of 6 mg/day for pregnant women. Pantothenic acid is very well tolerated even at high doses, and no Tolerable Upper Limit has been established for pregnant women.

### Discussion:

Pantothenic acid levels decrease substantially during pregnancy unless supplemented, and on average their intake is only ⅔ of the RDA. One study found that 2-5 mg total dietary consumption was far too low, and one study found that 5 mg total dietary consumption was too low, and one US study found that 10 mg/day of supplementation was optimal. One old study suggested that 60 mg might be needed to normalize levels of bound pantothenate, but we suspect problems with their measurements of bound pantothenate, and their measurements of free pantothenate suggest far less is needed. So, we believe that the Baker study (conducted 40 years later) had more robust methods, suggesting that supplementation of 10 mg/day seems optimal.

### Recommendation:

For US women the inventors recommend that prenatal supplements contain approximately 10 mg of pantothenic acid. This recommendation appears likely to reduce the risk of low birth weight.

Comparison with Commercial Prenatal Supplements:

Acid is included in 65% of prenatal supplements; when included, the median level is 7 mg (Q1: 7/Q3: 15). 42% of prenatal supplements meet or exceed our recommendation Pantothenic Acid.

### Example 14. Optimal Prenatal Vitamin/Mineral Supplement for Women in the US: B6 (Pyridoxine)

### Research:

Vitamin B6 affects over 100 enzymatic reactions in the body, including the production of important neurotransmitters and hormones. Vitamin B6 deficiency is associated with an increased risk of preterm birth, nausea/vomiting during pregnancy, cleft lip/palate in infants, and neurodevelopmental behavior problems in infants (see Table 6). B6 supplementation may help decrease the severity of nausea, reduce the risk of cardiovascular malformation, reduce the risk of preeclampsia, and improve birth weight.

Vitamin B6 levels decrease substantially during pregnancy if not supplemented, and decrease even if supplemented at the standard RDA level. Similarly, a functional test of vitamin B6 using an erythrocyte glutamate (EGOT) ratio in unsupplemented pregnant women in the Netherlands found that the percentage of women with a functional B6 deficiency increased from 7.5% to 25% at the end of pregnancy. Approximately 10 mg/day is needed to maintain B6 levels at normal (pre-pregnancy) levels, and even then, some women had levels below the reference range for healthy unsupplemented non-pregnant women, including 17% (1st trimester), 14% (2nd trimester), and 6% (3rd trimester).

B6 deficiency doubles the risk of preterm birth, and is associated with a much greater risk of nausea/vomiting during pregnancy. One study of Egyptian women (who tend to have low B6) found that vitamin B6 status was the most important nutrient in affecting infant neurobehavioral development and maternal-infant interactions. One study of orofacial clefts (cleft lip/palette) found that the lowest quintile of B6 intake was associated with a 61% higher risk of orofacial clefts. There is limited evidence that vitamin B6 supplementation during pregnancy may help decrease the severity of nausea, risk of preeclampsia, risk of cardiovascular malformation and improve birth weight-however, further studies are needed to verify these potential benefits. 2 mg was found to be sufficient to improve birth weight. One study of supplementation with a high dosage of vitamin B6 (20 mg/day) found that it significantly reduced the rate of dental decay during pregnancy.

### Intake:

The NHANES study found that from 2017 to 2018, the average daily intake of vitamin B6 of US women aged 20-39 was 1.8 mg/day, which is the same as the RDA recommendation of 1.9 mg/day of vitamin B6 for pregnant women. The Tolerable Upper Limit is 100 mg/day.

### Discussion:

Vitamin B6 levels decrease substantially during pregnancy unless supplemented, and about 10 mg/day is sufficient to maintain normal levels and prevent functional B6 deficiency.

### Recommendation:

The inventors recommend at least 10 mg/day because that is the dosage required to keep vitamin B6 levels from decreasing during pregnancy. A daily dose of 10 mg may reduce the risk of nausea, preeclampsia, maternal dental decay, preterm birth, low birth weight, cleft lip/palate, and cardiovascular malformation. Much higher doses (25 mg every 8 hours for 3 days) were found to decrease symptoms of nausea.

Comparison with Commercial Prenatal Supplements:

Vitamin B6 is included in 97% of prenatal supplements; when included, the median level is 5 mg (Q1: 2.5/Q3: 20). 41% of prenatal supplements meet or exceed our recommendation for Vitamin B6.

### Example 15. Optimal Prenatal Vitamin/Mineral Supplement for Women in the US: B7 (Biotin)

### Research:

Biotin is necessary for several enzymes involved in energy metabolism from fats and carbohydrates. During pregnancy, animal studies demonstrate that biotin deficiency may result in birth defects that include malformations to the face and extremities, impaired fetal development, or miscarriage.

A study by Baker et al. found that biotin levels during a healthy pregnancy were 29% lower than in healthy non-pregnant controls. Several more recent studies suggest that marginal biotin deficiency occurs at or about half of pregnancies.

Biotin transport across the placenta is limited, and several animal studies found that a mild biotin deficiency in the mother led to severe biotin deficiency in her offspring, which is highly teratogenic (likely to cause birth defects or terminate the pregnancy), and that this effect was consistent across multiple animal species. An in vitro study of biotin deficient human embryonic palatal cells demonstrates growth retardation vs. controls, further supporting the role of biotin deficiency in the formation of cleft lip palate. It is important to note that the timing during gestation and amount of increase in urinary excretion of 3-hydroxyisovaleric acid (3HIA) in animals, which is a marker of biotin deficiency, was similar to the 3HIA increase that occurred spontaneously during the first trimester of human pregnancy. This provides an indirect, yet important association that a marginal biotin deficiency in humans may yield the same teratogenic effects that it does in animals.

One study found that biotin supplementation of 300 mcg/day for two weeks was sufficient to treat the deficiency. Another study found that a diet containing 57 mcg/day for 10-12 weeks was insufficient to normalize a biomarker of marginal biotin deficiency. A brief review paper recommended that total biotin intake during pregnancy be in the range of 60-90 mg/day. A study by Baker found that 30 mcg/day of supplemental biotin was sufficient to slightly increase levels of biotin above that of healthy controls, but they did not measure 3-HIA, a biomarker for need for biotin. Note that normal gut bacteria make a significant amount of biotin (roughly comparable to that in the human diet), so people with gastrointestinal problems may need extra biotin.

### Intake:

The NHANES study did not measure biotin. Using food intake data from the NHANES II, the mean biotin intake of young women aged 18 to 24 years was estimated to be 40 mcg/day, which is higher than the RDA recommendation of 30 mcg/day for pregnant women. Biotin is regarded safe in high doses; therefore, no Tolerable Upper Limit has been established.

### Discussion:

Biotin levels decrease substantially during pregnancy, so although US women on averaged consume somewhat more than the RDA, about half of US pregnant women have biomarkers of mild biotin deficiency. A diet containing 57 mcg/day was insufficient to normalize biomarkers, but supplementation of 300 mcg/day for 2 weeks was sufficient. So, we estimate that steady consumption of approximately 100 mcg/day would be sufficient.

### Recommendation:

For US women The inventors recommend that prenatal supplements contain approximately 100 mcg of biotin, although more research is needed. Women with bariatric surgery or major gastrointestinal problems may need an extra 50-100 mcg of biotin, since normal gut bacteria produce a significant amount of biotin, comparable to dietary intake. This recommendation may reduce the risk of miscarriages and birth defects, but more research in human pregnancy is needed.

Comparison with Commercial Prenatal Supplements:

Biotin is included in 72% of prenatal supplements; when included, the median level is 280 mcg (Q1: 35/Q3: 300) of 17.5+/−3000 mcg. 43% of prenatal supplements meet or exceed our recommendation for Biotin.

### Example 16. Optimal Prenatal Vitamin/Mineral Supplement for Women in the US: B9 (Folate)

### Research:

Folate is important for DNA synthesis and methylation, which is important for the modulation of gene expression. Folate is also important for the metabolism of several amino acids. It is essential for normal cell growth and replication. Folate supplementation during pregnancy is proven to reduce the risk of neural tube disorders and megaloblastic anemia (see Table 11). It also reduces the rate of other birth defects, preterm birth, and (if taken preconception) small-for-gestational-age (see Table 11). Low levels of folate are associated with a greater risk of having a child with autism. High levels of unmetabolized folic acid are associated with a greater risk of autism and food allergies.

Most studies have reported that folate levels in blood decrease significantly during pregnancy unless supplemented, although one study in the Netherlands found a slight decrease in serum folate but a slight increase in RBC folate.

One study in Scotland investigated prenatal supplementation of 0, 124, 355, and 530 mcg of folate in addition to an iron supplement. They found that levels of folate at the end of pregnancy were 40% lower than that of healthy non-pregnant women, and that a dose of 355 mcg was sufficient to maintain median serum folate levels at postpartum that were equivalent to that of healthy non-pregnant women, whereas lower/higher dosages results in lower/higher serum folate levels. Similarly, it was found that doses of 355 and 530 mg resulted in zero cases of megaloblastic anemia, vs. 11% in the unsupplemented group, 6% in the group that received only iron, and 2% in the group that received iron and 124 mcg of folate. Serum folate levels were much lower in the mothers who developed megaloblastic anemia than in the mothers with a healthy pregnancy, similar to several previous studies.

A meta-analysis of four studies with 3839 pregnancies found that folate supplementation dramatically reduced the rate of megaloblastic anemia (OR=0.21), which occurs with severe deficiency of folate and/or vitamin B12.

One study measured folate levels in 563 pregnant women in the US during their first, 2nd, and 3rd trimester while they were receiving 1000 mcg/day of folic acid. They found that average blood levels were 25-26 ng/ml during each trimester, compared to 10 ng/ml in healthy non-pregnant, non-supplemented women. So, folate supplementation at a level of 1000 mcg increases levels well above that of healthy non-pregnant women, consistent with the Willoughby study.

The World Health Organization recommends that the optimal RBC-folate concentrations for prevention of NTD's are >906 nmol/L (approximately 416 mcg/L), based on a study that found a strong inverse relationship between RBC folate at 15 weeks gestation and rate of NTD's. Specifically, that study found that RBC-folate levels of <340 nmol/L had a risk of NTD's of 66/10,000, vs. a much lower risk of 8/10,000 in women with RBC-Folate levels of >906 nmol/L. The WHO estimated that it required about 450 mcg/day of intake of dietary folate equivalents from natural food to achieve a level of approximately 1050 nmol/L.

Folate supplementation during pregnancy has been very firmly established as being important for reducing the risk of neural tube defects in infants, with most studies involving a dose of 400 mcg/day.

Folate fortification of foods has been implemented in many countries and shown to substantially reduce, but not eliminate, the risk of NTDs Folate fortification began in the US in 1998. In the US, analysis of data from NHANES found that folate fortification of foods increased mean red blood cell folate concentration in women ages 15-44 years from 686±12 nmol/L pre-fortification (1988-1994) to 1060±9 nmol/L post-fortification (1999-2010). It is important to note that approximately ⅓ of all people (men and women of all ages) evaluated in this study used supplements, and that average levels were 11% lower in non-supplement users compared to the entire group. Thus, we estimate that folate levels in women ages 15-44 years not taking supplements were approximately 943 nmol/L. It is important to note that these are averages, and median values are lower, so over half of US women are below the WHO recommendations for prevention of NTD's without supplementation. For example, the central 95% range of RBC folate levels for non-Hispanic white women ages 20-59 ranged from 514 to 2530 nmol/L, and levels were slightly lower for Mexican American women and non-Hispanic black women. Furthermore, since folate levels decrease significantly during pregnancy, this is further reason for women to take supplemental folate during pregnancy; fortification alone is not enough for well over half of women.

The Society of Obstetricians and Gynaecologists of Canada has recommended that in countries like Canada with folate fortification of food that pregnant women supplement 400 mcg of folate if at low risk of NTDs starting 2-3 months preconception and continuing throughout pregnancy and 4-6 weeks during breastfeeding. For women at moderate or high risk of NTD's, recommendations are 1000 mcg and 4000 mcg, respectively, during preconception and the first 12 weeks of gestation, followed by 400-1000 mcg for the remainder of pregnancy and first 4-6 weeks of lactation.

As is discussed more in other sections, the risk of neural tube defects can be further reduced if supplemented with vitamin B12 or inositol, and there is limited evidence that choline and selenium may also help reduce the risk of neural tube defects.

Low folate is also significantly associated with risk of other birth defects. A meta-analysis of studies using a multi-vitamin supplement containing folic acid demonstrated not only a reduction in NTDs (OR=0.67), but other congenital anomalies as well (138). Analysis of case-control studies found that folate reduced the risk of heart (5 studies, OR=0.78), cleft lip or palate (10 studies, OR=0.76), and limb defects (2 studies, OR=0.48).

Low folate is also significantly associated with risk of preterm birth. A meta-analysis of 27 studies found that folate blood levels and dietary folate intake were associated with a lower risk of preterm birth (OR=0.72 and 0.68, respectively). Higher folate supplementation and starting supplementation preconception were both associated with a lower risk of preterm birth.

Similarly, a large meta-analysis of 108.525 pregnancies analyzed the effect of folate intake on small-for-gestational-age (SGA). They found that folate use preconception significantly reduced the risk of SGA (OR 0.80 for 10th %, p<0.01; OR 0.78 for 5th %, p<0.01). However, post-conceptual folate supplementation had no effect.

One large study found that intake of folate or folate-containing multivitamins was associated with an approximately 50% reduction in the risk of severe language delay in children at age 3 years.

Severe language delay is a core symptom of autism, and there is a large body of recent research linking a risk for autism spectrum disorders (ASD) and timing or absence of consuming folic acid during preconception and pregnancy. Many studies have now investigated the effect of folic acid and/or multivitamin use during pregnancy on the risk of ASD in offspring. A meta-analysis of 6 prospective studies found that maternal supplementation with folic acid was associated with a decreased risk of ASD in the child (RR=0.64 (95% CI: 0.46, 0.90). However, one study found that either low intake (≤2 times/week) or high intake (>5 times/week) resulted in a higher risk of ASD vs. moderate intake (3-5 times/week). Similarly, they found that very high levels of maternal plasma folate at birth (>90th %) or vitamin B12 (>90th %) resulted in an increased risk of ASD (OR-2.5), and if both folate and folate B12 high, the risk was very high (OR=13.7). Conversely, if both B12 and folate were low, the risk of ASD was also increased (OR=2.4). Similarly, a study of cord blood from 92 children with ASD and 475 neurotypical found that the highest quartile of unmetabolized folic acid (UMFA) was associated with a much higher risk of ASD (OR=2.26, CI 1.08-4.75), especially in black children (OR=9.85, CI=2.53,38.31). There was no significant relationship of the bioactive form of folate (5-methyltetrahydrofolate, 5-MTHF)) or total folate with risk. So, altogether this suggests that moderate folic acid intake is beneficial in reducing the risk of ASD, but excessive folic acid intake results in unmetabolized folic acid that is associated with a greater risk of ASD. This suggests that natural forms of folate, such as folinic acid or 5-MTHF, may be preferred over folic acid.

Total folate and unmetabolized folic acid have also been associated with a strong risk of food allergies. A study investigated 1394 children in the US, including 507 children with food sensitization and 78 with food allergy. Maternal total folate at birth was 14% lower in the children who developed food allergies. Maternal total folate concentrations in the third quartile (30.4-44.8 nmol/L) resulted in a much lower odds of developing food allergy than those in the first quartile (6.64-19.7 nmol/L), suggesting that a moderately high, but not highest, level was optimal. In contrast, levels of unmetabolized folic acid were 32% higher in cord blood of children who developed food allergies. The highest quartile of unmetabolized folic acid in cord blood had a much higher risk of food allergy (OR=8.5, p<0.001). So, this suggests that total maternal folate is protective against food allergies, and that a decreased ability to metabolize folic acid (a synthetic form) to the active form (5-MTHF) in cord blood is associated with a much higher risk of food allergy.

### Intake:

The NHANES study found that from 2017 to 2018, the average daily dietary intake of folate of US women aged 20-39 was 440 mcg/day, which is somewhat less than the RDA recommendation of 600 mcg of folate for pregnant women. The Tolerable Upper Limit for folate is 1000 mcg.

### Discussion:

Folate levels decrease significantly during pregnancy unless supplemented, and average dietary intake of folate is about 25% less than the RDA, so folate supplementation is needed, and many studies suggest that 400 mcg/day is sufficient. However, most folate in prenatal supplements is in the form of folic acid, which is an artificial form, and excess unmetabolized folic acid is associated with increased risk of food allergies and autism. So, the inventors recommend that folate be given as folinic acid or MTHF, although more research is needed.

### Recommendation:

For US women the inventors recommend that prenatal supplements contain approximately 400 mcg of folate, and it should be started at conception or earlier to reduce the risk of NTD's, small-for-gestational-age, and autism. If there was a previous birth with a neural tube defect, higher doses (around 4 mg) may be considered, and blood levels of folate and vitamin B12 should be measured. Folic acid is an artificial form of folate, and people vary greatly in their ability to convert it to the bioactive forms, so it appears that the natural forms of folate such as folinic acid or 5-methyl-tetrahydrofolate (5-MTHF) may be preferred, including for the prevention of autism and food allergies.

Comparison with Commercial Prenatal Supplements:

Folate is included in 98% of prenatal supplements; when included, the median level is 800 mcg (Q1: 400/Q3: 1000). 95% of prenatal supplements meet or exceed our recommendation for folate. 30% are at levels of 1000 mcg or above, which may be linked to a higher risk of food allergies and autism if using only folic acid. 71% of supplements use only folic acid, 13% use a combination of folic acid and MTHF, and 15% include only MTHF.

### Example 17. Optimal Prenatal Vitamin/Mineral Supplement for Women in the US: B12 (Cobalamin)

### Research:

Vitamin B12 is involved in the formulation of red blood cells, cellular metabolism, and the synthesis of both DNA and myelin. Both folic acid and vitamin B12 are needed for recycling homocysteine to methionine, which is important for the production of SAM, the primary methyl donor in the body. It is important for reducing risk of infertility, miscarriage, gestational diabetes, preeclampsia, and preterm birth for the mother (see Table 10). For the infant, vitamin B12 deficiency is associated with low birth weight, neural tube defects, serious heart defect, and childhood diabetes (see Table 11).

Vitamin B12 levels decrease during pregnancy. One study found that two-thirds of mothers in India had low vitamin B12 levels (<203 ng/l)—note that most people in India are vegetarians, and vegetarians are at the greatest risk of low vitamin B12. In contrast, in the US, vitamin B12 insufficiency among pregnant women was 21%, and 7% were classified as vitamin B12 deficient; also, B12 levels in pregnant women were 20% lower than in non-pregnant women, even though most were probably taking a prenatal vitamin. In Canada, it is estimated that about 5% of pregnant women are deficient in vitamin B12 during the first 28 days of pregnancy, and 10% later in pregnancy; they estimated that 35% of neural tube defects are due to vitamin B12 deficiency. Four studies found that low vitamin B12 status was strongly associated with a substantially increased risk of neural tube defects; note that folate and vitamin B12 work together in preventing neural tube defects. Severe B12 deficiency causes pernicious anemia, which is a known cause of infertility and miscarriage. A meta-analysis of five studies found that vitamin B12 deficiency was associated with an increased risk of miscarriage (OR=2.5). Similarly, a later study found that women with miscarriage had much lower levels of vitamin B12 (197 vs. 300 μg/mL, p=0.004). Low maternal B12 levels are correlated with a higher risk of type 2 diabetes in offspring. A meta-analysis of eighteen studies (11,216 pregnancies) found B12 deficiency (<201 ng/L) was associated with a slightly higher risk of low birth weight (adjusted risk ratio=1.15) and a slightly higher risk of preterm birth (adjusted risk ratio=1.21). One study in the US found that the lowest quartile of dietary intake of vitamin B12 was associated with significantly increased risk of a serious heart defect (OR 4.0).

A major review article of 122 observational studies and 1 randomized trial found that low maternal or cord blood B12 was associated with gestational diabetes (1 study), neural tube defects (9 studies), spontaneous abortions (2 studies), low birth weight/IUGR/small for gestational age (3 studies), congenital heart defects (4 studies), poorer infant memory (1 study), excessive crying (1 study), infant/child insulin resistance (3 studies). Low B12 was possibly associated with maternal anemia (2 positive studies, 1 negative study, 1 mixed study) and recurrent abortion (2 positive studies, 1 mixed).

A meta-analysis of 19 studies found that women with preeclampsia have significantly lower levels of vitamin B12 than healthy pregnant women. One small study found that total consumption of 2× the RDA resulted in a 30% decrease in serum B12 levels by the third trimester compared to the first, and in the third trimester, 35% of the participants had serum vitamin B (12) concentrations<201 ng/L. The authors argued that this temporary decrease was not harmful based on other biochemical markers of B12 status. One small study of 26 pregnant women found that providing approximately 3× the RDA of vitamin B12 from both diet (6 mcg) and supplements (2.6 mcg) was enough to stabilize vitamin B12 levels during pregnancy. However, one large study in the US found that supplementation of 12 mcg/day still resulted in levels that decreased during pregnancy and were 38% lower at the end of pregnancy compared to healthy non-pregnant controls. The microbiological assay by Baker is probably more reliable due to limitations of other methods of accurately extracting B12 and likely explains the difference between the studies. Therefore, substantially higher levels than 12 mcg/day appear necessary to stabilize B12 levels during pregnancy.

One large study in India (where B12 deficiency is common due to vegetarian diets) found that 50 mcg/day of vitamin B12 during pregnancy and early lactation led to significant increases in maternal B12 levels in blood and breastmilk, and infant levels of B12, and improved biomarkers of infant need for B12 (homocysteine, methylmalonic acid).

Abnormal maternal vitamin B12 levels may also be linked to risk of autism. As discussed in the folate section, one study found that very high levels of maternal plasma folate at birth (>90th %) or vitamin B12 (>90th %) resulted in an increased risk of ASD (OR-2.5), and if both folate and folate B12 high, the risk was very high (OR=13.7). Conversely, if both B12 and folate were low, the risk of ASD was also increased (OR=2.4). Another study of maternal blood levels at 2-5 years after birth found that mothers of children with ASD had 25% lower levels of vitamin B12 compared to mothers of typical children, p=0.003; so, investigation of their B12 levels during pregnancy is warranted.

### Intake:

The NHANES study found that from 2017 to 2018, the average daily dietary intake of vitamin B12 of US women aged 20-39 was 3.67 mcg/day, which is more than the RDA recommendation of 2.6 mcg/day for pregnant women. However, a small percentage of women may need approximately 400 mcg or more, due to very poor absorption (lack of intrinsic factor needed for absorption of B12). Vitamin B12 is very well tolerated even at high doses, and no Tolerable Upper Limit has been established.

### Discussion:

Vitamin B12 levels decrease substantially during pregnancy unless supplemented at levels well above the RDA. The average dietary intake is more than the RDA, but much higher intake is needed to maintain normal blood levels.

### Recommendation:

The inventors recommend approximately 25 mcg/day (preferably as hydroxocobalamin since it is better absorbed and has better retention) pending further research. It is important that vitamin B12 be supplemented for at least a month before conception to reduce the risk of neural tube defects, since they form in early pregnancy. Vegetarians should consume approximately 50 mcg/day due to the very low B12 content of vegetarian diets (B12 is mostly found in fish, meat, poultry, eggs, milk, and milk products). A very small percentage of women of child-bearing age may have low intrinsic factor, and without that, the absorption of vitamin B12 is only about 1%, so 100× higher oral doses are needed than the standard RDA; i.e., about 500-1000 mcg/day for this population. This recommendation appears likely to reduce the rate of infertility, miscarriages, gestational diabetes, preeclampsia, preterm birth, low birth weight, neural tube defects, serious heart defect, and possibly type 2 diabetes in offspring.

Comparison with Commercial Prenatal Supplements:

Vitamin B12 is included in 97% of prenatal supplements; when included, the median level is 8.5 mcg (Q1: 8/Q3: 20). Only 23% of prenatals meet or exceed our recommendation.

### Example 18. Optimal Prenatal Vitamin/Mineral Supplement for Women in the US: Choline

### Research:

Choline aids in the production of phosphatidylcholine (the main component of cell membranes) and acetylcholine (an important neurotransmitter involved in muscle control, memory, cognition, and cardiovascular regulation). In addition, choline is the primary dietary source of methyl groups (after it is converted to betaine), which modulates the DNA of all cells. It is important for optimal fetal brain development as well as possibly reducing the risk of neural tube defects, autism, and Down syndrome in the infant (see Table 6).

Choline is needed for optimal fetal brain development, and the majority of women are consuming too little choline. There is an increased demand for choline in late pregnancy. Since choline influences, several physiological systems in the infant, supplementing mothers with choline may have a long-term impact on the child's health. Higher maternal choline levels, especially in the second trimester, are associated with higher visual memory scores in their children at age 7. Also, the higher the status of choline in the mother, the greater the protective effect it had against neural tube disorders (OR=0.14). One study found that dietary intake of 920 mg/day for 12 weeks might not be enough during pregnancy. A review article suggests that maternal supplementation of choline may reduce the risk of Down's syndrome and Alzheimer's. One study that involved supplementing pregnant women with 900 mg/day of choline (as phosphatidylcholine) found it was safe, and helped increase cerebral inhibition in the infant at 5 weeks (but not at 13 weeks), which may be relevant to risk of schizophrenia.

### Intake:

The NHANES study found that from 2017 to 2018, the average daily intake of Choline for US women aged 20-39 was 285 mg/day, which is substantially less than the RDA recommendation of 450 mg/day of choline for pregnant women. The Tolerable Upper Limit is 3500 mg/day.

### Discussion:

Average dietary intake of choline is much less than the RDA, and demand for choline increases as pregnancy progresses. Total dietary intake of 920 mg/day may be insufficient, but supplementation with 900 mg/day was safe and possibly beneficial.

### Recommendation:

Therefore, for US women, the inventors recommend that prenatal supplements contain at least 350 mg of choline during the first two trimesters, and roughly 600 mg in the third trimester, especially for women who do not consume several eggs/week (eggs have the highest dietary content of choline per serving, with one large egg containing 300 mg of choline). This recommendation appears likely to improve brain development in infants, and possibly help with other conditions as well.

Comparison with Commercial Prenatal Supplements:

Choline is included in 40% of prenatal supplements; when included, the median level is 25 mg (Q1: 10/Q3: 55) of 0.6+/−550 mg. Only 2% of prenatal supplements meet or exceed our recommendation for choline.

### Example 19. Optimal Prenatal Vitamin/Mineral Supplement for Women in the US: DHA

### Research:

Docosahexaenoic acid (DHA) is an essential part of the brain, eyes, and of the membrane of every cell. It is an essential fatty acid that needs to be consumed as part of a healthy diet. The primary source of DHA is from fish, but humans also have a limited ability to convert about 9% of alpha-linolenic acid to DHA and 21% to EPA. During pregnancy, DHA is especially important for reducing the risk of preterm birth and preeclampsia, and for treating gestational diabetes (see Table 9).

A systematic review of 13 studies of DHA levels during pregnancy found that absolute concentrations of DHA and other omega-3 fatty acids in blood increase during pregnancy, especially from trimester 1 to 2, presumably due to increasing need by the fetus. However, there is a decrease in the relative concentration of DHA compared to other fatty acids, due to increased transfer of DHA to the infant, especially during the 3rd trimester. Similarly, individual studies investigated other indicators of DHA status (DHA deficiency index) and also reported evidence of a steadily increasing deficiency of DHA from early in pregnancy to delivery. One study compared 300 mg/day and 600 mg/day of DHA vs. placebo (178) in 345 women in the US. They found that gestational length increased 3.5 days (p=0.06) and 4.0 days (p=0.03) in the two treatment groups compared to controls. RBC DHA decreased 10% in the controls, but increased 7% in the 300 mg/day group and 21% in the 600 g/day group. The combined 300 and 600 mg/day groups had a significantly lower rate of early preterm birth compared to the placebo group (1.7% vs. 5.7%, p<0.05), and gestational length increased 3.5 days (p=0.06) and 4.0 days (p=0.03) in the two groups compared to controls.

Regarding perinatal depression, a meta-analysis of 12 studies of omega 3 fatty acid levels in blood found that, compared to healthy controls, women with perinatal depression (prenatal or postnatal) had significantly lower levels of DHA and total n-3 PUFAs and significantly increased ratio of n-6/n-3. A subgroup analysis for women with prenatal depression found that they had significantly lower levels of n-3 PUFAs, EPA, and DHA. Both prenatal and postnatal depression subgroups had significantly higher ratio of n-6/n-3. Similarly, an ecological analysis of 22 countries found that rates of postpartum depression varied widely between countries, from 2% to 24%, and higher concentrations of DHA in breastmilk and higher seafood consumption were strongly associated with lower levels of postpartum depression (R=−0.81, p<0.001 and R=−0.84, p<0.0001). A meta-analysis of eight omega-3 supplementation studies for 638 women with perinatal depression found that supplementation had moderate benefits on reducing depression (SMD=0.65, 95% CI=: 0.10, 1.20, P=0.02). Doses were moderate to high (1-6 g/day of omega 3). The studies with a ratio of EPA/DHA above 1.5 had a higher benefit, consistent with similar studies for a major depressive disorder, which found that EPA-rich formulas with EPA above 1 g/day were most beneficial. However, a meta-analysis of several prophylactic omega-3 supplementation studies did not demonstrate a significant benefit of omega 3 supplementation in preventing perinatal depression; it is possible it is only beneficial in those with lower levels of omega 3 fatty acids.

Regarding preterm birth and gestational duration, one epidemiological analysis investigated preterm birth (<37 weeks gestation) and total omega 3 intake in 184 countries. The fit to the data found that rates of preterm birth were approximately 12% at the lowest level of omega 3 consumption, and decreased linearly to about 9% at 600 mg/day, and then plateaued at levels above 600 mg/day. Similarly, three small studies found that higher levels of omega-3 fatty acids in erythrocytes (measured in mid or late pregnancy) were associated with increased length of gestation. A large study of a Danish Birth Cohort evaluated 376 women with early preterm birth (<34 gestational weeks, excluding preeclampsia) and 348 random controls. The average level of DHA plus EPA in plasma (measured at 9 and 25 weeks gestation) was about 27% lower in the women with early preterm birth. Levels of DHA+EPA were strongly inversely correlated with the rate of early preterm birth, plateauing at levels around 2-2.5% DHA+EPA (as % of total fatty acids). The quartile with the lowest levels of DHA+EPA had a RR=10.3 (95% CI=6.80-15.79, p<0.0001), and the 2nd quartile had a RR=2.86 (95% CI 1.79-4.59, p<0.0001), so this was a major difference in risk of preterm birth, especially in the lowest quartile.

A meta-analysis of the effect of omega 3 fatty acid supplementation during pregnancy found several significant benefits related to preterm birth. The analysis evaluated 70 RCTs involving 19,927 pregnant women comparing omega-3 LCPUFA interventions (supplements and food) compared with placebo or no omega-3. Most studies were done in upper-middle or high-income countries, and almost half of the trials included women with increased risk of adverse maternal and birth outcomes. Dosages of DHA and/or EPA varied substantially. The meta-analysis found that omega 3 supplementation significantly reduced risk of preterm birth (<37 weeks, RR=0.89, 95% CI=0.81 to 0.97; 26 RCTs, 10,304 participants; high-quality evidence) and especially early preterm birth (<34 weeks, RR=0.58, 95% CI 0.44 to 0.77; 9 RCTs, 5204 participants; high-quality evidence). Similarly, there was a significant increase in length of gestation (mean increase of 1.67 days, 95% CI 0.95 to 2.39 days; 41 trials, 12,517 participants; moderate-quality evidence) and an increase in prolonged gestation (>42 weeks, (RR 1.61 95% CI=1.11 to 2.33; 5141 participants; 6 RCTs; moderate-quality evidence). There was also a reduced risk of low birth weight (RR 0.90, 95% CI 0.82 to 0.99; 15 trials, 8449 participants; high-quality evidence). Unfortunately, there was a possible small increase in large-for-gestational age infants. There was a possibly reduced risk of preeclampsia (RR=0.84), perinatal death (RR=0.75), and possibly fewer neonatal care admissions (RR=0.92). In summary, this meta-analysis of many studies found that omega 3 supplementation reduced preterm birth, early preterm birth, and low birth weight, consistent with increases in length of gestation and birth weight, and possibly reduced rates of preeclampsia, perinatal death, and neonatal care admissions.

The benefits of fish oil seem to be greatest in women with low fish intake. One study of 533 women found that fish oil (1300 mg EPA, 900 mg DHA) increased pregnancy duration by 7.4 days in the women with low fish intake, 4.8 days in women with medium fish intake, and little effect (minus 1.6 days) in those with high fish intake. Similar results were found in a RCT of 495 women with previous problem pregnancies, and in a study of 5531 women in China. The latter study compared two different doses (approximately 275 mg EPA, 183 DHA vs. 1100 mg EPA, 732 DHA) and found similar benefits compared to placebo for the low-fish consumers, and no benefit for the high-fish consumers. This suggests that the lower dose (275 mg EPA, 183 DHA) was sufficient.

For women with recurring preterm birth, one study of supplementation with 900 g/day of DHA and 1300 g/day of EPA resulted in a significantly lower rate of preterm birth in the supplemented group (22%) vs. the untreated group (33%), p=0.05, and a significantly lower rate of early preterm birth (4.6% vs. 13.3%, p=0.04). However, a similar study with similar dosages found no effect.

For preeclampsia, one meta-analysis analyzed 14 supplementation studies and found that omega-3 fatty acids supplementation reduced the risk of preeclampsia (RR, 0.82; 95% CI, 0.70-0.97; p=0.024), and the benefit was primarily in women with low-risk pregnancies. Supplementation with DHA alone vs. DHA+EPA had similar benefits. Similarly, one study found that women with preeclampsia had 17% lower levels of DHA (p<0.05) in plasma at delivery compared to women with healthy pregnancies, and cord blood levels were also 17% lower.

For gestational diabetes, one meta-analysis of seven RCT's found that supplementation of omega 3 fatty acids to women with gestational diabetes substantially reduced fasting plasma glucose (standard mean difference (std. MD)=−0.56; 95% CI=−0.87 to −0.24; p=0.0005), reduced homeostatic model of assessment for insulin resistance (HOMA-IR) (std. MD=−0.52; 95% CI=−0.83 to −0.21; p=0.001), and high-sensitivity CRP ((std. MD=−1.14; 95% CI=−2.0 to −0.29; p=0.009). There was also a possible decreased risk of macrosomia (risk ratio (RR)=0.48; 95% CI=0.22-1.02; p=0.06) and possible reduced risk of newborns' hyperbilirubinemia (RR=0.46; 95% CI=0.19-1.10; p=0.08). So, it appears that omega-3 fatty acid supplementation can provide significant benefits on glycemic control and inflammatory response for women with gestational diabetes, although it does not seem to help prevent it.

Focusing on studies in the US, Americans have been reported to have among the lowest level of DHA in human breast milk in the world (0.19%, vs. a worldwide mean of 0.32%. There were 6 RCTs on effect of DHA or DHA and EPA on preterm birth and/or gestational length. Five studies involved low doses of DHA (4 studies at doses of 300-600 mg/day of DHA and 1 study of 137 mg/day of DHA in DHA-rich eggs) and found significant improvement in rates of early preterm birth low birth weight and/or gestational duration. One study in the US analyzed the effect of compliance with taking capsules (600 mg/day of DHA), and found that higher compliance was significantly associated with lower rates of early preterm birth, low birth weight, and very low birth weight. So, this suggests that 600 mg/day of DHA is better than lower doses for women in the US. One RCT for women with recurring preterm birth involving 800 mg of DHA and 1200 mg of EPA found only slight non-significant benefits on preterm birth and gestational duration, so possibly those higher doses are less beneficial.

### Intake:

An analysis of 2003-2012 NHANES data for 788 pregnant women in the US found that they consume approximately 66 mg/day of DHA and 34 mg/day of EPA. In contrast, the 2007 position paper of the American Dietetic Association and Dietitians of Canada recommend 2 servings/week of fatty fish, containing approximately 500 mg of DHA and EPA, although they do not make a recommendation on fish oil during pregnancy. So, fish intake in the US is only about 20% of what is recommended.

### Discussion:

DHA supplementation is most beneficial to women with low to moderate fish intake (less than 4 servings/month) and/or a history of previous preterm birth or preeclampsia. Omega-3 supplementation does not seem to help prevent perinatal depression, but it does seem to be helpful for reducing its severity, especially with ratios of EPA/DHA above 1.5 and doses above 1 g of EPA. Review of 5 US supplementation studies suggest that 600 mg/day of DHA is better than lower dosages.

### Recommendation:

For US women, the inventors recommend that prenatal supplements contain approximately 600 mg of DHA, although more research is needed. This is enough to compensate for the typical decrease in DHA (as % of total fatty acids) during pregnancy, and 4 studies in the US found that dosages of 300-600 mg/day of DHA were helpful in improving rates of early preterm birth, low birth weight, and gestational duration, and one study found that 600 mg/day was more effective than lower dosages. Supplementation with DHA may also reduce risk of gestational diabetes, preeclampsia, and some food allergies in infants. Women with low seafood consumption (less than 1 serving/week of fatty fish) are most likely to benefit. Women who develop prenatal or postnatal depression may benefit from adding 1000 mg or more of EPA.

Comparison with Commercial Prenatal Supplements:

DHA is included in 42% of prenatal supplements; when included, the median level is 200 mg (Q1: 128/Q3: 282.5) of 3+/−1000 mg. Only 1% meet or exceed our recommendation for DHA; however, DHA or fish oil is sometimes given separately from prenatals since it is usually taken in an oil form, and a powder form would require much more volume.

### Example 20. Optimal Prenatal Vitamin/Mineral Supplement for Women in the US: Inositol

### Research:

Inositol is a nutrient similar to glucose that is synthesized in the kidneys and present in the highest concentrations in the brain and heart. It acts as a second messenger to various hormones such as insulin, follicle stimulating hormone, and thyroid stimulating hormone. It also controls fat and sugar metabolism, nervous system cellular functions, and gene expression. Supplementation in pregnant women demonstrated improved insulin resistance in those with gestational diabetes, lower incidence of neural tube defects (NTDs) in those with folate resistant NTDs, and improve fertility in women with Polycystic Ovarian Syndrome (PCOS) (see Tables 5 and 6).

There are nine different stereoisomers of inositol, with myo-inositol being the most common natural form. Myo-inositol (MI) supplementation of 4 grams per day greatly reduced gestational diabetes (GD) in at risk women, and reduced insulin and fasting blood glucose in women with GD. A review of multiple studies of MI demonstrates its importance in regulating a variety of cellular processes, including those related to gamete development, fertilization, and early embryonic development.

In inositol-deficient mouse models, 70% of offspring had NTDs, causing authors to speculate that MI plays a major role in neural tube closure. A case (n=63) control (n=102) study revealed that humans with a low maternal serum MI concentration (≤13.2 nmol/L) had a 2.6-fold increased risk of offspring with spina bifida, and children with spina bifida had serum MI concentrations that were 7% lower than controls. One large study of pregnant women with neural tube defects (n=200) vs. controls (n=320), found that the maternal plasma MI concentrations in the spina bifida subgroup were 7.1% lower than controls. In two small studies, women with previous NTDs (combined n=31), which are at high risk of recurrent NTDs, were supplemented with MI (500 mg-1000 mg) and folic acid (5 mg) (210, 211). In both studies, those taking the MI plus folic acid supplements had zero recurrences of NTDs.

Additionally, MI and folic acid together can restore ovarian activity and subsequent fertility in women with PCOS (212). Women with PCOS (n=98) were supplemented with MI (4 g) plus folic acid (400 mcg) or folic acid only (1.5 mg) to evaluate prevalence of gestational diabetes (GD). Prevalence of GD in the MI plus folic acid group was 17.4% vs. 54% in the folic acid only group, p<0.001.

A study of 223 overweight, non-obese pregnant women found that 2000 mg/day of MI resulted in a significant decrease in gestational diabetes compared to placebo.

An analysis of 3 studies of myoinositol supplementation in women at risk of gestational diabetes found that 4000 mg/day of myoinositol resulted in significant reductions in the risk of preterm birth (3.4% vs. 7.6%, p=0.03), macrosomia (2.1% vs 5.3%, p=0.04), large for gestational age (4.8% vs. 8.9%, p=0.04) and gestational diabetes (11% vs. 25%, p<0.001).

### Intake:

The NHANES study did not include inositol, nor is there an RDA recommendation. Daily intake is approximately 650 mg/day on a typical American diet of 1800 kcal, with ranges of about 225-1500 mg/day. In addition, the kidneys produce about 2 g/day per kidney, so about 4 g total in healthy individuals, and there is also some myo-inositol production in the rest of the body. A review of multiple inositol studies in humans showed zero side effects in supplementation of less than 6 grams per day, with many testing 6-18 grams per day. Only some mild diarrhea was reported in some subjects taking high doses up to 18 grams per day. Therefore supplementation with less than 6 grams appears to be safe.

### Discussion:

In determining the optimal dose for inositol, more research is needed. Doses of 4000 mg/day were enough to reduce the risk of GD in at-risk women. Doses of 500-1000 mg were enough to reduce the risk of NTD. However, in both cases it is possible that lower doses would have been sufficient.

### Recommendation:

For US women, the inventors recommend that prenatal supplements contain approximately 500 mg of Myo-inositol, with some women at risk for gestational diabetes or with previous NTDs needing up to 4000 mg depending on diet. Note that this is a rather large volume, so although it could be taken as several capsules, it could also be consumed as a powder mixed in juice since inositol has a slightly sweet taste. This recommendation appears likely to reduce the risk of insulin resistance in gestational diabetes and NTDs in folate resistant NTDs, and improve fertility in women with PCOS.

Comparison with commercial prenatal supplements:

Inositol is included in 17% of prenatal supplements; when included, the median level is 10 mg (Q1: 10/Q3: 20). No prenatal supplement meets nor exceeds our recommendation.

### Discussion:

Vitamins are crucial dietary components needed to support human health and infant development. The levels of most vitamins decrease significantly during pregnancy, including vitamins A, C, D, K, B1, B3. B5, B6, folate, biotin, B12, resulting in increased risk of a wide range of pregnancy complications and infant health problems. Many research studies suggest that prenatal vitamin supplementation can reduce the risk of many of those problems. Note that although the present disclosure is focused on nutritional supplementation, improving diets should also be a goal to support overall health. Nutritional supplementation is not a substitute for a healthy diet but should be used to supplement a diet when needed, such as during pregnancy when the levels of many vitamins decrease substantially if not supplemented.

There is no national standard on the recommended amount of vitamins in prenatal supplements, so there is wide variation in their content. Most prenatal supplements on the market today have substantially lower levels than the inventors' recommendation. Supplementation below the inventors' recommendations may not adequately support a mother and her fetus. The inventors therefore believe that an urgent need exists for recommendations to reduce the current level of pregnancy complications and infant health problems listed in Tables 1 and 2, and which in total affect approximately half of pregnancies.

### Associations Between Health Outcomes and Vitamin Status:

The associations between health outcomes of mother or infant and vitamin/nutrient status are summarized in Table 8 and Table 9. “Substantial Evidence” is defined as a positive meta-analysis/review or two or more statistically significant studies of the association, and a ratio of 2:1 or greater of positive to null studies. “Limited Evidence” associations are listed when there is at least one study with statistical significance, and the ratio of positive to negative studies is greater than or equal to 1:1. As can be seen in tables 8 and 9, many maternal and infant health outcomes are associated with low levels of vitamins/nutrients.

The associations of maternal pregnancy complications with vitamin status are listed in Table 8, while the association of infant outcomes with maternal vitamin status are listed in Table 9. Both Tables 10 and 11 list the same data as Table 6 and 2 but organized by vitamin. Altogether, there is evidence that many pregnancies and infant health problems are related to maternal vitamin/nutrient status during pregnancy, but more research is needed in some cases to verify the association.

### Example 21. Optimal Prenatal Vitamin/Mineral Supplement for Women in the US: Calcium

### Research

Calcium is essential for bone and tooth growth, so a lack of calcium in infants causes growth delays and bone deformations, otherwise known as rickets. Calcium is also important for control of blood pressure, nerve impulses, muscle contraction, and secretion of some hormones.

Low calcium is especially associated with preeclampsia during pregnancy. Women under the age of 20, as well as women who live in the southern part of the United States, are reported to have a greater risk for preeclampsia. Levels of total serum calcium and bone density decline throughout pregnancy, indicating a need for calcium supplementation for most pregnant women.

A meta-analysis of 14 articles compared patients who had pregnancy-induced hypertension (PIH) with patients with healthy pregnancies, and found that patients with PIH had slightly lower calcium levels than healthy gravidas.

A Cochrane review of calcium supplementation found the following for high-dose and low-dose supplementation: For high-dose calcium supplementation (≥1 g/day), 13 high-quality studies (involving 15,730 women) found that supplementation significantly reduced the risk of high blood pressure (RR (Relative Risk)=0.65) and preeclampsia (RR=0.45). The effect was most significant for women with low-calcium diets and women at high risk for preeclampsia. Calcium supplementation also somewhat reduced the risk of maternal death or serious morbidity (RR=0.80) and preterm birth (RR=0.76). One possible rare negative effect of calcium supplementation involved two trials involving 12,901 women that found a small increased risk of HELLP (hemolysis, elevated liver enzymes, and low platelets) occurring in 16 cases among the supplemented women vs. 6 in the un-supplemented group; these two studies involved dosages of 1500-2000 mg/day of elemental calcium. Regarding childhood outcomes, one study showed a reduction in childhood elevated blood pressure, and one study found a reduced rate of dental caries at age 12.

For low-dose calcium supplementation (<1 g/day), 10 trials (involving 2234 women) evaluated supplementation with low doses of calcium alone (4 trials) or in association with vitamin D (3 trials), linoleic acid (2 trials), or antioxidants (1 trial). Supplementation with low doses of calcium substantially reduced the risk of preeclampsia (RR=0.38). There was also a reduction in hypertension, low birth weight, and neonatal intensive care unit admission.

Similarly, another meta-analysis of 27 trials with 28,492 pregnant women found that calcium supplementation was effective in decreasing the risk of preeclampsia (RR 0.51, 95% CI (Confidence Interval): 0.40 to 0.64) and gestational hypertension (RR 0.70, 95% CI: 0.60 to 0.82).

Two small studies found that 600 mg of calcium plus 450 mg of linoleic acid for women with a high risk of preeclampsia was dramatically effective in reducing rates of pregnancy-induced hypertension (PIH) (8% in treatment vs. 42% in controls) and preeclampsia (9% vs. 37%).

Preeclampsia almost doubles the risk of children being born with autism. Similarly, one retrospective study in China found that calcium supplementation was associated with a decreased risk of ASD (OR=0.48, CI=0.28, 0.84).

One study in Trinidad (Pacific Islands) of 510 women found that 1200 mg of calcium was much more effective than 600 mg of calcium plus aspirin at reducing the risk of preeclampsia, PIH, and hypertension in a population where these risks were relatively high (10-25%).

In one study in Hong Kong, pregnant women with a moderate to high risk of PIH were supplemented with placebo or calcium (600 mg calcium from 22 to 32 weeks, and 1200 mg/day from week 32 to birth). Supplementation reduced the rate of proteinuric PIH (more severe PIH) to 5.6% in the calcium group (n=154) vs. 10.7% in the placebo group (n=83), p=0.06. Similarly, the rates of non-proteinuric PIH were 15% and 24%, respectively.

Another study investigated doses of 120 mg, 240 mg, 1000 mg, 2000 mg, or placebo and found that the incidence of pregnancy-induced hypertension was 8.9%, 7.5%, 8%, and 4%, respectively, in these groups vs. 18% in the control group—this suggests that even 120 mg may be beneficial, but 2000 mg may be best for some. In a 2011 report, the World Health Organization (WHO) recommended 1.5-2 g/day supplementation of calcium in areas with low dietary intake of calcium, especially for those at high risk of developing preeclampsia.

Overall, low levels of calcium are associated with many maternal and infant health problems, and calcium supplementation has many benefits at moderate and high doses and only a possible rare risk of HELLP at high dosages (1500-2000 mg/day).

### Intake

The NHANES study found that from 2017 to 2018, the average daily dietary intake (not including supplements) of calcium of U.S. women aged 20-39 was 872 mg/day, which was only 87% of the RDA recommendation of 1000 mg of calcium for pregnant women age 20-39. The Tolerable Upper Limit of calcium intake is 2500 mg.

### Recommendation

Calcium levels decrease during pregnancy unless supplemented, so for U.S. women, the inventors recommend that prenatal supplements contain approximately 550 mg of elemental calcium, with some women needing more depending on their diet (i.e., if they have a low intake of milk or milk-based foods or low vegetable intake). For women with higher risks of preeclampsia, preterm birth, gestational hypertension, or who have a calcium-deficient diet, we recommend that they supplement with at least 1000 mg of calcium. This recommendation will likely reduce the risk of preeclampsia and possibly help with other conditions such as preterm birth, gestational hypertension, low birth weight, neonatal mortality, and autism. Note: Vitamin D should be given with calcium to improve calcium absorption and to prevent cellular apoptosis or artery hardening due to excess calcium.

Comparison with Commercial Prenatals

Calcium is included in 78% of prenatal supplements; when included, the median level is 200 mg (Q1: 150/Q3: 300.0). Only 8% of prenatal supplements meet or exceed our recommendation for calcium.

### Example 22. Evidence Based Recommendations for an Optimal Prenatal Vitamin/Mineral Supplement for Women in the US: Chromium

### Research

Chromium is recommended to control blood sugar levels, and low levels are associated with diabetes. One study measured chromium content in hair twice during pregnancy and found it decreased as the pregnancy progressed. Similarly, two studies found that chromium levels in hair were very low in pregnant women (at the ends of their pregnancies) compared with non-pregnant controls, and one of the studies found that it took four years for these levels to return to normal. One study found that diabetic mothers and their infants (n=76) had lower levels of chromium in scalp hair compared to the referent mothers-newly-born infant pairs (n=68), and diabetic mother—newly born infant pair samples had high urinary excretion of chromium. In contrast, a study found that that women with gestational diabetes had much higher chromium in their hair than nondiabetic pregnant women, and pregnant women with pre-gestational overt diabetes mellitus had intermediate levels. Further research is needed on levels of chromium during pregnancy, but the limited data from hair analysis suggests that chromium levels may decrease during pregnancy.

One study in India found that pregnant women with gestational diabetes had much lower levels of serum chromium. In comparison, another study in the U.S. found no difference in serum chromium in 396 nondiabetic pregnant women vs. 29 pregnant women who had gestational diabetes. The difference is likely due to lower levels of chromium in India.

One study in the U.S. provided 4 i.g/kg of chromium or placebo to 24 women with gestational diabetes. Supplementation significantly improved their fasting plasma glucose and insulin levels and significantly improved their glucose and insulin response to a 100 g glucose loading test. However, in this study, women with severe glucose intolerance had only a partial improvement and still needed insulin therapy. They hypothesized that higher dosages might be necessary.

One study found that eight weeks of supplementation of 200 i.g of chromium in non-pregnant women with polycystic ovary syndrome (an insulin-resistant condition) led to several benefits and possibly an increase in pregnancy rate (17% vs. 3%, p=0.08) during that eight weeks. Similarly, another study found that eight weeks of supplementation with 200 i.g/day of chromium in infertile women with polycystic ovary syndrome led to significant improvements in biomarkers of inflammation and glucose.

Chromium supplementation is commonly used in treatment of diabetes (improving glycemic control), and although controversial as to whether or not it is beneficial (due in part to some studies using chromium chloride, an ineffective form), a meta-analysis of 22 randomized controlled trials found that it improved glycemic control, reduced triglycerides, and increased HDL-C (high density lipoprotein-cholesterol) levels. Chromium picolinate was the form with the greatest effects on glucose and triglyceride levels. Doses over 200 i.g/day were more effective at improving glycemic control, and there was no difference in the adverse events between chromium and placebo.

Several studies have suggested that chromium supplementation at 400-600 i.g/day is helpful for atypical depression. Therefore, we speculate that it may also help prevent post-partum depression, and research in this area would be beneficial.

Overall, low chromium is associated with gestational diabetes, and chromium supplementation improves glucose and insulin levels.

### Intake

There is no NHANES data on the average daily intake of chromium, but it is estimated that adult women consume about 23 to 29 i.g of chromium per day from food. The RDA for chromium is 30 i.g/day for pregnant women. Chromium is generally well-tolerated, and no Tolerable Upper Limit has been established; in 1989, the National Academy of Sciences established an “estimated safe and adequate daily dietary intake” of 50 to 200 i.g/day for adults and adolescence.

### Recommendation

Limited data in hair suggests that chromium levels decrease during pregnancy. For U.S. women, the inventors recommend that prenatal supplements contain at least 100 μg/day of chromium as chromium picolinate, although more research is needed to determine optimal dosing, and women who develop gestational diabetes or women with diabetes should use 200 μg/day or more to improve glycemic control. The best form is chromium picolinate; the worst form (mostly ineffective) is chromium chloride. This recommendation may reduce the risk of gestational diabetes and possibly improve fertility in women who have PCOS.

Comparison with Commercial Prenatals

Chromium is included in 35% of prenatal supplements; when included, the median level is 79 μg (Q1: 30/Q3: 120). Sixteen percent of prenatal supplements on the market contain enough chromium to meet or exceed our recommendation.

### Example 23. Optimal Prenatal Vitamin/Mineral Supplement for Women in the US: Copper

### Research

Copper is needed for several functions, including iron absorption, formation of connective tissue, energy metabolism, oxidative stress, and brain development. Copper is recommended to prevent miscarriages and is necessary to prevent anemia because copper-based enzymes are needed for iron absorption.

Copper levels increase during pregnancy, eventually reaching twice that of non-pregnant women, due to increasing estrogen. One study of over 800 problem pregnancies found that serum copper levels were much lower throughout pregnancy compared to healthy pregnant controls and especially lower in those involving spontaneous abortion of the fetus. Similarly, other studies have found lower copper in women with spontaneous abortion, threatened abortion, missed abortion and blighted ovum, and in anencephalic pregnancies. Another study found that in drinking water, copper was the mineral most strongly associated with central nervous system (CNS) malformations. One study found that low copper was associated with premature rupture of membranes (PROM) in preterm, but not term, pregnancies. A meta-analysis of 17 studies of Asian populations and a meta-analysis of 12 Asian and European studies found that copper levels were higher during the third trimester in women with preeclampsia, and several studies have reported increased ceruloplasmin during pregnancy, and 96% of serum copper is bound to ceruloplasmin-therefore, increased oxidative stress associated with preeclampsia may result in an increased production of ceruloplasmin (an antioxidant) to combat the preeclampsia. It is unclear if copper is causing oxidative stress (as free copper) and an increased risk of preeclampsia, or if it is merely a symptom of the body's antioxidant response to preeclampsia. A study in France provided 2 mg of copper as part of a multi-vitamin/mineral supplement, and this resulted in no difference in copper levels between treatment and placebo groups.

One RCT involving 1 mg/day of copper found that supplementation resulted in significant decreases in depression (75% and 90% decreases in the second trimester and third trimester, respectively) and significant decreases in anxiety (45% and 80% decreases in anxiety symptoms in the second trimester and third trimester, respectively). There was also a significant decrease in rate of infection during pregnancy (p=0.046).

Overall, it appears that low copper in early pregnancy is a risk factor for spontaneous abortion and CNS malformations, so supplementation before conception seems essential, and low copper in later pregnancy is a risk factor for PROM.

### Intake

The NHANES study found that from 2017 to 2018, the average daily dietary intake (not including supplements) of copper of U.S. women aged 20-39 was 1.1 mg/day, which was slightly more than the RDA recommendation of 1 mg/day for pregnant women. The Tolerable Upper Limit for pregnant women is 10 mg/day.

### Recommendation

Therefore, for U.S. women the inventors recommend that prenatal supplements contain approximately 1.3 mg of copper, based on the limited research to date. Supplementation before conception may help decrease the rate of miscarriages and CNS defects, and supplementation at that time or later may reduce the risk of anemia and PROM.

Comparison with Commercial Prenatals

Copper is included in 58% of prenatal supplements; when included, the median level is 1.5 mg (Q1: 1.0/Q3: 2.0). Forty-one percent of prenatal supplements on the market meet or exceed our recommendation.

### Example 24. Optimal Prenatal Vitamin/Mineral Supplement for Women in the US: Iodine

### Research

Low iodine is strongly associated with iodine deficiency disorders, including hypothyroidism in mothers and infants and intellectual disability in infants. Low iodine is possibly related to preeclampsia and autism. Low iodine results in reduced thyroid hormone synthesis, which causes increased pituitary TSH production, which stimulates thyroid growth and can result in maternal or fetal goiter.

Iodine supplementation is strongly recommended for pregnant women to decrease the rate of hypothyroidism and intellectual disability in their children. Worldwide, 2 billion people have insufficient iodine intake, 31% of children have insufficient iodine intake, and, hence, it is a common cause of hypothyroidism, intellectual disability, and intellectual impairment. In the U.S., iodine deficiency was especially common in the iodine-deficient regions of the Great Lakes, Appalachians, and the northwestern area of the country, affecting 26-70% of the population in those regions until the 1920s, when the use of iodized salt began. Worldwide, 120 countries now require iodization of salt, but in the U.S., it is still optional, only 70-76% of the U.S. population uses iodized salt, and half the salt brands in the U.S. use less than the level recommended by the FDA. Furthermore, from the 1970s to the 1990s, there was a 50% decrease in median urinary iodine levels in the U.S, apparently due to decreased use of iodized table salt, so an increasing number of women and infants are at risk of iodine deficiency. The median urinary iodine concentration in women aged 15-44 years in the U.S. in the 2011-2014 National Health and Nutrition Examination Survey (NHANES) surveys was 110 mcg/L, which was mildly deficient compared to World Health Organization (WHO) guidelines of 149-249 μg/L for optimal levels and 50-150 for marginally deficient. Iodine requirements increase during pregnancy due to at least three factors: (1) increased need for thyroxine (T4) to maintain normal metabolism in the mother, (2) a transfer of iodide and T4 from the mother to the fetus, and (3) possible increased loss of iodide from the kidneys, Iodine levels may remain stable during pregnancy if sufficient iodine is present in the diet, but in marginally-deficient regions, iodine levels decrease during pregnancy. An extensive review of iodine status recommended that the optimal range for total iodine intake during pregnancy was in the range of 250-300 μg.

Neurodevelopmental delay is increased in children born to mothers with iodine deficiency. Iodine deficiency needs to be corrected very early in pregnancy, as low levels after mid-gestation result in permanent damage. Higher psychomotor test scores were observed in children whose mothers were supplemented with iodine before the third trimester in comparison to those who were provided iodine later in pregnancy or at 2 years of age.

Severe iodine deficiency during pregnancy results in increased rates of miscarriage, stillbirth and infant mortality, and impaired cognitive function of infants. It can also result in cretinism, which involves severe intellectual disability, deaf-mutism, and motor rigidity. Iodine deficiency is the leading cause of preventable intellectual disability worldwide.

Mild to moderate iodine deficiency during pregnancy increases the risk of maternal goiter and thyroid disorders as well as attention deficit disorder and impaired cognition in the infants. A meta-analysis of three studies involving 9036 mother-child pairs in Europe found that low maternal free thyroxin (T4, the major thyroid hormone produced by the thyroid gland) in early pregnancy was associated with a lower IQ in all three studies; T4 below the 2.5th percentile was associated with a 3.9-point lower nonverbal IQ and a 2.1-point lower verbal IQ.

The effect of iodine supplementation during pregnancy clearly reduces maternal thyroid disorders, but results are mixed on whether or not it can improve neurodevelopment. A systematic review and meta-analysis of 37 studies found that iodine supplementation during pregnancy reduced maternal thyroglobulin, and 3 RCTs found it reduced the increase in maternal thyroid volume during pregnancy. However, the review found that it did not affect maternal or infant thyroid-stimulating hormone or free thyroxine, and limited studies found it did not improve intellectual development of the infant. So, it appears that iodine supplementation may need to be given preconception in order to improve infant intellectual development.

A systematic review of 28 studies found “moderate evidence for an association between maternal thyroid hormone levels and offspring ADHD (attention deficit hyperactivity disorder).” Three of four studies found an association of maternal hypothyroidism and ADHD. Maternal hypothyroxinemia (normal TSH (thyroid stimulating hormone) levels and low free thyroxin (fT4)) was associated with an increased risk of ADHD in children (OR=1.54 (CI=1.02, 2.33), 4 studies).

One study found lower levels of iodine in women with severe preeclampsia. A small, randomized, double-blind, placebo-controlled study in a region of Italy with mild/moderate iodine deficiency found that supplementation with 225 ptg/day of iodine starting during the first trimester was not detrimental, greatly increased urinary iodine levels from moderate deficiency to a normal range, and reduced thyroid hyperstimulation. One small, open-label study in a region of Italy with mild iodine deficiency found that supplementing with 200 ptg/day resulted in slightly better improvements in thyroid function than supplementing with 50 ptg/day.

One study found lower levels of iodine in children with autism, and another study found 25% of children with autism had unusually low levels of iodine, suggesting a possible link between iodine deficiency and the risk of autism, consistent with studies that iodine deficiency affects language skills. The World Health Organization, UNICEF (United Nations Children's Fund), and ICCIDD (International Council for Control of Iodine Deficiency Disorders) recommend that pregnant women be supplemented with 250 ptg/day of iodine in countries with insufficient access to iodized salt to prevent iodine deficiency disorders including hypothyroidism and goiters in infants. The American Thyroid Association taskforce recommended 150 mg/day supplementation for pregnant women, starting 3 months prior to pregnancy.

Chronic excessive iodine intake can inhibit the production of thyroid hormones (known as the Wolff-Chaikoff effect). A detailed study of 7190 pregnant women in an iodine-sufficient region of China found that women with UIC (Urinary Iodine Concentration) of 150-249 ptg/L had the lowest rate of subclinical hypothyroidism and isolated hypothyroxinemia, UIC levels of 250-499 ptg/L resulted in a 1.7-fold increase of subclinical hypothyroidism, and UIC levels above 500 ptg/L were associated with a 2.8-fold increase of hypothyroxinemia.

Similarly, severe excess maternal intake of iodine (800-12,000 ug/day) can cause thyroid disorders, including congenital hypothyroidism in infants, and although effects are often transitory, some children require levo-thyroxine due to hypothyroxinemia or persistent hyperthyrotropinemia. Such high levels are uncommon in the U.S., and in a study of 907 cases of congenital hypothyroidism and 900 controls in California (U.S.), there were no differences in median blood iodine levels nor in the distribution of it at the high or low ends, suggesting that iodine levels at birth were not a major contributing factor. Therefore, although the Tolerable Upper Intake is set at 1100 i.g/day for all people, including pregnant women, the WHO has recommended that total daily intake above 500 i.g/day may be excessive.

### Intake

The NHANES study found that from 2011 to 2014, the average daily urinary io-dine concentration of U.S. women aged 15-44 years was 110 i.g/L, which corresponded to a daily intake of approximately 160 i.g/day based on standard assumptions of 100% absorption of dietary iodine, 90% excretion in the urine, and urinary excretion of 1400 mL/day, This is lower than the RDA recommendation of 220 i.g of iodine for pregnant women. Recent preferences for reduced use of salt and the use of sea salts over iodized table salt have dramatically reduced the amount of iodine in the diet. The Tolerable Upper Intake is 1100 i.g.

### Recommendation

Iodine requirements increase during pregnancy, so for U.S. women, the inventors recommend that prenatal supplements contain approximately 150 i.g of iodine, with some women needing more or less depending on their intake of iodized salt and dairy (a major dietary source of iodine). This recommendation appears likely to reduce the current rate of hypothyroidism and intellectual disability in the U.S. and possibly help with other conditions, as well.

Comparison with Commercial Prenatals

Iodine is included in 76% of prenatal supplements; when included, the median level is 150 i.g (Q1: 150/Q3: 225). Sixty-nine percent of prenatal supplements on the market meet or exceed our recommendation for iodine.

### Example 25. Optimal Prenatal Vitamin/Mineral Supplement for Women in the US: Iron

### Research

Iron is primarily needed for hemoglobin to transport oxygen in red blood cells, as well as several other roles. Two large studies found that about half of U.S. women had indicators of low iron. Similarly, iron deficiency is common in U.S. women, affecting 8.8% of non-pregnant women ages 20-35 and 11.6% of non-pregnant women ages 35-49. Iron levels decline during pregnancy, so rates of iron deficiency increase during pregnancy, reaching approximately 27.5% by the third trimester. Rates of iron deficiency are lower for the first pregnancy but increase with increasing pregnancies. Low iron levels cause anemia (low hemoglobin), which causes weakness, fatigue, reduced cognitive performance, and diminished immune response in the mother and substantially impairs brain development of the fetus, which can have life-long effects on intellectual ability.

One study found that women with low iron had a doubled risk of having a child with autism, presumably due to the critical need for oxygen transport to the brain, the highest oxygen-consuming organ in the body. One study found that the risk of orofacial clefts was significantly lower in mothers with dietary intakes of 14-22 mg/day of iron (OR 0.4). One study found that dietary intake in the highest quartile (above 18 mg/day) was associated with a significantly decreased risk of anencephaly, with an OR of 0.51 (95% CI: 0.28, 0.96).

Iron supplementation decreases the risk of anemia in mothers and infants. Three iron supplementation studies in the U.S. investigated the effects of iron (30-60 mg) or placebo on women with initially normal iron status, supplementing them for approximately weeks 20-28, followed by iron (30-60 mg) for all from weeks 28 on. Iron supplementation was generally beneficial, but there was still a dramatic decrease in serum ferritin and a substantial decrease in hemoglobin despite supplementation of 30-60 mg. One of the studies used much higher doses of 60 mg 3×/day (180 mg total) for 12 participants with iron deficiency anemia (IDA), and that reduced IDA in 75% of the subject.

it appears that women with initially normal iron status still need about 60 mg starting at week 20, and some may need up to 180 mg or more.

A meta-analysis of 44 trials involving 43,274 women compared the effects of daily iron supplements (mostly 30-200 mg/day) versus no iron or placebo. Preventive iron supplementation reduced maternal anemia at term by 70% (14 trials, 2199 women), iron-deficiency anemia at term by 67% (6 trials, 1088 women), and iron deficiency at term by 57% (7 trials, 1256 women, low quality evidence). Overall, these studies showed that iron supplementation was helpful, but that some studies used too low a level of supplementation to fully eliminate iron-deficient anemia.

### Intake

The NHANES study found that from 2017 to 2018, the average daily dietary intake (not including supplements) of iron by U.S. women aged 20-39 was 12.2 mg/day (U.S. Department of Agriculture, 2014), which was only half of the RDA recommendation of 27 mg iron for pregnant women. The Tolerable Upper Limit is 45 mg, but many studies have found benefits from doses of 60 mg during pregnancy.

### Recommendation

Iron levels decrease substantially during pregnancy, and some women begin pregnancy with iron deficiency. Therefore, for U.S. women, the inventors recommend that prenatal supplements contain at least 30 mg of iron during the first trimester and at least 60 mg starting week 20, with some women needing up to 60 mg 3×/day if iron levels are low or iron deficiency anemia occurs. The inventors strongly recommend testing iron levels before conception, or as soon after as possible, and re-testing at the start of the third trimester, when the need for iron increases substantially. Note that iron deficiency is extremely common in women, and fetal brain development during the first months is especially sensitive to iron deficiency, so it is important to normalize iron levels as soon as possible. Women with a history of anemia and with multiple pregnancies are especially at risk. This recommendation appears likely to reduce the rate of anemia and intellectual disability in the U.S. and possibly help decrease the risks of autism and anencephaly. Note that copper is needed for copper-based enzymes that absorb iron, so low copper can cause low iron.

Comparison with Commercial Prenatals

Iron is included in 89% of prenatal supplements; when included, the median level is 27 mg (Q1: 19.5/Q3: 28). Seventeen percent of prenatal supplements on the market contain iron at levels that meet or exceed our recommendation.

### Example 26. Optimal Prenatal Vitamin/Mineral Supplement for Women in the US: Magnesium

### Research

Magnesium is needed as an enzymatic co-factor for hundreds of reactions in the body and has many functions including cell signaling, ion transport, energy production, and synthesis of nucleic acids and proteins. It is also an important part of bones, cell membranes, and chromosomes.

Blood levels of magnesium decrease significantly during pregnancy, but supplementation with 345 mg/day is enough to keep magnesium levels stable. Low magnesium is strongly associated with increased risk of preeclampsia, preterm labor, and leg cramps and slightly associated with pregnancy-induced hypertension. One study found that the risk of orofacial clefts was significantly lower in mothers with dietary intakes of 376-404 mg/day of magnesium (OR 0.4). One ecological study across the U.S. found a strong inverse correlation between magnesium levels in soil and the rates of preterm birth (r=−0.68; p<0.001).

A meta-analysis of magnesium supplementation with 345 to 500 mg/day with re-analysis by the present authors to remove one study with a very low dosage averaging 32 mg/day) found significant decreases in the rate of pregnancy-induced hypertension, as well as reduced maternal hospitalization during pregnancy, preterm birth, low birth weight, and babies with low Apgar scores. One study found a dosage of 184 mg/day of magnesium gluconate substantially reduced the rate of pregnancy-induced hypertension. One study used a dosage averaging only 32 mg/day and found little benefit. Overall, magnesium supplementation was well-tolerated, and doses of 184-500 mg/day resulted in multiple benefits in all but one study.

Magnesium supplementation resulted in a very large reduction in the rate of pregnancy-induced hypertension in the two studies in Angola and China; the combined rate was 4% in the treatment group vs. 21% in the placebo group (out of a total of 201 participants). The Angola study also reported a substantial reduction in the rate of edema (24% vs. 58%, respectively). However, a study of magnesium supplementation (300 mg/day of elemental magnesium) in Brazil did not find any effect on perinatal composite outcome (preterm birth, stillbirth, neonatal death, NICU admission, or small-for-gestational-age birthweight) or for maternal composite outcome (preeclampsia, eclampsia, gestational hypertension <37 weeks, placental abruption, or maternal stroke or death during pregnancy or ≤7 days after delivery). Therefore, the effects of magnesium supplementation may vary between countries.

A more recent metanalysis of six RCT's with 3068 pregnant women found that magnesium supplementation significantly reduced the rate of preterm birth (RR=0.58, CI=0.35-0.96).

Several studies investigated giving high doses of magnesium sulfate (4-6 g) intra-venously to mothers at high risk of preterm birth (birth expected within 24 h, gestational age less than 33 weeks), to reduce the risk of cerebral palsy. A meta-analysis of five studies found that magnesium sulfate significantly reduced the risk of cerebral palsy by approximately 32% and significantly improved the rate of gross motor dysfunction. There were frequent minor side effects to the mothers (flushing, sweating, nausea, vomiting, headaches, and a rapid heartbeat (palpitations)), but no major complications.

### Intake

The NHANES study found that from 2017 to 2018, the average daily dietary intake (not including supplements) of magnesium of U.S. women aged 20-39 was 269 mg/day, which was 22% less than the RDA recommendation of magnesium for pregnant women of 350-360 mg for women ages 19 to 50. The official Tolerable Upper Limit of magnesium in a supplement is 400 mg, but eight treatment studies using levels of 345-500 mg were generally very beneficial, so the Tolerable Upper Limit evidently needs to be updated for pregnant women.

### Recommendation

Overall, because U.S. women have average magnesium intake that is 22% less than the RDA, and because levels decrease during pregnancy, the inventors recommend supplementing with 350 mg because 345 mg was found be sufficient to keep magnesium levels stable, and supplementation studies with doses of 345-500 mg were found to be beneficial. The inventors recommend avoiding the oxide form due to poor absorption. This recommendation appears likely to reduce the rate of pregnancy-induced hypertension, maternal hospitalization, preterm birth, low birth weight, and low Apgar scores, and could possibly help with other conditions as well.

Comparison with Commercial Prenatals

Magnesium is included in 66% of prenatal supplements; when included, the median level is 50 mg (Q1: 40/Q3: 181). Only 5% of prenatal supplements on the market meet or exceed our recommendation for magnesium.

### Example 27. Optimal Prenatal Vitamin/Mineral Supplement for Women in the US: Manganese

### Research

Manganese is vital for healthy brain and nervous system function as well as maintaining metabolism and hormone production. Manganese is one of the least-studied micronutrients for pregnancy, and at present, no supplementation trial for pregnancy has been published. Manganese is an essential mineral, but an excessive amount can cause neurological disorders. Manganese levels appear to increase throughout pregnancy due to low iron levels, leading to increased absorption of manganese. Low levels of manganese are associated with lower birth weight, fetal growth restriction, and possibly with preterm labor. One study in Korea found that the mean manganese concentration in whole maternal blood was 22.5 i.g/L, and birth weight peaked at the maternal blood manganese levels of 30 and 35 i.g/L and was lower if manganese was low or unusually high. One study did not find an association of blood levels of manganese with fetal growth, but the mothers were all exposed to manganese-containing pesticides, which may have confounded the results. One study found that mothers with preeclampsia had higher blood levels of manganese. One study in Korea found that low or high levels of manganese were associated with worse mental and psychomotor development at six months of age, and that median levels were best. One study found that cord blood manganese above the 75th percentile was negatively associated with neurodevelopment scores at age two years, including worse overall neurodevelopment (13=−7.03, p=0.009) and cognitive (13=−8.19, p=0.01), and language quotients (13=−6.81, p=0.01). One large study of 397 children with ASD and 1034 controls found that maternal blood levels in the highest quartile were associated with an increased risk of ASD (OR=1.84) (CI: 1.30, 2.59). Overall, it appears that low levels or unusually high levels of manganese are a problem for fetal growth, neurodevelopment, and psychomotor development.

### Intake

Based on the Total Diet Study, the average intake of manganese was 2.3 mg/day for women age 19-34, which was slightly more than the RDA recommendation of 2.0 mg for pregnant women. The Tolerable Upper Limit is 11 mg/day.

### Recommendation

For U.S. women, the inventors recommend that prenatal supplements contain approximately 1 mg of manganese, although more research is needed to improve this recommendation. When iron is supplemented, manganese absorption will decrease; therefore, manganese supplementation is more likely to be needed. This recommendation appears likely to reduce the risk of low birth weight, fetal growth restriction, and possibly preterm labor; moderate levels of manganese are associated with improved mental and psychomotor development.

Comparison with Commercial Prenatals

Manganese is included in 40% of prenatal supplements; when included, the median level is 2.0 mg (Q1: 2.0/Q2: 3.9). Thirty-eight percent of prenatal supplements on the market meet or exceed our recommendation for manganese.

### Example 28. Optimal Prenatal Vitamin/Mineral Supplement for Women in the US: Molybdenum

### Research

Molybdenum is an essential co-factor for three enzymes. Molybdenum deficiency is rare, but one study found that about 38% of children with autism often needed 50 i.g molybdenum to normalize activity of one of the enzymes to improve sulfation. There is almost no data on the optimal level of molybdenum supplementation during pregnancy. One study found an association between above-average levels of molybdenum with slightly worse psychomotor development in infants, but that was likely due to exposure to toxic forms of molybdenum and not the forms found in food.

### Intake

The Total Diet Study estimated daily intake of 76 i.g/day for women, which was more than the RDA recommendation of 50 i.g/day for pregnant women. The Tolerable Upper Limit for pregnant women is 2000 i.g.

### Recommendation

The inventors recommend 25 i.g/day to prevent molybdenum deficiency in women with low dietary intake.

Comparison with Commercial Prenatals

Molybdenum is included in 29% of prenatal supplements; when included, the median level is 25 i.g (Q1: 50/Q3: 75). Twenty-eight percent of prenatal supplements on the market meet or exceed this recommendation.

### Example 29. Optimal Prenatal Vitamin/Mineral Supplement for Women in the US: Selenium

### Research

Selenium has many functions in the body, primarily as selenocysteine-containing proteins (selenoproteins). Selenium supplementation has been shown to reduce hypothyroidism, pregnancy-induced hypertension, and preeclampsia, as well as postpartum depression, in pregnant women. It has been found that selenium stores in the body are depleted throughout pregnancy, with most depletion occurring at the end of pregnancy. A meta-analysis of 7 studies found that serum selenium levels were lower in women with gestational diabetes mellitus (GDM) than those with standard glucose tolerance, especially in Asia, but not in Europe. A review of selenium status and adverse pregnancy outcomes found that low selenium was possibly associated with miscarriages (2 studies, and mixed results for a 3rd), neural tube defects (3 of 4 studies), low birth weight (5 of 8 studies), intrauterine growth restriction (1 of 3 studies), congenital diaphragmatic hernia (1 large study), preeclampsia (3 of 6 studies), and abnormal glucose metabolism and gestational diabetes (3 studies). One study found that low selenium levels during pregnancy were associated with a higher risk of infection during the first 6 weeks of life and a worse psychomotor score at 6 months. Selenium supplementation in mothers results in a higher selenium status in their infants.

A study of 230 women in the UK found that 60 i.g/day of selenium was enough to prevent a decrease of selenium levels, improve the primary biomarkers of selenium status, and significantly reduce the odds of having either preeclampsia or PIH (65% reduction, p=0.04). A randomized trial of 169 women compared 100 i.g/day of selenome-thionine with placebo, and no significant differences were seen for either preeclampsia or preterm birth, although the study was probably too small to detect significant differences. In women at risk of pregnancy-induced hypertension, a dose of 100 i.g during the last 6-8 weeks of pregnancy significantly reduced the risk of pregnancy-induced hypertension (8% vs. 23%, p<0.05) and gestational edema (15% vs. 33%, p<0.05) and cured existing gestational edema in 88% of 26 cases vs. 1 out of 13 cases in the placebo group, p<0.0001. A RCT of supplementation of 200 i.g/day of selenium for 6 weeks in 70 women with gestational diabetes found significant improvements in fasting glucose, serum insulin, C-reactive protein, and oxidative stress.

Selenium has also been shown to treat postpartum depression when taken at levels of 100 i.g/day. In women at high risk of postpartum thyroid deficiency, supplementation with 200 i.g/day greatly reduced the rate of postpartum thyroid deficiency (29% vs. 49%, p<0.01) and permanent hypothyroidism (12% vs. 20%, p<0.01).

### Intake

The NHANES study found that from 2017 to 2018, the average daily intake (not including supplements) of selenium of U.S. women aged 20-39 was 97 i.g/day, which was more than the RDA recommendation of 60 ptg/day of selenium for pregnant women. The Tolerable Upper Limit is 400 ptg/day.

### Recommendation

Because selenium levels decrease during pregnancy and because one study found 60 ptg/day was sufficient to prevent that decrease, the inventors recommend 60 ptg/day, preferably as selenomethionine. For women with gestational edema or pregnancy-induced hypertension, 100 mg is recommended. For women at risk of postpartum thyroid deficiency, 200 ptg/day or higher is recommended. This recommendation appears likely to reduce the risk of postpartum depression, gestational diabetes, pregnancy-induced hypertension/preeclampsia, and postpartum thyroid deficiency as well as possibly neural tube defects, miscarriages, intrauterine growth restriction, and hernias.

Comparison with Commercial Prenatals

Selenium is included in 40% of prenatal supplements: when included, the median level is 70 ptg (Q1: 35/Q3: 70). Twenty-four percent of prenatal supplements meet or exceed our recommendation.

### Example 30. Optimal Prenatal Vitamin/Mineral Supplement for Women in the US: Zinc

### Research

Zinc has many roles in the body, including immune function, growth and development, nerve function, vision, and fertility. Zinc is recommended for reducing the risk of preeclampsia in pregnant women and reducing the risk of preterm birth as well as asthma in infants. Zinc absorption increases during late pregnancy and early lactation, but most studies suggest serum zinc levels decrease somewhat throughout pregnancy, although one study in China found a small increase in levels. By the end of pregnancy, levels were significantly lower in comparison to healthy, non-pregnant controls in most countries (20% lower in Turkey, 38% lower in Korea, 38% lower in U.S., but 10% higher in China—in China, zinc levels were much higher than in other countries.

Two meta-analyses, both including 14 studies, confirmed low serum zinc levels were associated with PIH and preeclampsia.

A meta-analysis of 32 studies of maternal dietary intake found that higher maternal intake of zinc was associated with a lower probability of wheeze (OR=0.62, 95% CI=0.40-0.97) during childhood (but not necessarily asthma). Zinc levels in mothers were negatively correlated with asthma in their children at the age of five.

A study of 450 pregnancies included an evaluation of 12 biomarkers of nutritional status and found that zinc levels in the lowest quartile had the strongest association with total occurrence of fetal and maternal health complications and the specific symptom of fetal distress.

One study of 279 pregnant women found that plasma zinc levels at delivery below the median level were associated with “mild toxemia (5.6% vs. 0.7%, p=0.02), vaginitis (13% vs. 4.4%, p=0.01), and postdates (4.2% vs. 0%, p=0.01) in the antenatal period. During the intrapartum period, low plasma zinc levels were associated with a prolonged latent phase (2.8% vs. 0%, p=0.05), a protracted active phase (29% vs. 18%, p=0.04), labor greater than 20 h (6.3% vs. 1.5%, p=0.03), second stage greater than 2.5 h (6.3% vs. 0.7%, p=0.01), and cervical and vaginal lacerations (7.0% vs. 1.5%, p=0.02)”. No such association was found with red blood cell zinc, suggesting that plasma zinc was a better biomarker.

Regarding supplementation effects, one study in the U.S. with women with initial plasma zinc levels below the median value found that by comparing levels at the beginning and the end of pregnancy, zinc levels had decreased by 11% in the un-supplemented group vs. only 7% in a group receiving 25 mg/day of zinc sulfate. One U.S. study of healthy, middle-income Caucasians found plasma zinc levels decreased during pregnancy, and supplementation averaging 11 mg/day of zinc sulfate had little effect on plasma levels but did increase hair and possibly saliva levels. One study of U.S. Hispanic women found that serum zinc declined during the first trimester, and that levels remained similarly low in those taking or not taking 20 mg/day of zinc acetate, although there was a significant decrease in the percent with deficient levels (20% decreased to 10%, p<0.05) in the treatment group and not in the unsupplemented group. In another U.S. study, 138 low-income Hispanic teenagers were randomized to a vitamin/mineral supplement with or without 20 mg of zinc sulfate. Serum zinc levels decreased 14% in the non-supplemented group vs. 8% in the supplemented group from about the 17th week to week 31-36 of pregnancy. Zinc supplementation reduced (p=0.018) the number of low serum zinc values (less than or equal to 53 micrograms/dl) in late pregnancy. Zinc supplementation did not affect the outcome of pregnancy, but serum zinc levels were lower (p=0.038) in teenagers with pregnancy-induced hypertension than in normotensives.

A meta-analysis of 16 randomized, controlled trials found that zinc supplementation resulted in a 14% reduction in preterm birth (RR=0.86, CI=0.76 to 0.97), but no other significant benefits were found; most of the studies used 20-30 mg of zinc, with most studies using zinc sulfate. Similarly, another meta-analysis of 12 studies found that zinc supplementation did not affect low birthweight or pre-eclampsia/eclampsia.

Daily zinc supplementation of 25 mg/day zinc sulfate in women with relatively low plasma zinc concentrations in early pregnancy was associated with greater infant birth weights and head circumferences; however, zinc supplementation did not affect test scores of neurologic development. In another study, mothers were supplemented with 30 mg/day, which resulted in a 54% reduction in the chance of their infant having impetigo, a bacterial skin infection which affects about 162 million children worldwide.

One study compared doses of 0, 5, 10, and 30 mg of zinc lactate. The results demonstrated that the doses of 5 and 10 mg had no benefit, but the 30 mg/day dose resulted in great improvements in the incidence of low birth weight, preterm birth, and intrauterine growth retardation. There was also improvement in birth weight, head circumference, duration of gestation, and Apgar scores. Serum zinc decreased in the group receiving placebo, 5, or 10 mg, but 30 mg of zinc lactate was enough to slightly increase zinc levels. More research is needed, but this study suggests that zinc lactate may be more beneficial than other forms of zinc.

Zinc sulfate was most commonly used and likely beneficial at preventing preterm birth: limited data suggest that zinc lactate and zinc gluconate are also beneficial. Two studies suggest that zinc acetate is not beneficial.

Overall, it appeared that 30 mg/day of zinc lactate was enough to stabilize zinc levels; there was only a partial benefit of 20 mg/day of zinc sulfate or 25 mg/day of zinc sulfate; there was little effect of 11 mg/day of zinc sulfate or 20 mg/day of zinc acetate on zinc levels.

### Intake

The NHANES study found that from 2017 to 2018, the average daily dietary intake (not including supplements) of zinc of U.S. women aged 20-39 was 9.4 mg/day, which was somewhat less than the RDA recommendation of 11 mg/day for pregnant women. The Tolerable Upper Limit is 40 mg/day.

### Recommendation

Therefore, for U.S. women, the inventors recommend that prenatal supplements contain at least 30 mg of zinc, but further research may suggest that higher levels are beneficial. This recommendation appears likely to reduce the risk of preterm birth and may reduce the risk of impetigo, asthma, and preeclampsia. The inventors recommend using zinc sulfate, zinc gluconate, or zinc lactate but avoiding zinc acetate. One study suggests that zinc lactate may be especially beneficial, but more research is required for verification.

Comparison with Commercial Prenatals

Zinc is included in 89% of prenatal supplements; when included, the median level is 15.0 mg (Q1: 11.0/Q3: 20.0). No prenatal supplement on the market meets or exceeds the inventors' recommendation.

### Example 31. Optimal Prenatal Vitamin/Mineral Supplement for Women in the US

Table 11 lists the inventors' recommendations for the optimal level of each vitamin/nutrient for prenatal supplements, and compares with the RDA, the NHANES average daily intake for women ages 20-39 years in the US, the tolerable upper limit, and which vitamins/nutrients decrease during pregnancy. Comparing the RDA and NHANES show that average daily intake of Vitamin D, Choline and DHA are far below the RDA. Note that the NHANES values are averages, therefore the actual values of intake for many women are less.

The inventors' analysis of available information indicates that in some cases the RDA is too low, and that higher levels of intake are required to reduce the risk of pregnancy complications and infant health problems. The blood levels of most vitamins decrease substantially during pregnancy, so supplementation is needed. The recommendations in Table 12 (49, 50) appear likely to substantially reduce the many pregnancy complications and infant health problems listed in Tables 8-11.

TABLE 12
RDA Recommendations & Daily Vitamin Intake.

| | | | | | Daily Intake | | | | |
|---|---|---|---|---|---|---|---|---|---|
| | | | RDA | | (Women | | | | |
| | | | Recommendation | | aged 20-39) | | Tolerable | | Decreases |
| | | | for Total Daily | | per NHANES | | Upper Limit | | significantly |
| | | | Intake for | | unless | | for | | during |
| | Daily | | Pregnant | | otherwise | | Pregnant | | pregnancy if |
| Nutrient | Recommendation | | Women | | noted | | Women | | unsupplemented |
| Vitamin A | 1200 mcg of | | 770 | mcg | 596 | mcg | 3000 | mcg | yes |
| | preformed | | | | | | | | |
| | vitamin A & | | | | | | | | |
| | 1000 mcg as | | | | | | | | |
| | mixed | | | | | | | | |
| | carotenoids | | | | | | | | |
| Vitamin C | 200 | mg | 85 | mg | 78 | mg | 2000 | mg | yes |
| Vitamin D | 2000 | IU | 600 | IU | 156 | IU | 4000 | IU | yes |
| Vitamin E | 19 | mg | 15 | mg | 7 | mg | 1000 | mg | unknown |
| Vitamin K | 90 | mcg | 111 | mcg | 90 | mcg | * | | unknown |
| DHA | 600 | mg | No RDA; NIH | | 62 | mg | * | | Increases, but |
| | | | recommends | | | | | | ratio of n-3 to |
| | | | 300 | mg* | | | | | n-6 decreases |
| Vitamin B1 | 6 | mg | 1.4 | mg | 1.5 | mg | * | | yes |
| (Thiamine) | | | | | | | | | |
| Vitamin B2 | 2 | mg | 1.4 | mg | 1.9 | mg | * | | no |
| (Riboflavin) | | | | | | | | | |
| Vitamin B3 | 35 | mg | 18 | mg | 23 | mg | * | | yes |
| (Niacin) | | | | | | | | | |
| Vitamin B5 | 10 | mg | 6 | mg | 4 | mg | * | | yes |
| (Pantothenic | | | | | | | | | |
| Acid) | | | | | | | | | |
| Vitamin B6 | 10 | mg | 1.9 | mg | 1.9 | mg | 100 | mg | yes |
| (Pyridoxine) | | | | | | | | | |
| Vitamin B7 | 100 | mcg | 30 | mcg | 40 | mcg* | * | | yes |
| (Biotin) | | | | | | | | | |
| Vitamin B9 | 400 | mcg | 600 | mcg | 527 | mcg | 1000 | mcg | yes |
| (Folate) | | | | | | | | | |
| Vitamin B12 | 25 | mcg | 4.54 | mcg | 2.6 | mcg | * | | yes |
| Choline | Trimester 1 | | 450 | mg | 276 | mg | 3500 | mg/day | Increased |
| | and 2: | | | | | | | | need during |
| | 350 mg. | | | | | | | | third trimester |
| | Trimester 3: | | | | | | | | |
| | 600 | mg | | | | | | | |

| | | | | | | | |
|---|---|---|---|---|---|---|---|
| Inositol | 500 | mg | — | 2000 | mg | — | unknown |

* Safe at high levels; Tolerable Upper Limit Not Established

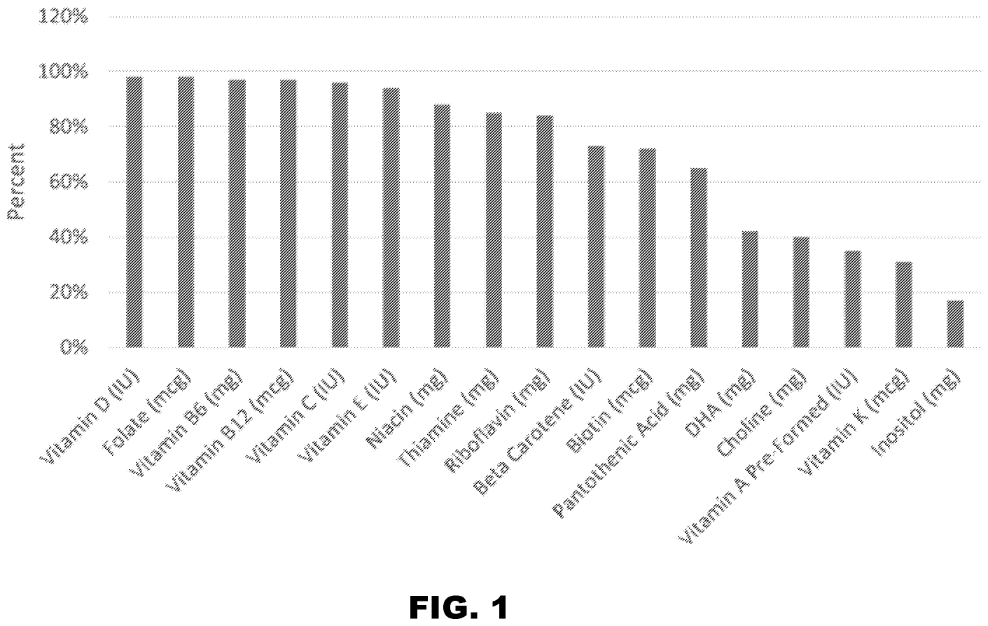

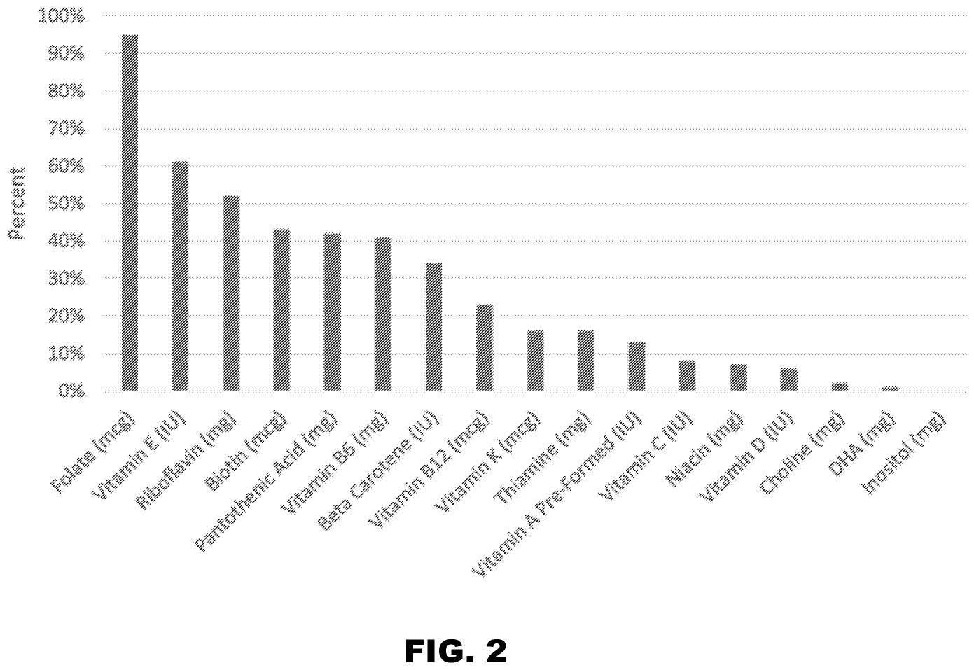

Table 13 is a comparison of the levels of vitamins in prenatal supplements on the market compared to our evidence-based recommendations. The “average level of all supplements” is the average amount of the vitamin/nutrient, averaging across all supplements. The “average of those with the nutrient” is an average of only the supplements which contain some of that nutrient. FIG. 1 shows the % of prenatal supplements that include some amount of the nutrient, even if the level is minimal. As shown in Table 13 as well as FIG. 1, almost all prenatal supplements currently on the market include folate, while most contain vitamins E, B6, B12, beta carotene, pantothenic acid, biotin and riboflavin and some contain vitamins K, A, C, thiamine, choline, DHA, and inositol. While the majority of prenatal supplements contain all or some of the nutrients recommended, many do not meet the inventors recommendations. Almost all prenatals meet or exceed the inventor recommendations for folate (although levels above 600 mg may increase the risk of food allergies and autism). However, as shown in FIG. 2, the levels of most other vitamins are well below the inventors recommendations. Specifically, only 61% meet the inventors' recommendations for vitamin E, 52% meet the inventors' recommendations for riboflavin, 43% meet our recommendation for riboflavin, 42% meet the inventors' recommendations for pantothenic acid, 41% meet the inventors' recommendations for vitamin B6, 34% meet the inventors' recommendation for beta carotene, and less than 25% meet the inventors' recommendations for vitamins A (preformed), C, D, K, thiamine, niacin, B12, choline, DHA, inositol. So, most prenatals provide vitamins at levels well below the inventors' recommendations. The inventors' analysis strongly indicates that vitamin supplementation at the levels recommend by the inventors is likely to significantly reduce the risk of many of the pregnancy and infant health conditions listed in Tables 8 and 9.

TABLE 13
Comparison of Prenatal Supplements on Market vs. Inventors recommendations

| | | | | | | | % of the | |
|---|---|---|---|---|---|---|---|---|
| | | | | | | | average of | |
| | | | | | | % of the | supplements | |
| | | | | | Average | average of all | with the | |
| | | Supplements | % Meeting or | | of only | supplements | nutrient | |
| | | with this | exceeding | Average | those | divided by | divided by | |
| | Inventors | nutrient | inventors' | level of all | with the | Inventors | Inventors | |
| Nutrients | recommendation | (out of 188) | recommendation | supplements | nutrient | recommendation | recommendation | Range |
| Vitamin A | 4000 | 35% (66) | 13% (25) | 1014.3 +/− | 2889.14 +/− | 25% | 72% | 0-8000 |
| Pre-Formed | | | | 1660.2 | 1546.9 | | | |
| (IU) | | | | | | | | |
| Beta | 3333 | 73% (137) | 34% (64) | 2408.2 +/− | 3304.7 | 72% | 99% | 0-10000 |
| Carotene | | | | 2311.6 | +/− | | | |
| (IU) | | | | | 2081.0 | | | |
| Vitamin C | 200 | 96% (181) | 8% (15) | 108.8 +/− | 113.0 +/− | 54% | 57% | 0-1000 |
| (IU) | | | | 105.1 | 104.6 | | | |
| Vitamin D | 2000 | 98% (184) | 6% (12) | 708.6 +/− | 724.0 +/− | 35% | 36% | 0-4200 |
| (IU) | | | | 545.7 | 539.9 | | | |
| Vitamin E | 28.5 | 94% (176) | 61% (114) | 40.5 +/− | 43.27 +/− | 142% | 152% | 0-200 |
| (IU) | | | | 47.6 | 47.8 | | | |
| Vitamin K | 90 | 31% (58) | 16% (31) | 23.5 +/− | 76.2 +/− | 26% | 85% | 0-200 |
| (mcg) | | | | 40.0 | 33.7 | | | |
| Thiamine | 6 | 85% (159) | 16% (30) | 4.1 +/− | 4.8 +/− | 68% | 81% | 0-50 |
| (mg) | | | | 3.9 | 7.2 | | | |
| Riboflavin | 2 | 84% (158) | 52% (98) | 4.3 +/− | 5.2 +/− | 216% | 257% | 0-50 |
| (mg) | | | | 6.7 | 7.0 | | | |
| Niacin (mg) | 35 | 88% (166) | 7% (13) | 19.6 +/− | 22.1 +/− | 56% | 63% | 0-100 |
| | | | | 12.1 | 10.4 | | | |
| Pantothenic | 10 | 65% (123) | 42% (79) | 11.7 +/− | 17.8 +/− | 117% | 178% | 0-150 |
| Acid (mg) | | | | 23.0 | 26.4 | | | |
| Vitamin B6 | 10 | 97% (182) | 41% (78) | 10.8 +/− | 11.2 +/− | 108% | 112% | 0-50 |
| (mg) | | | | 12.2 | 12.1 | | | |
| Biotin (mcg) | 100 | 72% (136) | 43% (81) | 165.2 +/− | 228.4 +/− | 165% | 228% | 0-3000 |
| | | | | 275.4 | 299.8 | | | |
| Folate | 400 | 98% (184) | 95% (179) | 854.5 +/− | 873.1 +/− | 214% | 218% | 0-2000 |
| (mcg) | | | | 295.6 | 269.4 | | | |
| Vitamin B12 | 25 | 97% (182) | 23% (43) | 34.5 +/− | 35.6 +/− | 138% | 142% | 0-800 |
| (mcg) | | | | 84.8 | 85.8 | | | |
| Choline | 350 | 40% (75) | 2% (3) | 25.7 +/− | 64.3 +/− | 7% | 18% | 0-550 |
| (mg) | | | | 71.4 | 101.2 | | | |
| DHA (mg) | 600 | 42% (79) | 1% (2) | 94.2 +/− | 224.1 +/− | 16% | 37% | 0-1000 |
| | | | | 150.4 | 156.4 | | | |
| Inositol | 500 | 17% (32) | 0% (0) | 4.5 +/− | 26.5 +/− | 1% | 5% | 0-150 |
| (mg) | | | | 19.7 | 41.2 | | | |

### Example 32. Optimal Prenatal Vitamin/Mineral Supplement for Women: Health Outcome and Mineral Status

Essential minerals are vital for human health, and during pregnancy, they are even more critical to support maternal health and infant development. If not supplemented, the levels of many essential minerals decrease during pregnancy, including calcium, iron, magnesium, selenium, zinc, and possibly chromium and iodine. Low levels of minerals are associated with a wide range of maternal and infant health problems that occur in the U.S. and worldwide, and appropriate supplementation can reduce the risk of many maternal and infant health complications.

### Associations Between Health Outcomes and Mineral Status

Tables 14 and 15 summarize the associations between health outcomes (maternal and infant, respectively) and mineral status. The associations are listed as “significant” if there are two or more statistically significant studies in support of the association and a ratio of 2:1 or higher of positive to null studies. Associations are listed as “possible” if there is at least one study with a statistically significant association, and the ratio of positive to negative studies is greater than or equal to 1:1. In cases where meta-analyses were performed, the results of the meta-analysis were counted as “significant” evidence if the results were statistically significant. In general, Tables 14 and 15 indicate that many maternal and infant health complications are associated with one or more minerals.

Table 15 demonstrates the significance of a mineral in conditions that can affect an infant. Substantial nutritional interference is regarding minerals that have two or more research articles that support the correlation, while possible nutritional interference only has one supporting research article.

Tables 16 and 17 list the same data as in Tables 14 and 15, but organized by minerals; i.e., Tables 16 and 17 list associations between maternal mineral status and maternal and infant health complications, respectively. Overall, it is clear that each mineral is linked to one or more maternal and infant health complications, with the possible exception of molybdenum, which has not been well-researched.

Table 18 lists the inventors' recommendations for prenatal supplements and also lists the RDA, the average daily intake for women ages 20-39 years in the U.S. based only on food/beverages (does not include intake from nutritional supplements), the Tolerable Upper Limit, and if the mineral levels decrease during pregnancy. Comparing the NHANES with the RDA shows that average daily intake of iron, iodine, and magnesium in the U.S. are well below the RDA. Also, it is important to realize that the NHANES values are averages, and some women consume less. So, the inventors' recommendations for a general prenatal supplement are intended to help all women achieve at least the RDA without providing an excessive amount that would approach the Tolerable Upper Limit. In addition, levels of many minerals decrease significantly during pregnancy without supplementation, and some of the research examined by the inventors suggests that the RDA may be too low for several minerals in pregnant women, and that higher levels of supplementation may provide improved health outcomes for mother and/or child.

TABLE 14
Relationship of maternal health complications to mineral status.

| Maternal Outcome | Significant Evidence | Limited Evidence |
|---|---|---|
| Anemia | Iron | |
| Anxiety | | Copper |
| Blighted Ovum | | Copper |
| Depression | | Copper |
| Edema | | Magnesium |
| | | Selenium |
| Fertility (for women with Polycystic | | Chromium |
| Ovary Syndrome) | | |
| Gestational Diabetes | Chromium | Selenium |
| Gestational Hypertension | Calcium | |
| | Magnesium | |
| | Selenium 124 130 | |
| | Zinc 7M, 141M | |
| Hypothyroidism | Selenium | Selenium |
| | Iodine | |
| Infection | | Selenium |
| Leg Cramps | | Magnesium |
| Maternal Death/Serious Morbidity | | Calcium |
| Maternal Hospitalization | Magnesium | |
| Miscarriage | Copper | |
| | Selenium 128 R | |
| Postpartum Depression | | Chromium |
| | | Selenium |
| Preeclampsia | Calcium 3, 8 r 10 11 14 17 | Iodine |
| | Copper 36M, 37M | Manganese (high levels are a |
| | Magnesium 95 97 | problem |
| | Selenium 124 128 130 | |
| | Zinc 7M, 141M | |
| Premature Rupture of Membranes | | Copper |
| (PROM) | | |

TABLE 15
Relationship of infant health problems to maternal mineral status

| | Significant | |
|---|---|---|
| Infant Outcome | Evidence | Limited Evidence |
| ADD | | Iodine |
| ADHD | Iodine | |
| Anemia | Iron | |
| Anencephaly | | Copper |
| | | Iron |
| Apgar Score | Magnesium | Zinc |
| Asthma | | Zinc |
| Autism | Calcium | Iron |
| | Iodine | Molybdenum |
| Birth Weight | Magnesium | Calcium |
| | Manganese | Selenium |
| | | Zinc |
| Central Nervous | | Copper |
| System (CNS) | | |
| Malformations | | |
| Cerebral Palsy | Magnesium | |
| Congenital | | Selenium |
| Diaphragmatic | | |
| Hernia | | |
| Dental Cavities | | Calcium |
| Fetal Distress | | Zinc |
| Fetal Growth | | Magnesium |
| Restriction | | |
| High Blood | | Calcium |
| Pressure | | |
| Hypothyroidism | Iodine | |
| Impetigo | | |
| Infant Mortality | | |
| Intellectual | Iodine | |
| Disability | Manganese | |
| Intrauterine Growth | | |
| Restriction | | |
| Long Delivery | | |
| Neonatal Intensive | | |
| Care Unit | | |
| Admissions | | |
| Neural Tube | | |
| Defects | | |
| Orofacial Cleft | | |

TABLE 16
Relationship of minerals to maternal health problems/benefits

| Mineral | Significant Evidence | Limited Evidence |
|---|---|---|
| Calcium | Gestational Hypertension | |
| | Maternal Death | |
| | Preeclampsia | |
| | Pregnancy Induced | |
| | Hypertension | |
| Chromium | Gestational Diabetes | Postpartum |
| | | Depression |
| | | Fertility in Women with |
| | | Polycystic Ovary |
| | | Syndrome |
| Copper | Miscarriages | Anxiety |
| | Preeclampsia | Depression |
| | | PROM |
| Iodine | Hypothyroidism | Preeclampsia |
| Iron | Anemia 77 78 83-85 87 | |
| | 89 | |
| Magnesium | Gestational Hypertension | Leg Cramps |
| | Maternal Hospitalization | |
| | Preeclampsia | |
| Manganese | | Preeclampsia (high |
| | | levels are a problem) |
| Molybdenum | | |
| Selenium | Miscarriage | Gestational Diabetes |
| | Preeclampsia | Hypothyroidism |
| | Gestational Hypertension | |
| Mineral | Significant Evidence | Limited Evidence |
| | | Postpartum Thyroid |
| | | Deficiency |
| Zinc | Preeclampsia | |
| | Gestational Hypertension | |

TABLE 17
Relationship of maternal mineral status
to infant health problems/benefits

| Mineral | Significant Evidence | Limited Evidence |
|---|---|---|
| Calcium | Autism | High Blood Pressure |
| | Preterm Birth | Dental Cavities |
| | Rickets | Low Birthweight |
| Chromium | | |
| Copper | | Anencephaly |
| | | CNS Malformations |
| Iodine | ADHD | Mortality |
| | Hypothyroidism | Stillbirth |
| | Intellectual Disability | |
| Iron | Anemia | Anencephaly |
| | | Autism |
| | | Orofacial Cleft |
| Magnesium | Apgar Score | Orofacial Cleft |
| | Birth Weight | |
| | Cerebral Palsy | |
| | Preterm Birth | |
| Manganese | Birth Weight | Preterm Birth |
| | Intellectual Disability | |
| Selenium | Neural Tube Defects | Birthweight |
| | | Congenital |
| | | Diaphragmatic Hernia |
| | | Intellectual Disability |
| | | Intrauterine Growth |
| | | Restriction |
| Zinc | Preterm Birth | Apgar Score |
| | Wheeze | Birth Weight |
| | | Duration of Gestation |
| | | Impetigo |
| | | Asthma |

TABLE 18
Recommendations for content of prenatal supplements and other relevant data for comparison.

| | | | RDA | | Daily Intake | | | | |
|---|---|---|---|---|---|---|---|---|---|
| | | | Recommendation | | (Women Aged [symbol] -39) | | | | |
| | | | for Total Daily | | per NHANES | | Tolerable Upper | | |
| | Our | | Intake for Pregnant | | Unless Otherwise | | Limit for Pregnant | | Change during |
| Nutrient | Recommendation | | Women | | Noted | | Women | | Pregnancy |
| Calcium | 550 mg (1000 mg for | | 1000 | mg | 872 | mg | [symbol] | mg | Decreases |
| | [symbol] ) | | | | | | | | |
| Chromium | 100 mg (200 mg for | | 30 | μg | [symbol] to 29 | μg | — | | Possibly decreases |
| | women with | | | | | | | | |
| | diabetes) | | | | | | | | |
| Copper | 1.3 | mg | 1 | mg | [symbol] | mg | 10 | mg | Levels increase, but |
| | | | | | | | | | low levels associated |
| | | | | | | | | | with health complications. |
| Iodine | 150 | μg/day | 220 | μg | 160 | μg [symbol] | [symbol] | μg | Possibly decreases |
| Iron | 30 mg 1st trimester | | [symbol] | mg | 122.2 | mg | [symbol] | mg | Decreases |
| | 60 mg 2nd trimester | | | | | | | | |
| | and 3rd trimester; up | | | | | | | | |
| | to [symbol] mg [symbol] day in | | | | | | | | |
| | extreme cases | | | | | | | | |
| Magnesium | [symbol] | mg | [symbol] | mg | [symbol] | mg | [symbol] | mg | Decreases |
| Manganese | 1 | mg | 2.0 | mg | 2.3 | mg | 11 | mg | Increases, but how |
| | | | | | | | | | levels are associated |
| | | | | | | | | | with health |
| | | | | | | | | | complications |
| Molybdenum | 25 | μg | 50 | μg | 76 | μg | 2000 | μg | Unknown |

| | | | | | | | |
|---|---|---|---|---|---|---|---|
| Selenium | 80 | μg | 70 | μg | [symbol] | [symbol] | Decreases |

| | | | | | |
|---|---|---|---|---|---|
| Zinc | [symbol] | [symbol] | [symbol] | [symbol] | Decreases |

[symbol]

Intake based on NHANES study which evaluated wpmen aged 15-44 years. RDA: Recommended Dietary Allowance. [symbol]
indicates data missing or illegible when filed

Low levels of essential minerals can affect many pregnancy and infant health complications, as shown in Tables 14-17, and many of these conditions are common in the U.S. The supplement recommendations made in the present disclosure (summarized in Table 15) are likely to significantly reduce many pregnancy complications and infant health problems.

It is important to note that nutritional needs are not static but can change as the pregnancy progresses. Levels of many minerals decrease significantly during pregnancy, including calcium, iron, magnesium, selenium, zinc, and possibly chromium and iodine. These substantial decreases during pregnancy are not all widely known, and strongly argue for increased supplementation of those minerals. For example, many women start their pregnancy with low iron levels, and iron levels decrease further during pregnancy, especially mid-trimester, because of the production of new red blood cells for placenta and fetus. Although iodine levels appear to be stable during pregnancy, low levels of iodine are common in the U.S., so iodine supplementation is also important.

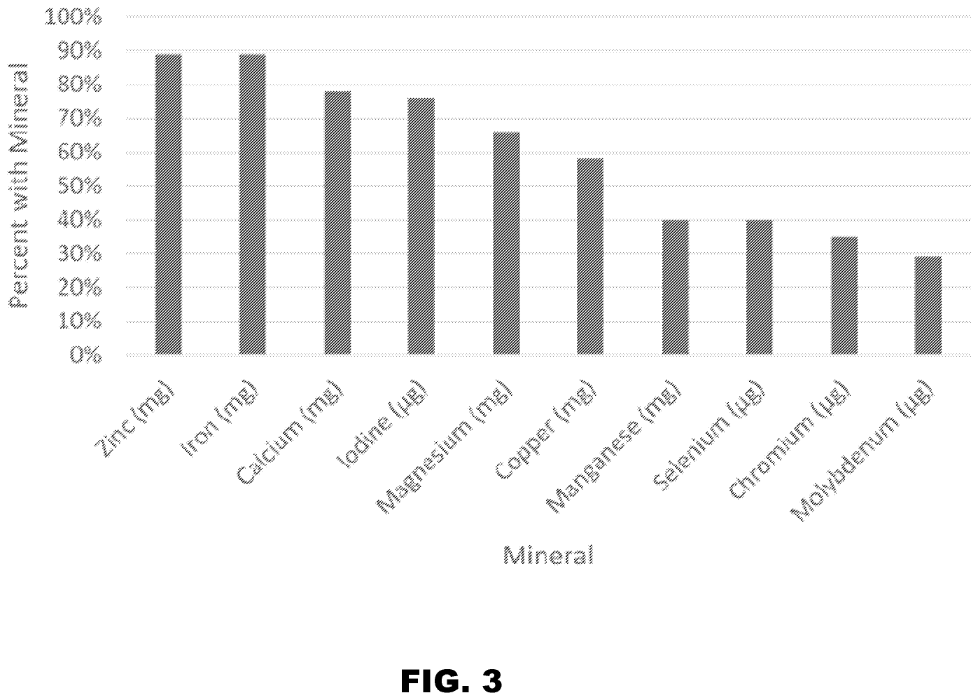

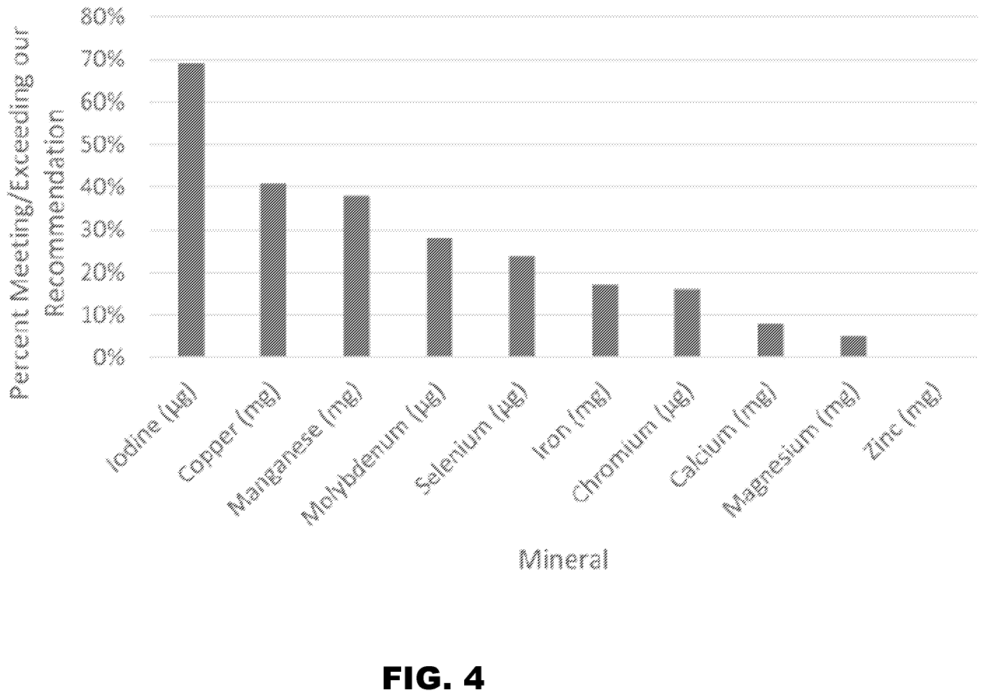

Table 18 reports the mineral content of 188 prenatal supplements and a comparison against the inventors' recommendations. As shown in FIG. 3, the rates of inclusion of each mineral in prenatal supplements were iron (89%), zinc (89%), calcium (78%), iodine (76%), magnesium (66%), copper (58%), manganese (40%), selenium (40%), chromium (35%), and molybdenum (29%). So, although most supplements contained some iron, zinc, and calcium, other essential minerals were included at a lower frequency. When minerals were included in prenatals, the levels were usually below the inventors' recommended levels, especially for magnesium, calcium, and zinc, which were included at only 32%, 48%, and 50%, respectively, of the inventors' recommendations, if they were included. As shown in FIG. 4, although supplements may have included levels of minerals, most included dosages below the inventors' recommendations, especially for iron, chromium, magnesium, and zinc, wherein only 17%, 16%, 5%, and 0%, respectively, met the inventors' recommendations.

Therefore, analysis of 188 prenatal supplements found that few reached the levels recommended in the present invention. Overall, the largest differences between the inventors' recommendations and the amounts included in prenatals were for magnesium, chromium, and calcium, wherein the average in prenatals was only 21-37% of the inventors' recommendations.

The review of 188 prenatal supplements found that 44% involved only a single capsule/pill/tablet/softgel/gummie. Calcium and magnesium require larger amounts than other minerals, and it appears that manufacturers often limit the amount of those minerals in prenatal supplements so that fewer pills, or only a single pill, are required. Supplements of only 1 pill met only 37% of the inventors' recommendations when averaging over all pills, whereas supplements with 6-8 pills met 80% of the inventors' recommendations. It is estimated that approximately 8 pills, or 2-3 pills 3×/day, would be required to meet the inventors' recommendations for vitamins and minerals. This may seem like a large amount, but it is a tiny fraction of the volume of food consumed in a typical diet, and the potential benefits appear to be very high. Today, over 50% of pregnancies involve major complications, including miscarriage (15-20%), iron deficiency (28% by third trimester), and pre-term birth (10%); taking a few extra pills may result in a substantial decrease in those rates, and substantially improve the health of the mother and her baby.

### Example 33. Optimal Prenatal Vitamin/Mineral Supplement for Women in the US: Mineral Supplements

Many aspects of maternal and infant health can be improved by prenatal supplementation at appropriate levels. The present disclosure proposes a comprehensive set of recommendations for the optimal level of each mineral for a prenatal supplement based on the inventors' meta-analysis of available data. However, mineral content of prenatal supplements varies widely, and a review of 188 commercially available prenatal supplements found that they often included only a subset of minerals, and at relatively low levels, so that only a small fraction of supplements satisfied the levels determined as optimal by the inventors. Thus, the inventors believe that following the proposed recommendations for mineral supplementation, and use of supplements as disclosed herein will reduce the rate of many maternal and infant health complications.

### Example 34. Optimal Prenatal Vitamin/Mineral Supplement for Women: Limitations on Vitamin Recommendations

The present disclosure provides a general summary of important research on the optimal level of supplementation for each vitamin. There is a wide variation in nutritional intake among women in the US, and the recommendations here are for the general population. Women with especially poor diets or pre-existing health conditions may need additional or different supplementation. Women with very good diets and in good health may need less supplementation.

The current recommendations assume that no individualized testing of nutritional status is conducted. Individual assessments of dietary intake and biochemical measures of nutritional status could be used to tailor recommendations for an individual.

Prenatal supplements are intended to supplement, and not replace, a healthy diet. Healthy diets should be encouraged especially during pregnancy.

### Example 35. Optimal Prenatal Vitamin/Mineral Supplement for Women in the US: Conclusions for Supplementation

The levels of most vitamins decrease significantly during pregnancy, and low levels of vitamins are associated with a wide range of pregnancy and infant health complications. Therefore, vitamin supplementation is important during pregnancy to prevent a wide range of problems. Unfortunately, there is no national standard for the content of prenatal supplements, so they vary widely in their content, and many contain only a few vitamins. The present disclosure provides recommendations for the optimal level of multiple components combined in prenatal supplements to reduce the risk of a wide range of pregnancy and infant health problems.

### Example 36. Supplements for Pregnant and Lactating Women: Trimester One and Preconception

A series of prenatal supplements were developed using the inventors' meta-analysis of research study results for individual components, and formulated for an infant's developing brain, with the most bioavailable nutrients at levels customized by each trimester to uniquely support each developmental stage. About 40% of American women lack the gene MTHFR (Methylenetetrahydrofolatereductase) to metabolize and absorb folic acid. To solve this problem, the supplements used Calcium L-5-Methyltetrahydrofolate [5-MTHF] as the form of folic acid. The supplements also comprise other forms of bioavailable nutrients to facilitate digestion and to reduce stomach upset or nausea. The supplements were so formulated to minimize aftertaste and/or fishy smell. Some subjects also noticed an improvement in skin, nails and hair, and elevated general mood. The supplements were packaged into easy to swallow capsules and softgels.

A prenatal supplement for preconception and women in 1st trimester pregnancy comprised 27 essential and bioavailable vitamins, minerals, and DHA, at levels customized and optimized for first trimester development. The supplements were packaged into 2 cartons each containing 31 sachets. The sachet labeled as “Serving One” was recommended for daily morning use (see Table 19 for composition), which holds 3 vitamin capsules. The sachet labeled as “Serving Two” was recommended for daily evening use (see Table 20 for composition), which holds 3 vitamin capsules and 2 DHA soft gels. The “Serving One” sachet contain Vitamin A at or about 1600 mcg (5,333 IU); Vitamin C at or about 75 mg; Vitamin D3 at or about 25 mcg (1,000 IU); Vitamin E at or about 12.5 mg; Vitamin K at or about 45 mcg; Vitamin B1 at or about 3 mg; Vitamin B2 at or about 1 mg; Vitamin B3 at or about 15 mg; Vitamin B6 at or about 5 mg; Folate at or about 300 mcg DFE (176.5 mcg folic acid); Vitamin B12 at or about 9 mcg; Biotin at or about 50 mcg; Pantothenic Acid at or about 5 mg; Choline at or about 175 mg; Calcium at or about 162.5 mg; Iron at or about 15 mg; Iodine at or about 110 mcg; Magnesium at or about 90 mg; Zinc at or about 10 mg; Selenium at or about 25 mcg: Copper at or about 0.65 mg; Manganese at or about 0.5 mg; Chromium at or about 50 mcg; Molybdenum at or about 12.5 mcg; Potassium at or about 50 mg; and Inositol at or about 250 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, a nutritional supplement as disclosed herein is administered to women preconception, or to women in the first trimester of pregnancy. In one aspect, the nutritional supplement is to be administered in the morning to women preconception, or to women in the first trimester of pregnancy. The “Serving Two” sachet contain vitamin A at or about 1600 mcg (5.333 IU); Vitamin C at or about 75 mg; Vitamin D3 at or about 25 mcg (1,000 IU): Vitamin E at or about 12.5 mg; Vitamin K at or about 45 mcg; Vitamin B1 at or about 3 mg; Vitamin B2 at or about 1 mg; Vitamin B3 at or about 15 mg; Vitamin B6 at or about 5 mg; Folate at or about 300 mcg DFE (176.5 mcg folic acid); Vitamin B12 at or about 9 mcg; Biotin at or about 50 mcg; Pantothenic Acid at or about 5 mg; Choline at or about 175 mg; Calcium at or about 162.5 mg; Iron at or about 15 mg; Iodine at or about 110 mcg; Magnesium at or about 90 mg; Zinc at or about 10 mg; Selenium at or about 25 mcg; Copper at or about 0.65 mg; Manganese at or about 0.5 mg; Chromium at or about 50 mcg; Molybdenum at or about 12.5 mcg; Potassium at or about 50 mg; Fish Oil Concentrate at or about 1138 mg; Docosahexaenoic acid (DHA) at or about 500 mg; and Inositol at or about 250 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. In one aspect, the nutritional supplement is to be used on preconception women or pregnant women in the first trimester. In one aspect, the nutritional supplement is to be administered in the evening to women preconception, or to women in the first trimester of pregnancy.

### Example 37. Supplements for Pregnant and Lactation Woman: Trimester Two

A prenatal supplement for 2nd trimester was designed to support an infant's emerging senses of taste, smell, and hearing, and baby's synaptic connections between neurons. The supplement included 27 essential and bioavailable vitamins, minerals, and DHA, at levels customized and optimized for second trimester development. The supplements were packaged into 2 cartons each containing 31 sachets. The sachet labeled as “Serving One” was recommended for daily morning use (see Table 21 for composition), which holds 3 vitamin capsules. The sachet labeled as “Serving Two” was recommended for daily evening use (see Table 22 for composition), which holds 3 vitamin capsules and 2 DHA soft gels. The sachet “Serving One” contain Vitamin A at or about 1157 mcg (3,857 IU); Vitamin C at or about 75 mg; Vitamin D3 at or about 21.4 mcg (856 IU); Vitamin E at or about 8.57 mg; Vitamin K at or about 38.6 mcg: Vitamin B1 at or about 2.57 mg; Vitamin B2 at or about 0.86 mg; Vitamin B3 at or about 15 mg; Vitamin B6 at or about 4.29 mg; Folate at or about 257 mcg DFE (151.3 mcg folic acid); Vitamin B12 at or about 10.3 mcg; Biotin at or about 42.9 mcg; Pantothenic Acid at or about 4.29 mg; Choline at or about 150 mg; Calcium at or about 182.14 mg; Iron at or about 19.29 mg; Iodine at or about 94.3 mcg; Magnesium at or about 111.43 mg; Zinc at or about 10.71 mg; Selenium at or about 25.7 mcg; Copper at or about 0.51 mg; Manganese at or about 0.43 mg; Chromium at or about 42.9 mcg; Molybdenum at or about 10.7 mcg; Potassium at or about 42.86 mg; and Inositol at or about 214 mg. In yet another aspect, a nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. The sachet may be administered in the morning to women in the second trimester of pregnancy. The sachet “Serving Two” contains Vitamin A at or about 1543 mcg (5143 IU); Vitamin C at or about 100 mg; Vitamin D3 at or about 28.6 mcg (1,144 IU); Vitamin E at or about 11.43 mg; Vitamin K at or about 51.4 mcg; Vitamin B1 at or about 3.43 mg; Vitamin B2 at or about 1.14 mg; Vitamin B3 at or about 20 mg; Vitamin B6 at or about 5.71 mg; Folate at or about 343 mcg DFE (201.7 mcg folic acid); Vitamin B12 at or about 13.7 mcg; Biotin at or about 57.1 mcg; Pantothenic Acid at or about 5.71 mg; Choline at or about 200 mg; Calcium at or about 242.86 mg; Iron at or about 25.71 mg; Iodine at or about 125.7 mcg; Magnesium at or about 148.57 mg; Zinc at or about 14.29 mg; Selenium at or about 34.3 mcg; Copper at or about 0.69 mg; Manganese at or about 0.57 mg; Chromium at or about 57.1 mcg; Molybdenum at or about 14.3 mcg; Potassium at or about 57.14 mg; Fish Oil Concentrate at or about 1138 mg; Docosahexaenoic acid (DHA) at or about 500 mg; and Inositol at or about 286 mg. In yet another aspect, the nutritional supplement may further comprise (a) MSM in the amount of about 50 to about 1000 mg; (b) n-acetylcysteine in the amount of about 20 mg to about 200 mg; and/or (c) lithium in the amount of about 20 mcg to about 1000 mcg. The sachet is to be administered to women in the second trimester of pregnancy, preferably in the evening.

TABLE 19
Prenatal Supplements for 1^{st} Trimester, Serving One
Supplement Facts
Serving Size 1 Packet (3 capsules)
Servings Per Container 31

| Amount | % DV for Pregnant | | |
|---|---|---|---|
| Per Serving | and Lactating Women | | |
| Vitamin A (as natural beta carotene and | 1600 mcg | | 123% |
| [symbol] ) | (5,333 IU) | | |
| Vitamin C (from calcium ascorbate) | 75 | mg | 63% |
| Vitamin D3 (as [symbol] ) | 25 mcg (1,000 IU) | | 167% |
| Vitamin E (as natural mixed tocopherols) | 12.5 | mg | 66% |
| Vitamin K (as [symbol] [Vitamin K1] | 45 | mcg | 50% |
| and [symbol] -7 [Vitamin K2]) | | | |
| Vitamin B1 (as thiamine hydrochloride) | 3 | mg | 214% |
| Vitamin B2 | 1 | mg | 63% |
| Vitamin B3 (as niacin and niacinamide) | 15 | mg | 83% |
| Vitamin [symbol] (as pyridoxine hydrochloride) | 5 | mg | 250% |
| Folate (as Calcium L-5- | 300 mcg DFE | | 50% |
| Methyltetrahydrofolate [5-MTHF]) | (176.5 mcg | | |
| (Magnafolate [symbol] C) | folic acid) | | |
| Vitamin B12 (as methyl [symbol] ) | 9 | mcg | [symbol] |
| Biotin | 50 | mcg | 143% |
| [symbol] Acid (as d-calcium | 5 | mg | 71% |
| [symbol] ) | | | |
| Choline (from choline bitartrate) | 175 | mg | 32% |
| Calcium (from calcium carbonate) | 162.5 | mg | 13% |
| Iron (from iron [symbol] ) | 15 | mg | 56% |
| Iodine (from potassium [symbol] ) | 110 | mcg | 38% |
| Magnesium (from magnesium | 90 | mg | 23% |
| [symbol] and magnesium malate) | | | |
| Zinc (from zinc sulfate and zinc amino | 10 | mg | 77% |
| acid chelate) | | | |
| [symbol] (from [symbol] amino acid | 25 | mcg | 36% |
| chelate) | | | |
| Copper (from copper [symbol] ) | 0.65 | mg | 50% |
| Manganese (from manganese amino | 0.5 | mg | 10% |
| acid chelate) | | | |
| Chromium (from chromium picolinate) | 50 | mcg | 111% |
| Molybdenum (from molybdenum | 12.5 | mcg | 25% |
| glycinate) | | | |
| Potassium (from potassium chloride) | 50 | mg | 1% |
| Inositol | 250 | mg | [symbol] |

[symbol]

Daily Value not established [symbol]
indicates data missing or illegible when filed

TABLE 20
Prenatal Supplements for 1^{st} Trimester, Serving Two
Supplement Facts
Serving Size 1 Packet (3 capsules, 2 softgels)
Servings Per Container 31

| Amount | % DV for Pregnant | | |
|---|---|---|---|
| Per Serving | and Lactating Women | | |
| Vitamin A (as natural beta carotene and | 1600 mcg | | 123% |
| [symbol] ) | (5,333 IU) | | |
| Vitamin C (from calcium ascorbate) | 75 | mg | 63% |
| Vitamin D3 (as [symbol] ) | 25 mcg (1,000 IU) | | 167% |
| Vitamin E (as natural mixed tocopherols) | 12.5 | mg | 66% |
| Vitamin K (as [symbol] [Vitamin K1] | 45 | mcg | 50% |
| and [symbol] -7 [Vitamin K2]) | | | |
| Vitamin B1 (as thiamine hydrochloride) | 3 | mg | 214% |
| Vitamin B2 (as riboflavin) | 1 | mg | [symbol] |
| Vitamin B3 (as niacin and niacinamide) | 15 | mg | 83% |
| Vitamin B6 (as pyridoxine hydrochloride) | 5 | mg | 250% |
| Folate (as Calcium L-5- | 300 mcg DFE | | 50% |
| Methyltetrahydrofolate [5-MTHF]) | (176.5 mcg | | |
| (Magnafolate [symbol] C) | folic acid) | | |
| Vitamin B12 (as methyl [symbol] ) | 9 | mcg | [symbol] |
| Biotin | 50 | mcg | 143% |
| [symbol] Acid (as d-calcium | 5 | mg | 71% |
| [symbol] ) | | | |
| Choline (from choline bitartrate) | 175 | mg | 32% |
| Calcium (from calcium carbonate) | 162.5 | mg | 13% |
| Iron (from iron [symbol] ) | 15 | mg | 56% |
| Iodine (from potassium [symbol] ) | 110 | mcg | 38% |
| Magnesium (from magnesium | 90 | mg | 23% |
| [symbol] and magnesium malate) | | | |
| Zinc (from zinc sulfate and zinc amino | 10 | mg | 77% |
| acid chelate) | | | |
| [symbol] (from [symbol] amino acid | 25 | mcg | 36% |
| chelate) | | | |
| Copper (from copper [symbol] ) | 0.65 | mg | 50% |
| Manganese (from manganese amino | 0.5 | mg | 19% |
| acid chelate) | | | |
| Chromium (from chromium picolinate) | 50 | mcg | 111% |
| Molybdenum (from molybdenum | 12.5 | mcg | 25% |
| glycinate) | | | |
| Potassium (from potassium chloride) | 50 | mg | 1% |
| Fish Oil Concentrate | 1138 | mg | [symbol] |
| [symbol] acid (DA) | 500 | mg | [symbol] |
| Inositol | 250 | mg | [symbol] |

[symbol]

Daily Value not established [symbol]
indicates data missing or illegible when filed

TABLE 21
Prenatal Supplements for 2^{nd} Trimester, Serving One
Supplement Facts
Serving Size 1 Packet (3 capsules)
Servings Per Container 31

| Amount | % DV for Pregnant | | |
|---|---|---|---|
| Per Serving | and Lactating Women | | |
| Vitamin A (as natural beta carotene and | 1157 mcg | | 89% |
| retinyl [symbol] ) | (3,857 IU) | | |
| Vitamin C (from calcium ascorbate) | 75 | mg | 63% |
| Vitamin D3 (as [symbol] ) | 21.4 mcg (856 IU) | | 143% |
| Vitamin E (as natural mixed tocopherols) | [symbol] | mg | 45% |
| Vitamin K (as [symbol] [Vitamin K1] | 38.6 | mcg | 43% |
| and [symbol] -7 [Vitamin K2]) | | | |
| Vitamin B1 (as thiamine hydrochloride) | 2.57 | mg | 184% |
| Vitamin B2 (as riboflavin) | 0.86 | mg | 54% |
| Vitamin B3 (as niacin and niacinamide) | 15 | mg | 83% |
| Vitamin B6 (as pyridoxine hydrochloride) | 4.29 | mg | 215% |
| Folate (as Calcium L-5- | 257 mcg DFE | | 43% |
| Methyltetrahydrofolate [5-MTHF]) | (151.3 mcg | | |
| (Magnafolate [symbol] C) | folic acid) | | |
| Vitamin B12 (as methyl [symbol] ) | 10.3 | mcg | 368% |
| Biotin | 42.9 | mcg | 123% |
| [symbol] Acid (as d-calcium | 4.29 | mg | 61% |
| [symbol] ) | | | |
| Choline (from choline bitartrate) | 150 | mg | 27% |
| Calcium (from calcium carbonate) | 182.14 | mg | 14% |
| Iron (from iron [symbol] ) | 19.29 | mg | 71% |
| Iodine (from potassium [symbol] ) | 94.3 | mcg | 33% |
| Magnesium (from magnesium | 111.43 | mg | 28% |
| [symbol] and magnesium malate) | | | |
| Zinc (from zinc sulfate and zinc amino | 10.71 | mg | 82% |
| acid chelate) | | | |
| [symbol] (from [symbol] amino acid | 25.7 | mcg | 37% |
| chelate) | | | |
| Copper (from copper [symbol] ) | 0.51 | mg | 39% |
| Manganese (from manganese amino | 0.43 | mg | 17% |
| acid chelate) | | | |
| Chromium (from chromium picolinate) | 42.9 | mcg | 95% |
| Molybdenum (from molybdenum | 10.7 | mcg | 21% |
| glycinate) | | | |
| Potassium (from potassium chloride) | 42.86 | mg | 1% |
| Inositol | 214 | mg | [symbol] |

[symbol]

Daily Value not established [symbol]
indicates data missing or illegible when filed

TABLE 22
Prenatal Supplements for 2^{nd} Trimester, Serving Two
Supplement Facts
Serving Size 1 Packet (4 capsules, 2 softgels)
Servings Per Container 31

| Amount | % DV for Pregnant | | |
|---|---|---|---|
| Per Serving | and Lactating Women | | |
| Vitamin A (as natural beta carotene and | 1543 mcg | | 119% |
| retinyl [symbol] ) | (5143 IU) | | |
| Vitamin C (from calcium ascorbate) | 100 | mg | 83% |
| Vitamin D3 (as [symbol] ) | 28.6 mcg | | 191% |
| | (856 IU) | | |
| Vitamin E (as natural mixed tocopherols) | 11.43 | mg | 66% |
| Vitamin K (as [symbol] [Vitamin K1] | 51.4 | mcg | 57% |
| and [symbol] -7 [Vitamin K2]) | | | |
| Vitamin B1 (as thiamine hydrochloride) | 3.43 | mg | 245% |
| Vitamin B2 (as riboflavin) | 1.14 | mg | 71% |
| Vitamin B3 (as niacin and niacinamide) | 20 | mg | 111% |
| Vitamin B6 (as pyridoxine hydrochloride) | 5.71 | mg | 286% |
| Folate (as Calcium L-5- | 343 mcg DFE | | 57% |
| Methyltetrahydrofolate [5-MTHF]) | (201.7 mcg | | |
| (Magnafolate [symbol] C) | folic acid) | | |
| Vitamin B12 (as methyl [symbol] ) | 13.7 | mcg | 489% |
| Biotin | 57.1 | mcg | 163% |
| [symbol] Acid (as d-calcium | 5.71 | mg | 82% |
| [symbol] ) | | | |
| Choline (from choline bitartrate) | 200 | mg | 36% |
| Calcium (from calcium carbonate) | 242.85 | mg | 19% |
| Iron (from iron [symbol] ) | 25.71 | mg | 95% |
| Iodine (from potassium [symbol] ) | 125.7 | mcg | 43% |
| Magnesium (from magnesium | 148.57 | mg | 37% |
| [symbol] and magnesium malate) | | | |
| Zinc (from zinc sulfate and zinc amino | 14.29 | mg | 110% |
| acid chelate) | | | |
| [symbol] (from [symbol] amino acid | 34.3 | mcg | 49% |
| chelate) | | | |
| Copper (from copper [symbol] ) | 0.69 | mg | 53% |
| Manganese (from manganese amino | 0.57 | mg | 22% |
| acid chelate) | | | |
| Chromium (from chromium picolinate) | 57.1 | mcg | 127% |
| Molybdenum (from molybdenum | 14.3 | mcg | 29% |
| glycinate) | | | |
| Potassium (from potassium chloride) | 57.14 | mg | 1% |
| Fish Oil Concentrate | 1138 | mg | [symbol] |
| Docosahexaenoic acid (DHA) | 500 | mg | [symbol] |
| Inositol | 286 | mg | [symbol] |

[symbol]

Daily Value not established [symbol]
indicates data missing or illegible when filed

### Example 38. Supplements for Pregnant and Lactation Woman: Trimester Three

A prenatal supplement for the third trimester pregnant women is to facilitate and enhance infant's growth spurt and ‘synaptic pruning,’ a process of editing and organizing pathways in the brain for life outside the womb. The supplement included 27 essential and bioavailable vitamins, minerals, and DHA, at levels customized and optimized for the third trimester development. The supplements were packaged into 2 cartons each containing 31 sachets. The sachet labeled as “Serving One” was recommended for daily morning use (see Table 23 for composition), which holds 4 vitamin capsules. The sachet labeled as “Serving Two” was recommended for daily evening use (see Table 24 for composition), which holds 5 vitamin capsules and 2 DHA soft gels. The “Serving One” sachet contained vitamin A at or about 978 mcg (3,260 IU); Vitamin C at or about 89 mg; Vitamin D3 at or about 22.2 mcg (888 IU); Vitamin E at or about 6.67 mg; Vitamin K at or about 40 mcg; Vitamin B1 at or about 2.67 mg; Vitamin B2 at or about 0.89 mg; Vitamin B3 at or about 17.78 mg; Vitamin B6 at or about 4.44 mg; Folate at or about 267 mcg DFE (156.9 mcg folic acid); Vitamin B12 at or about 16 mcg; Biotin at or about 44.4 mcg; Pantothenic Acid at or about 4.44 mg; Choline at or about 266.67 mg; Calcium at or about 233.33 mg; Iron at or about 26.67 mg; Iodine at or about 97.8 mcg; Magnesium at or about 155.56 mg; Zinc at or about 13.33 mg; Selenium at or about 31.1 mcg; Copper at or about 0.49 mg; Manganese at or about 0.44 mg; Chromium at or about 44.4 mcg; Molybdenum at or about 11.1 mcg; Potassium at or about 44.4 mg; and Inositol at or about 222 mg. The “Serving Two” sachet contained Vitamin A at or about 1222 mcg (4,073 IU); Vitamin C at or about 111 mg; Vitamin D3 at or about 27.8 mcg (1.112 IU); Vitamin E at or about 8.33 mg; Vitamin K at or about 50 mcg; Vitamin B1 at or about 3.33 mg; Vitamin B2 at or about 1.11 mg; Vitamin B3 at or about 22.22 mg; Vitamin B6 at or about 5.56 mg; Folate at or about 333 mcg DFE (196.1 mcg folic acid); Vitamin B12 at or about 20 mcg; Biotin at or about 55.6 mcg; Pantothenic Acid at or about 5.56 mg; Choline at or about 333.33 mg; Calcium at or about 291.67 mg; Iron at or about 33.33 mg; Iodine at or about 122.2 mcg; Magnesium at or about 194.44 mg; Zinc at or about 16.67 mg; Selenium at or about 38.9 mcg; Copper at or about 0.61 mg; Manganese at or about 0.56 mg; Chromium at or about 55.6 mcg; Molybdenum at or about 13.9 mcg; Potassium at or about 55.6 mg; Fish Oil Concentrate at or about 1138 mg; Docosahexaenoic acid at or about 500 mg; and Inositol at or about 278 mg. The supplements were recommended to take with water and a meal. The sachets were to be stored in a cool dry place away from direct sunlight.

### Example 39. Supplements for Pregnant and Lactating Women: Trimester Four and Postnatal Care

A prenatal supplement for the fourth and postnatal care provided the right nutrients to ensure complete recovery from baby bearing and birth. It included 27 essential and bioavailable vitamins, minerals, and DHA, at levels customized and optimized for the third trimester development. The supplements were packaged into 1 carton with 31 sachets. Each sachet contained vitamin A at or about 978 mcg (3,260 IU); Vitamin C at or about 89 mg; Vitamin D3 at or about 22.2 mcg (888 IU); Vitamin E at or about 6.67 mg; Vitamin K at or about 40 mcg; Vitamin B1 at or about 2.67 mg; Vitamin B2 at or about 0.89 mg; Vitamin B3 at or about 17.78 mg; Vitamin B6 at or about 4.44 mg; Folate at or about 267 mcg DFE (156.9 mcg folic acid); Vitamin B12 at or about 16 mcg; Biotin at or about 44.4 mcg; Pantothenic Acid at or about 4.44 mg; Choline at or about 266.67 mg; Calcium at or about 233.33 mg; Iron at or about 26.67 mg; Iodine at or about 97.8 mcg; Magnesium at or about 155.56 mg; Zinc at or about 13.33 mg; Selenium at or about 31.1 mcg; Copper at or about 0.49 mg; Manganese at or about 0.44 mg; Chromium at or about 44.4 mcg; Molybdenum at or about 11.1 mcg; Potassium at or about 44.4 mg; Fish Oil Concentrate at or about 569 mg; Docosahexaenoic acid (DHA) at or about 250 mg; and Inositol at or about 222 mg. The sachet was recommended for daily administration (see Table 25 for composition), which holds 4 vitamin capsules and 1 DHA soft gel, which were advised to be taken with water and a meal. The sachet was to be administered to pregnant women in the fourth trimester or post-natal care. The sachet may be administered daily to a woman in the fourth trimester of pregnancy, or in the post-natal care. Women in their fourth trimester or in post-natal care could choose to take the sachet twice daily, e.g., once in the morning and once in the evening. The sachets were to be stored in a cool dry place away from direct sunlight.

TABLE 23
Prenatal Supplements for 3^{rd} Trimester, Serving One
Supplement Facts
Serving Size 1 Packet (3 capsules)
Servings Per Container 31

| Amount | % DV for Pregnant | | |
|---|---|---|---|
| Per Serving | and Lactating Women | | |
| Vitamin A (as natural beta carotene and | 976 mcg | | 75% |
| [symbol] ) | (3,260 IU) | | |
| Vitamin C (from calcium ascorbate) | 89 | mg | 74% |
| Vitamin D3 (as [symbol] ) | 22.2 mcg | | 148% |
| | (888 IU) | | |
| Vitamin E (as natural mixed tocopherols) | 6.67 | mg | 35% |
| Vitamin K (as [symbol] [Vitamin K1] | 40 | mcg | 54% |
| and [symbol] -7 [Vitamin K2]) | | | |
| Vitamin B1 (as thiamine hydrochloride) | 2.57 | mg | 291% |
| Vitamin B2 (as riboflavin) | 0.89 | mg | 56% |
| Vitamin B3 (as niacin and niacinamide) | 17.78 | mg | 99% |
| Vitamin B6 (as pyridoxine hydrochloride) | 4.44 | mg | 222% |
| Folate (as Calcium L-5- | 267 mcg DFE | | 45% |
| Methyltetrahydrofolate [5-MTHF]) | (156.9 mcg | | |
| (Magnafolate [symbol] C) | folic acid) | | |
| Vitamin B12 (as methyl [symbol] ) | 16 | mcg | 571% |
| Biotin | 44.4 | mg | 127% |
| [symbol] Acid (as d-calcium | 4.44 | mg | 63% |
| [symbol] ) | | | |
| Choline (from choline bitartrate) | 266.67 | mg | 48% |
| Calcium (from calcium carbonate) | 233.33 | mg | 18% |
| Iron (from iron [symbol] ) | 26.67 | mg | 99% |
| Iodine (from potassium iodide) | 97.8 | mcg | 34% |
| Magnesium (from magnesium | 155.56 | mg | 39% |
| [symbol] and magnesium malate) | | | |
| Zinc (from zinc sulfate and zinc amino | 13.33 | mg | 103% |
| acid chelate) | | | |
| [symbol] (from [symbol] amino acid | 31.1 | mcg | 44% |
| chelate) | | | |
| Copper (from copper [symbol] ) | 0.49 | mg | 38% |
| Manganese (from manganese amino | 0.44 | mg | 17% |
| acid chelate) | | | |
| Chromium (from chromium picolinate) | 44.4 | mcg | 99% |
| Molybdenum (from molybdenum | 11.1 | mcg | 22% |
| glycinate) | | | |
| Potassium (from potassium chloride) | 44.4 | mg | 1% |
| Inositol | 222 | mg | [symbol] |

[symbol]

Daily Value not established [symbol]
indicates data missing or illegible when filed

TABLE 24
Prenatal Supplements for 3^{rd} Trimester, Serving Two
Supplement Facts
Serving Size 1 Packet (5 capsules, 2 softgels)
Servings Per Container 31

| Amount | % DV for Pregnant | | |
|---|---|---|---|
| Per Serving | and Lactating Women | | |
| Vitamin A (as natural beta carotene and | 1222 mcg | | 94% |
| retinyl [symbol] ) | (4,073 IU) | | |
| Vitamin C (from calcium ascorbate) | 111 | mg | 93% |
| Vitamin D3 (as [symbol] ) | 27.8 mcg | | 185% |
| | (1.112 IU) | | |
| Vitamin E (as natural mixed tocopherols) | 11.43 | mg | 66% |
| Vitamin K (as [symbol] [Vitamin K1] | 51.4 | mcg | 57% |
| and [symbol] -7 [Vitamin K2]) | | | |
| Vitamin B1 (as thiamine hydrochloride) | 3.43 | mg | 245% |
| Vitamin B2 (as riboflavin) | 1.14 | mg | 71% |
| Vitamin B3 (as niacin and niacinamide) | 20 | mg | 111% |
| Vitamin B6 (as pyridoxine hydrochloride) | 5.71 | mg | 286% |
| Folate (as Calcium L-5- | 343 mcg DFE | | 57% |
| Methyltetrahydrofolate [5-MTHF]) | (201.7 mcg | | |
| (Magnafolate [symbol] C) | folic acid) | | |
| Vitamin B12 (as methyl [symbol] ) | 13.7 | mcg | 489% |
| Biotin | 57.1 | mcg | 163% |
| [symbol] Acid (as d-calcium | 5.71 | mg | 82% |
| [symbol] ) | | | |
| Choline (from choline bitartrate) | 200 | mg | 36% |
| Calcium (from calcium carbonate) | 242.85 | mg | 19% |
| Iron (from iron [symbol] ) | 25.71 | mg | 95% |
| Iodine (from potassium [symbol] ) | 125.7 | mcg | 43% |
| Magnesium (from magnesium | 148.57 | mg | 37% |
| [symbol] and magnesium malate) | | | |
| Zinc (from zinc sulfate and zinc amino | 14.29 | mg | 110% |
| acid chelate) | | | |
| [symbol] (from [symbol] amino acid | 34.3 | mcg | 49% |
| chelate) | | | |
| Copper (from copper [symbol] ) | 0.69 | mg | 53% |
| Manganese (from manganese amino | 0.57 | mg | 22% |
| acid chelate) | | | |
| Chromium (from chromium picolinate) | 57.1 | mcg | 127% |
| Molybdenum (from molybdenum | 14.3 | mcg | 29% |
| glycinate) | | | |
| Potassium (from potassium chloride) | 57.14 | mg | 1% |
| Fish Oil Concentrate | 1138 | mg | [symbol] |
| Docosahexaenoic acid (DHA) | 500 | mg | [symbol] |
| Inositol | 286 | mg | [symbol] |

[symbol]

Daily Value not established [symbol]
indicates data missing or illegible when filed

TABLE 25
Prenatal Supplements for 4^{th} Trimester and Postnatal Care
Supplement Facts
Serving Size 1 Packet (4 capsules, 1 softgels)
Servings Per Container 31

| Amount | % DV for Pregnant | | |
|---|---|---|---|
| Per Serving | and Lactating Women | | |
| Vitamin A (as natural beta carotene and | 978 mcg | | 75% |
| retinyl [symbol] ) | (3,260 IU) | | |
| Vitamin C (from calcium ascorbate) | 89 | mg | 74% |
| Vitamin D3 (as [symbol] ) | 22.2 mcg | | 148% |
| | (888 IU) | | |
| Vitamin E (as natural mixed tocopherols) | 6.67 | mg | 35% |
| Vitamin K (as [symbol] [Vitamin K1] | 40 | mcg | 44% |
| and [symbol] -7 [Vitamin K2]) | | | |
| Vitamin B1 (as thiamine hydrochloride) | 2.67 | mg | 191% |
| Vitamin B2 (as riboflavin) | 0.89 | mg | 56% |
| Vitamin B3 (as niacin and niacinamide) | 17.78 | mg | 99% |
| Vitamin B6 (as pyridoxine hydrochloride) | 4.44 | mg | 222% |
| Folate (as Calcium L-5- | 267 mcg DFE | | 45% |
| Methyltetrahydrofolate [5-MTHF]) | (156.9 mcg | | |
| (Magnafolate [symbol] C) | folic acid) | | |
| Vitamin B12 (as methyl [symbol] ) | 16 | mcg | 571% |
| Biotin | 44.4 | mcg | 127% |
| [symbol] Acid (as d-calcium | 4.44 | mg | 63% |
| [symbol] ) | | | |
| Choline (from choline bitartrate) | 266.67 | mg | 48% |
| Calcium (from calcium carbonate) | 233.33 | mg | 19% |
| Iron (from iron [symbol] ) | 26.67 | mg | 99% |
| Iodine (from potassium [symbol] ) | 97.8 | mcg | 34% |
| Magnesium (from magnesium | 155.56 | mg | 39% |
| [symbol] and magnesium malate) | | | |
| Zinc (from zinc sulfate and zinc amino | 13.33 | mg | 103% |
| acid chelate) | | | |
| [symbol] (from [symbol] amino acid | 31.1 | mcg | 44% |
| chelate) | | | |
| Copper (from copper [symbol] ) | 0.49 | mg | 38% |
| Manganese (from manganese amino | 0.44 | mg | 17% |
| acid chelate) | | | |
| Chromium (from chromium picolinate) | 44.4 | mcg | 99% |
| Molybdenum (from molybdenum | 11.1 | mcg | 22% |
| glycinate) | | | |
| Potassium (from potassium chloride) | 44.4 | mg | 1% |
| Fish Oil Concentrate | [symbol] | mg | [symbol] |
| Docosahexaenoic acid (DHA) | 500 | mg | [symbol] |
| Inositol | 286 | mg | [symbol] |

[symbol]

indicates data missing or illegible when filed

### Example 40. Prenatal Supplements Including I MSM, N-Acetylcysteine and/or Lithium

A prenatal supplement is prepared which contains the multiple essential and bioavailable vitamins, minerals, and DHA as disclosed in any of the prior examples, and further comprises methylsulfonylmethane (MSM), n-acetylcysteine, and/or lithium in any combination. The prenatal supplement optionally further comprises MSM in an amount of about 50 mg to about 1000 mg, n-acetylcysteine in an amount of about 20 mg to about 200 mg, and/or lithium in the amount of about 20 mcg to about 1000 mcg.

### STATEMENTS OF THE INVENTION

The invention relates to a nutritional supplement comprising: (a) at least two vitamins selected from: preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol; and at least two minerals selected from: calcium, chromium, copper, iodine, iron, magnesium, manganese, molybdenum, selenium, and zinc; or (b) a sulfur containing compound, a carnitine, and/or lithium, and, optionally, at least one vitamin selected from preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol. In one aspect, the nutritional supplement also comprises (a) at least three vitamins selected from Vitamin C, Vitamin E, choline, DHA, inositol, Vitamin B3 (niacin/niacinamide), pantothenic acid, and Vitamin B6, and at least three minerals selected from calcium, magnesium, iron, and zinc; or (b) at least three vitamins selected from vitamin A, beta carotene, riboflavin, Vitamin D, thiamine, Vitamin K, biotin, folate, Vitamin B12 and at least three minerals selected from copper, iodine, manganese, chromium, molybdenum, and selenium. Yet In one aspect, the nutritional supplement comprises a pair of dosage forms comprising a first dosage form comprising (a) and a second dosage form comprising (b). In one aspect, the nutritional supplement comprises (a) at least two vitamins selected from Vitamin C, choline, DHA, inositol and at least one mineral selected from calcium and magnesium; or (b) at least two vitamins selected from thiamine, Vitamin B3 (niacin/niacinamide), pantothenic acid, Vitamin B6, Vitamin A, beta carotene, riboflavin, Vitamin E and at least two minerals selected from iron, zinc, copper, and manganese; or (c) at least two vitamins selected from Vitamin D, Vitamin K, biotin, folate, Vitamin B12 and at least two minerals selected from chromium, iodine, molybdenum, and selenium. In yet another aspect, the nutritional supplement comprises a triplet of dosage forms comprising a first dosage form comprising (a), a second dosage form comprising (b) and a third dosage form comprising (c). In one aspect, the nutritional supplement comprises (a) preformed vitamin A, vitamin C, vitamin D, Vitamin E, Vitamin K, Vitamin B6, Vitamin B12, beta carotene, thiamine, riboflavin, Vitamin B3 (niacin/niacinamide), pantothenic acid, biotin, folate/folinic acid, choline, inositol, calcium, chromium, copper, iodine, iron, magnesium, manganese, molybdenum, selenium, zinc and, optionally, DHA; or (b) Vitamin C, choline, inositol, Vitamin B3 (niacin/niacinamide), pantothenic acid, Vitamin B6, Vitamin E, calcium, magnesium, iron, zinc, and optionally DHA; or (c) preformed Vitamin A, beta carotene, thiamine, riboflavin, Vitamin D, Vitamin K, biotin, folate/folinic acid, Vitamin B12, copper, manganese, chromium, molybdenum, iodine, and selenium; or (d) Vitamin C, choline, inositol, calcium, magnesium, and, optionally, DHA; or (e) thiamine, Vitamin B3 (niacin/niacinamide), pantothenic acid, Vitamin B6, preformed Vitamin A, Vitamin E, beta carotene, riboflavin, iron, zinc, copper, and manganese; or (f) Vitamin D, Vitamin K, biotin, folate/folinic acid, Vitamin B12, chromium, molybdenum, iodine, and selenium. Yet In one aspect, the nutritional supplement of claim 6 comprising: at least one dosage form comprising any one of (a), (b), (c), (d), (e), or (f). Further, In one aspect, the nutritional supplement comprises a sulfur containing compound, a carnitine, and lithium. In one aspect, the nutritional supplement comprises the sulfur containing compound comprising n-acetylcysteine, sulforaphane, methyl-sufonyl-methane, thiamine tetrahydrofurfuryl disulfide (TTFD), benfotiamine, S-allyl cysteine, Epsom salts, or any combination thereof and/or is present at a concentration of about 100 to about 1000 mg; the carnitine comprises L-carnitine or acetyl-L-carnitine and/or is present at a concentration of about 100 mg to about 2000 mg; and/or the supplement comprises about 100 mcg to about 500 mcg of lithium. The nutritional supplement may further comprise at least one vitamin selected from preformed Vitamin A, Vitamin C, Vitamin D, Vitamin E, Vitamin K, Vitamin B6, and Vitamin B12, beta carotene, thiamine, riboflavin, Vitamin B3 (niacin/niacinamide), pantothenic acid, biotin, folate, choline, DHA, and inositol.

In one aspect, the nutritional supplement comprising from about 1000 to about 10000 IU of preformed Vitamin A, Beta carotene, and/or Vitamin D. In another aspect, the nutritional supplement comprises about 4000 IU (1200 mcg) or about 1666 IU (about 500 mcg) of preformed Vitamin A (retinol), about 3333 IU (2000 mcg), 1666 IU (1000 mcg), or 2500 IU (1500 mcg) of Beta Carotene, and/or about 2000 IU (about 50 mcg) of Vitamin D. In one aspect, the nutritional supplement comprises about 100 to about 1000 mg of DHA, Inositol, and/or choline. In one aspect, the nutritional supplement comprises about 500 mg or 600 mg of DHA, about 500 mg of Inositol, and/or about 350 mg or 600 mg of choline. In one aspect, the nutritional supplement comprises about 50 to 1000 mcg of activated Folate/Folinic acid and/or Biotin. In one aspect, the nutritional supplement comprises about 400 mcg or 600 mcg of activated Folate/Folinic acid and/or about 50 mcg or 100 mcg of Biotin. In one aspect, the nutritional supplement comprises about 100 to 1000 mg of Vitamin C. In one aspect, the nutritional supplement comprises about 100 mg, about 150 mg, about 175 mg, or about 200 mg of Vitamin C. In one aspect, the nutritional supplement comprises about 10 to 100 mcg of Biotin, Vitamin K, and/or Vitamin B12. In one aspect, the nutritional supplement comprises about 50 mcg or 100 mcg of Biotin, about 60 mcg or about 90 mcg of Vitamin K, and/or about 18 mcg, about 24 mcg, about 25 mcg or about 36 mcg of Vitamin B12. In one aspect, the nutritional supplement comprises about 1 to 50 IU (about 0.67 mg to about 33.5 mg) of Vitamin E. In one aspect, the nutritional supplement comprises about 15 mg, about 16 mg, about 19 mg, or about 20 mg of Vitamin E. In one aspect, the nutritional supplement comprises about 1 to 50 mg of pantothenic acid, Vitamin B6, thiamine, riboflavin, and/or Vitamin B3 (niacin/niacinamide). In one aspect, the nutritional supplement comprises about 1 to 10 mg of pantothenic acid, Vitamin B6, thiamine, and/or riboflavin and/or about 15 to 50 mg of Vitamin B3 (niacin/niacinamide). In one aspect, the nutritional supplement comprises about 7 mg or 10 mg of pantothenic acid, about 10 mg of Vitamin B6, about 1.4 mg or 6 mg of thiamine, about 1.4 mg or 2 mg of riboflavin and/or about 18 mg, about 30 mg, 35 mg or about 40 mg of Vitamin B3 (niacin/niacinamide). In one aspect, the nutritional supplement comprises about 100 to 1000 mg of calcium and/or about 100 to 1000 mg magnesium. In one aspect, the nutritional supplement comprises about 200 mg, about 325 mg, about 425 mg, about 525 mg, or about 550 mg of calcium, about/or about 140 mg, about 180 mg, about 260 mg, or about 350 mg of magnesium. In one aspect, the nutritional supplement comprises about 10 to 100 mg of iron and/or about 10 to 100 mg zinc. In one aspect, the nutritional supplement comprises about 25 mg, about 30 mg, about 45 mg, or about 60 mg iron and/or about 10 mg, about 20 mg, about 25 mg, or about 30 mg of zinc. In one aspect, the nutritional supplement comprises about 0.5 to 5 mg of copper and/or about 0.5 to 5 mg manganese. In one aspect, the nutritional supplement comprises about 0.5 mg, about 1.1 mg, about 1.2 mg, or about 1.3 mg of copper and/or about 1 mg of manganese. In one aspect, the nutritional supplement comprises about 10 to 500 mcg of chromium, about 10 to 500 mcg of molybdenum, about 10 to 500 mcg of selenium, and/or about 10 to 500 mcg of iodine. In one aspect, the nutritional supplement comprises about 50 mcg or 100 mcg of chromium, about 25 mcg of molybdenum, about 50 mcg, about 60 mcg or about 70 mcg of selenium, and/or about 150 or 220 mcg of iodine.

In one aspect, the nutritional supplement comprises (I) (a) a single dosage form comprising at least two of the following: about 4000 IU (1200 mcg) or about 1666 IU (about 500 mcg) of preformed vitamin A, about 100 mg, about 150 mg, about 175 mg, or about 200 mg of vitamin C, about 2000 IU (about 50 mcg) of Vitamin D, about 28.5 IU (about 19 mg), about 16 mg, about 20 mg, or about 15 mg of Vitamin E, about 60 mcg or about 90 mcg of Vitamin K, about 10 mg of Vitamin B6, about 25 mcg or about 36 mcg of Vitamin B12, about 3333 IU (about 2000 mcg), about 1666 IU (about 1000 mcg) or about 2500 IU (1500 mcg) of beta carotene, about 1.4 mg or about 6 mg of thiamine, about 1.4 mg or about 2 mg of riboflavin, 18 mg, about 30 mg, 35 mg or about 40 mg of Vitamin B3 (niacin/niacinamide), about 7 mg or 10 mg of pantothenic acid, about 50 mcg or about 100 mcg of biotin, about 400 mcg or 600 mcg of folate/folinic acid, about 350 mg or 600 mg of choline, about 500 mg or 600 mg of DHA, about 500 mg of inositol, about 200 mg, about 325 mg, about 425 mg, about 525 mg, or about 550 mg of calcium, about 50 mcg or 100 mcg of chromium, about 1.3 mg of copper, about 150 mcg or 220 mcg of iodine, about 25 mg, about 30 mg, about 45 mg, or about 60 mg of iron, about 140 mg, about 180 mg, about 260 mg, or about 350 mg of magnesium, about 1 mg of manganese, about 25 mcg of molybdenum, about 60 mcg or about 70 mcg of selenium, and about 10 mg, about 20 mg, about 25 mg, or about 30 mg of zinc; or (II) a pair of dosage forms comprising (b) a first dosage form comprising at least two of the following: about 100 mg, about 150 mg, about 175 mg, or about 200 mg of Vitamin C, about 350 mg or 600 mg of choline, about 500 or 600 mg of DHA, about 500 mg of inositol, about 18 mg, about 30 mg, 35 mg or about 40 mg of Vitamin B3 (niacin/niacinamide), about 28.5 IU (about 19 mg), about 16 mg, about 20 mg, or about 15 mg of Vitamin E, about 7 mg or 10 mg of pantothenic acid, about 10 mg of Vitamin B6, about 200 mg, about 325 mg, about 425 mg, about 525 mg, or about 550 mg of calcium, about 140 mg, about 180 mg, about 260 mg, or about 350 mg of magnesium, about 25 mg, about 30 mg, about 45 mg, or about 60 mg of iron, and about 10 mg, about 20 mg, about 25 mg, or about 30 mg of zinc; and (c) a second dosage form comprising at least two of the following: about 4000 IU (1200 mcg) or about 1666 IU (about 500 mcg) of preformed Vitamin A, about 3333 IU (about 2000 mcg), about 1666 IU (about 1000 mcg) or about 2500 IU (1500 mcg) of beta carotene, about 1400 mcg (1.4 mg) or about 6000 mcg (6 mg) of thiamine, about 1400 mcg (1.4 mg) or 2000 mcg (2 mg) of riboflavin, about 2000 IU (about 50 mcg) of Vitamin D, about 60 mcg or about 90 mcg of Vitamin K, about 50 mcg or about 100 mcg of biotin, about 400 mcg or about 600 mcg of folate/folinic acid, about 25 mcg or about 36 mcg of Vitamin B12, about 1300 mcg (1.3 mg) of copper, about 1000 mcg (1 mg) of manganese, about 50 mcg or about 100 mcg of chromium, about 25 mcg of molybdenum, about 150 or about 220 mcg of iodine, and about 60 mcg or about 70 mcg of selenium; or (III) a triplet of dosage forms comprising (d) a first dosage form comprising at least two of the following: about 100 mg, about 150 mg, about 175 mg, or about 200 mg of Vitamin C, about 350 mg or 600 mg of choline, about 500 or 600 mg of DHA, about 500 mg of inositol, about 200 mg, about 325 mg, about 425 mg, about 525 mg, or about 550 mg of calcium, and about 140 mg, about 180 mg, about 260 mg, or about 350 mg of magnesium; and (e) a second dosage form comprising at least two of the following: about 1.4 mg or about 6 mg of thiamine, about 18 mg, about 30 mg, 35 mg or about 40 mg of Vitamin B3 (niacin/niacinamide), about 7 mg or about 10 mg of pantothenic acid, about 10 mg of Vitamin B6, about 4000 IU (1.2 mg) or about 1666 IU (about 0.5 mg) preformed Vitamin A, about 3333 IU (about 2000 mcg), about 1666 IU (about 1000 mcg) or about 2500 IU (1500 mcg) beta carotene, 28.5 IU (about 19 mg) about 16 mg, about 20 mg, or about 15 mg of Vitamin E, about 1.4 mg or about 2 mg of riboflavin, about 25 mg, about 30 mg, about 45 mg, or about 60 mg of iron, about 10 mg, about 20 mg, about 25 mg, or about 30 mg of zinc, about 1.3 mg of copper, and about 1 mg of manganese; and (f) a third dosage form comprising at least two of the following: about 2000 IU (about 50 mcg) of Vitamin D, about 60 or 90 mcg of Vitamin K, about 50 mcg or about 100 mcg biotin, about 400 or about 600 mcg of folate/folinic acid, about 25 mcg or 36 mcg of Vitamin B12, about 50 mcg or 100 mcg of chromium, about 25 mcg of molybdenum, about 150 mcg or about 220 mcg of iodine, and about 60 mcg or about 70 mcg of selenium; or (IV) any one dosage form according to any one of (b), (c), (d), (e), or (f). In one aspect, the nutritional supplement comprising (a). In one aspect, the nutritional supplement comprising (b). In one aspect, the nutritional supplement comprising (c). In one aspect, the nutritional supplement comprising (d). In one aspect, the nutritional supplement comprising (e). In one aspect, the nutritional supplement comprising (f).

In one aspect, the nutritional supplement comprises at least 500 mcg of retinol (preformed Vitamin A), at least 1000 mcg of beta carotene, at least 100 mg of Vitamin C, at least 50 mcg of Vitamin D, at least 46 mcg of Vitamin K, at least 30 mcg of Vitamin K2, at least 1.4 mg of Vitamin B1 (thiamine hydrochloride), at least 1.4 mg of Vitamin B2 (Riboflavin), at least 18 mg of Niacin, at least 10 mg of pyridoxine hydrochloride (Vitamin B6), at least 400 mcg folinic acid, at least 18 mcg of Vitamin B12, at least 50 mcg of Biotin, at least 7 mg of Pantothenic acid, at least 150 mg of iodine, at least 350 mg of choline, at least 200 mg of Calcium, at least 140 mg of magnesium, at least 10 mg of zinc, at least 50 mcg of selenium, at least 1 mg of manganese, at least 50 mcg of chromium, at least 25 mcg of molybdenum, at least 25 mg of iron, at least 0.5 mg of copper or a combination of any combination thereof. In one aspect, the nutritional supplement comprises at least 1200 mcg of retinol (preformed Vitamin A), at least 2000 mcg of beta carotene, at least 150 mg of Vitamin C, at least 50 mcg of Vitamin D, at least 25 mg of Vitamin E, at least 90 mcg of Vitamin K, at least 6 mg of thiamine (Vitamin B1), at least 2 mg of riboflavin (Vitamin B2), at least 15 mg niacin, at least 15 mg niacinamide, at least 10 mg Vitamin B6, at least 200 mcg activated folate, at least 300 mcg folinic acid, at least 18 mcg Vitamin B12, at least 100 mcg Biotin, at least 10 mg pantothenic acid, at least 220 mcg iodine, at least 350 mg choline, at least 325 mg calcium, at least 180 mg of magnesium, at least 20 mg zinc, at least 50 mg selenium, at least 1 mg manganese, at least 100 mcg chromium, at least 25 mcg molybdenum, at least 30 mg of iron, at least 1.3 mg of copper, at least 500 mg of inositol, or a combination of any thereof.

In one aspect, the nutritional supplement comprises at least 1200 mcg of retinol (preformed Vitamin A), at least 1500 mcg of beta carotene, at least 175 mg of Vitamin C, at least 50 mcg of Vitamin D, at least 20 mg of Vitamin E, at least 90 mcg of Vitamin K, at least 6 mg of thiamine (Vitamin B1), at least 2 mg of Riboflavin (Vitamin B2), at least 15 mg niacin, at least 20 mg niacinamide, at least 10 mg Vitamin B6, at least 300 mcg activated folate (MTHF), at least 300 mcg folinic acid, at least 24 mcg of Vitamin B12, at least 100 mcg of Biotin, at least 10 mg of pantothenic acid, at least 220 mcg of iodine, at least 350 mg of choline, at least 425 mg of calcium, at least 260 mg of magnesium, at least 25 mg of zinc, at least 60 mcg of selenium, at least 1 mg manganese, at least 100 mcg of chromium, at least 25 mcg of molybdenum, at least 45 mg of iron, at least 1.2 mg of copper, at least 500 mg of inositol or any combination thereof.

In one aspect, the nutritional supplement comprises at least 1200 mcg of retinol (Vitamin A, preformed), at least 100 mcg of beta carotene, at least 200 mg of Vitamin C, at least 50 mcg of Vitamin D, at least 15 mg of Vitamin E, at least 90 mcg of Vitamin K, at least 6 mg of thiamine (Vitamin B1), at least 2 mg of riboflavin (Vitamin B2), at least 15 mg niacin, at least 25 mg niacinamide, at least 10 mg of Vitamin B6, at least 300 mcg activated folate (MTHF), at least 300 mcg of folinic acid, at least 36 mcg of Vitamin B12, at least 100 mcg of Biotin, at least 10 mg of pantothenic acid, at least 220 mcg of iodine, at least 600 mg of choline, at least 525 mg of calcium, at least 350 mg of magnesium, at least 30 mg of zinc, at least 70 mcg of selenium, at least 1 mg of manganese, at least 100 mcg of chromium, at least 25 mcg of molybdenum, at least 60 mg of iron, at least 1.1 mg of copper, at least 500 mg of inositol, or any combination thereof.

In one aspect, the nutritional supplement comprises at least 1200 mcg of retinol (preformed Vitamin A), at least 1000 mcg of beta carotene, at least 200 mg Vitamin C, at least 50 mcg of Vitamin D, at least 19 mg of Vitamin E, at least 90 mcg of Vitamin K, at least 6 mg of Vitamin B1, at least 2 mg of Vitamin B2, at least 20 mg of Niacin, at least 15 mg of Niacinamide, at least 10 mg of Vitamin B6, at least 600 mcg of activated folate (MTHF), at least 25 mcg of Vitamin B12, at least 100 mcg of Biotin, at least 10 mg of Pantothenic acid, at least 220 mcg of iodine, at least 350 mg of choline, at least 525 mg Calcium, at least 350 mg magnesium, at least 30 mg of zinc, at least 60 mcg of selenium, at least 1 mg manganese, at least 100 mcg chromium, at least 25 mcg of molybdenum, at least 30 mg of iron, at least 1.3 mg of copper, at least 500 mg of inositol or any combination thereof. In one aspect, the nutritional supplements of above further comprises potassium, such as at least 100 mg of potassium. In one aspect, the nutritional supplement of above further comprising DHA, such as at least 500 mg of DHA. In one aspect, the nutritional supplements of above further comprises one or more sulfur containing compounds. In one aspect, the one or more sulfur containing compounds are selected from the group consisting of cysteine, n-acetylcysteine, sulforaphane, methyl-sufonyl-methane, thiamine tetrahydrofurfuryl disulfide (TTFD), benfotiamine, S-allyl cysteine, and Epsom salts. In one aspects, the nutritional supplement comprises (a) n-acetylcysteine and methyl-sufonyl-methane; (b) at least one of n-acetylcysteine, sulforaphane; or (c) at least one of thiamine tetrahydrofurfuryl disulfide (TTFD), benfotiamine or S-allyl cysteine. In one aspect, the nutritional supplement further comprises ribose. In one aspect, the ribose comprises D-ribose. In one aspect, the nutritional supplement further comprises l-carnitine, acetyl-l-carnitine and/or lithium. In one aspect, the nutritional supplement further comprises a pharmaceutically acceptable carrier or excipient.

In one aspect, the nutritional supplements disclosed herein are formulated for oral administration. In one aspect, the supplement is formulated as a tablet, a pill, or a liquid suspension. In one aspect, the nutritional supplement is used as a dietary supplement for pregnant, nursing, or lactating subjects.

In another aspect, the invention discloses a method of supplementing the diet of a subject who is pregnant, trying to become pregnant, nursing and/or lactating, and the method comprises administering the above nutritional supplements to the subject. In one aspect, the method comprises adjusting the concentration of one or more of the vitamins and/or minerals in the dietary supplement depending on the stage of pregnancy of the subject (preconception to third trimester). In one aspect, the method comprises administering the nutritional supplement daily.

In one aspect, the invention relates to a method for supplementing the diet of a subject who is pregnant, trying to become pregnant, nursing and/or lactating, and the method comprises administering about (a) 4000 IU/day (1200 mcg/day) or about 1666 IU/day (about 500 mcg/day) of preformed vitamin A, about 100 mg/day, about 150 mg/day, about 175 mg/day, or about 200 mg/day of vitamin C, about 2000 IU/day (about 50 mcg/day) of Vitamin D, about 28.5 IU/day (about 19 mg/day), about 16 mg/day, about 20 mg/day, or about 15 mg/day of Vitamin E, about 46 mcg/day or about 90 mcg/day of Vitamin K, about 10 mg/day of Vitamin B6, about 25 mcg/day or about 36 mcg/day of Vitamin B12, about 3333 IU/day (1000 mcg/day), about 6666 IU/day (about 2000 mcg/day) or about 5000 IU/day (1500 mcg/day) of beta carotene, about 1.4 mg/day or about 6 mg/day of thiamine, about 1.4 mg/day or about 2 mg/day of riboflavin, about 18 mg/day, about 30 mg/day, about 35 mg/day or about 40 mg/day of Vitamin B3 (niacin/niacinamide), about 7 mg/day or 10 mg/day of pantothenic acid, about 50 mcg/day or about 100 mcg/day of biotin, about 400 mcg/day or 600 mcg/day of folate/folinic acid, about 350 mg/day or 600 mg/day of choline, about 500 mg/day or 600 mg/day of DHA, about 500 mg/day of inositol, about 200 mg/day, about 325 mg/day, about 425 mg/day, about 525 mg/day, or about 550 mg/day of calcium, about 50 mcg/day or 100 mcg/day of chromium, about 1.3 mg/day of copper, about 150 mcg/day or 220 mcg/day of iodine, about 25 mg/day, about 30 mg/day, about 45 mg/day, or about 60 mg/day of iron, about 140 mg/day, about 180 mg/day, about 260 mg/day, or about 350 mg/day of magnesium, about 1 mg/day of manganese, about 25 mcg/day of molybdenum, about 60 mcg/day or about 70 mcg/day of selenium, and about 10 mg/day, about 20 mg/day, about 25 mg/day, or about 30 mg/day of zinc; or (b) about 100 mg/day to about 1000 mg/day of a sulfur containing compound, about 100 mg/day to about 2000 mg/day of a carnitine and/or about 100 mcg/day to about 500 mcg/day of lithium to the subject.

In one aspect, the method comprises adjusting the amount of preformed vitamin A, amount of Vitamin C, amount of vitamin D, amount of Vitamin E, amount of Vitamin K, amount of Vitamin B6, amount of Vitamin B12, amount of beta carotene, amount of thiamine, amount of riboflavin, amount of niacin, amount of pantothenic acid, amount of biotin, amount of folate, amount of choline, amount of DNA, amount of inositol, amount of calcium, amount of chromium, amount of copper, amount of iodine, amount of iron, amount of magnesium, amount of manganese, amount of molybdenum, amount of selenium, amount of zinc, amount of the sulfur containing compound, amount of carnitine, and/or amount of lithium depending on the stage of pregnancy of the subject (preconception to third trimester). In one aspect, the method further comprises administering one or more sulfur containing compounds to the subject. In one aspect, the one or more sulfur containing compounds are selected from the group consisting of n-acetylcysteine, sulforaphane, methyl-sufonyl-methane, thiamine tetrahydrofurfuryl disulfide (TTFD), benfotiamine, S-allyl cysteine, and Epsom salts and/or the carnitine is selected from l-carnitine or acetyl-l-carnitine. In one aspect, the one or more sulfur containing compounds comprise (a) n-acetylcysteine and methyl-sufonyl-methane; (b) at least one of n-acetylcysteine, or sulforaphane; or (c) at least one of thiamine tetrahydrofurfuryl disulfide (TTFD), benfotiamine or S-allyl cysteine. In one aspect, the method further comprises administering a ribose to the subject. In one aspect, the ribose comprises D-ribose. In one aspect, the method further comprises administering l-carnitine, acetyl-l-carnitine and/or lithium to the subject. In one aspect, the method further comprises administering potassium to the subject. In one aspect, the method further comprises administering DHA to the subject. In one aspect, the method comprises (a) administering a nutritional supplements disclosed above to the subject; or (b) administering the single dosage form, the pair of dosage forms, or the triplet of dosage forms of the above supplements to the subject. In one aspect, the subject is actively trying to become pregnant. In one aspect, the subject is in the first trimester of pregnancy. In another aspect, the subject is in the second trimester of pregnancy. In one aspect, the subject is in the third trimester of pregnancy.

1. A nutritional supplement comprising
Vitamin A at or about 1600 mcg (5,333 IU);
Vitamin C at or about 75 mg;
Vitamin D3 at or about 25 mcg (1,000 IU);
Vitamin E at or about 12.5 mg;
Vitamin K at or about 45 mcg;
Vitamin B1 at or about 3 mg;
Vitamin B2 at or about 1 mg;
Vitamin B3 at or about 15 mg;
Vitamin B6 at or about 5 mg;
Folate at or about 300 mcg DFE (176.5 mcg folic acid);
Vitamin B12 at or about 9 mcg;
Biotin at or about 50 mcg;
Pantothenic Acid at or about 5 mg;
Choline at or about 175 mg;
Calcium at or about 162.5 mg;
Iron at or about 15 mg;
Iodine at or about 110 mcg;
Magnesium at or about 90 mg;
Zinc at or about 10 mg;
Selenium at or about 25 mcg;
Copper at or about 0.65 mg;
Manganese at or about 0.5 mg;
Chromium at or about 50 mcg;
Molybdenum at or about 12.5 mcg;
Potassium at or about 50 mg; and
Inositol at or about 250 mg.

2. The nutritional supplement of claim 1, further comprising:
(a) MSM in an amount from about 50 mg to about 1000 mg;
(b) n-acetylcysteine in an amount from about 20 mg to about 200 mg; and/or
(c) lithium in an amount from about 20 mcg to about 1000 mcg.

3. A nutritional supplement, comprising:
Vitamin A at or about 1600 mcg (5.333 IU);
Vitamin C at or about 75 mg;
Vitamin D3 at or about 25 mcg (1,000 IU);
Vitamin E at or about 12.5 mg;
Vitamin K at or about 45 mcg;
Vitamin B1 at or about 3 mg;
Vitamin B2 at or about 1 mg;
Vitamin B3 at or about 15 mg;
Vitamin B6 at or about 5 mg;
Folate at or about 300 mcg DFE (176.5 mcg folic acid);
Vitamin B12 at or about 9 mcg;
Biotin at or about 50 mcg;
Pantothenic Acid at or about 5 mg;
Choline 175 mg;
Calcium at or about 162.5 mg;
Iron at or about 15 mg;
Iodine at or about 110 mcg;
Magnesium at or about 90 mg;
Zinc at or about 10 mg;
Selenium at or about 25 mcg;
Copper at or about 0.65 mg;
Manganese at or about 0.5 mg;
Chromium at or about 50 mcg;
Molybdenum at or about 12.5 mcg;
Potassium at or about 50 mg;
Fish Oil Concentrate at or about 1138 mg;
Docosahexaenoic acid (DHA) at or about 500 mg; and
Inositol at or about 250 mg.

4. The nutritional supplement of claim 3, further comprising:
(a) MSM in an amount from about 50 to about 1000 mg;
(b) n-acetylcysteine in an amount from about 20 mg to about 200 mg; and/or
(c) lithium in an amount from about 20 mcg to about 1000 mcg.

5. The nutritional supplement of claim 1, wherein the nutritional supplement is formulated as an oral dosage form.

6. A method of providing nutritional supplemental to a subject in preconception or in the first trimester of pregnancy, comprising:
(a) administering daily the nutritional supplement of claim 1 to the subject in the morning; and
(b) administering daily to the subject in the evening a nutritional supplement.
wherein the nutritional supplement, comprising:
Vitamin A at or about 1600 mcg (5.333 IU);
Vitamin C at or about 75 mg;
Vitamin D3 at or about 25 mcg (1,000 IU);
Vitamin E at or about 12.5 mg;
Vitamin K at or about 45 mcg;
Vitamin B1 at or about 3 mg;
Vitamin B2 at or about 1 mg;
Vitamin B3 at or about 15 mg;
Vitamin B6 at or about 5 mg;
Folate at or about 300 mcg DFE (176.5 mcg folic acid);
Vitamin B12 at or about 9 mcg;
Biotin at or about 50 mcg;
Pantothenic Acid at or about 5 mg;
Choline 175 mg;
Calcium at or about 162.5 mg;
Iron at or about 15 mg;
Iodine at or about 110 mcg;
Magnesium at or about 90 mg;
Zinc at or about 10 mg;
Selenium at or about 25 mcg;
Copper at or about 0.65 mg;
Manganese at or about 0.5 mg;
Chromium at or about 50 mcg;
Molybdenum at or about 12.5 mcg;
Potassium at or about 50 mg;
Fish Oil Concentrate at or about 1138 mg;
Docosahexaenoic acid (DHA) at or about 500 mg; and
Inositol at or about 250 mg.

7. A nutritional supplement, comprising
Vitamin A at or about 1157 mcg (3,857 IU);
Vitamin C at or about 75 mg;
Vitamin D3 at or about 21.4 mcg (856 IU);
Vitamin E at or about 8.57 mg;
Vitamin K at or about 38.6 mcg;
Vitamin B1 at or about 2.57 mg;
Vitamin B2 at or about 0.86 mg;
Vitamin B3 at or about 15 mg;
Vitamin B6 at or about 4.29 mg;
Folate at or about 257 mcg DFE (151.3 mcg folic acid);
Vitamin B12 at or about 10.3 mcg;
Biotin at or about 42.9 mcg;
Pantothenic Acid at or about 4.29 mg;
Choline at or about 150 mg;
Calcium at or about 182.14 mg;
Iron at or about 19.29 mg;
Iodine at or about 94.3 mcg;
Magnesium at or about 111.43 mg;
Zinc at or about 10.71 mg;
Selenium at or about 25.7 mcg;
Copper at or about 0.51 mg;
Manganese at or about 0.43 mg;
Chromium at or about 42.9 mcg;
Molybdenum at or about 10.7 mcg;
Potassium at or about 42.86 mg; and
Inositol at or about 214 mg.

8. The nutritional supplement of claim 7, further comprising:
(a) MSM in an amount from about 50 mg to about 1000 mg;
(b) n-acetylcysteine in an amount from about 20 mg to about 200 mg; and/or
(c) lithium in an amount from about 20 mcg to about 1000 mcg.

9. (canceled)

10. (canceled)

11. A method of providing nutritional supplemental to a subject in the 2^{nd} trimester of pregnancy, comprising:
(a) administering daily the nutritional supplement of claim 7 to the subject in the morning; and
(b) administering daily to the subject in the evening a nutritional supplement comprising:
Vitamin A at or about 1543 mcg (5143 IU);
Vitamin C at or about 100 mg;
Vitamin D3 at or about 28.6 mcg (1,144 IU);
Vitamin E at or about 11.43 mg;
Vitamin K at or about 51.4 mcg;
Vitamin B1 at or about 3.43 mg;
Vitamin B2 at or about 1.14 mg;
Vitamin B3 at or about 20 mg;
Vitamin B6 at or about 5.71 mg;
Folate at or about 343 mcg DFE (201.7 mcg folic acid);
Vitamin B12 at or about 13.7 mcg;
Biotin at or about 57.1 mcg;
Pantothenic Acid at or about 5.71 mg;
Choline at or about 200 mg;
Calcium at or about 242.86 mg;
Iron at or about 25.71 mg;
Iodine at or about 125.7 mcg;
Magnesium at or about 148.57 mg;
Zinc at or about 14.29 mg;
Selenium at or about 34.3 mcg;
Copper at or about 0.69 mg;
Manganese at or about 0.57 mg;
Chromium at or about 57.1 mcg;
Molybdenum at or about 14.3 mcg;
Potassium at or about 57.14 mg;
Fish Oil Concentrate at or about 1138 mg;
Docosahexaenoic acid (DHA) at or about 500 mg; and
Inositol at or about 286 mg.

12.-20. (canceled)

21. The nutritional supplement of claim 1, wherein the nutritional supplement is formulated as capsules or softgels.

22. The nutritional supplement of claim 1, wherein
Vitamin A as natural beta carotene and retinyl palmitate;
Vitamin C from calcium ascorbate;
Vitamin D3 as cholecalciferol;
Vitamin E as natural mixed tocopherols;
Vitamin K as phytonadione [Vitamin K1] and menaquinone-7 [Vitamin K2];
Vitamin B1 as thiamine hydrochloride;
Vitamin B2 as riboflavin;
Vitamin B3 as niacin and niacinamide;
Vitamin B6 as pyridoxine hydrochloride;
Folate as Calcium L-5-Methyltetrahydrofolate [5-MTHF];
Vitamin B12 as methylcobalamin;
Pantothenic Acid as d-calcium pantothenate;
Choline from choline bitartrate;
Calcium from calcium carbonate;
Iron from iron bisglycinate;
Iodine from potassium iodide;
Magnesium from magnesium bisglycinate and magnesium malate;
Zinc from zinc sulfate and zinc amino acid chelate;
Selenium from selenium amino acid chelate;
Copper from copper bisglycinate;
Manganese from manganese amino acid chelate;
Chromium from chromium picolinate;
Molybdenum from molybdenum glycinate; or
Potassium from potassium chloride.

23. The nutritional supplement of claim 1, wherein folic acid comprises Calcium L-5-Methyltetrahydrofolate [5-MTHF].

24. A kit comprising 31 sachets of the nutritional supplement of claim 1, a direction of use, and a package of holding both the 31 sachets and the direction of use,
wherein the kit comprises 31 sachets of nutritional supplement of claim 1 when the direction of use is for preconception and the 1^{st} trimester.

25. A method of providing nutritional supplement to a subject, comprising the steps of:
(a) calculating or having calculated the subject's current pregnancy trimester; and
(d1) recommending the nutritional supplement of claim 1, if the subject is in the 1^{st} trimester;
(d2) recommending a first nutritional supplement, if the subject is in the 2^{nd} trimester;
(d3) recommending a second nutritional supplement, if the subject is in the 3^{rd} trimester;
(d4) recommending a third nutritional supplement, if the subject is in the 4^{th} trimester or postnatal care; and
wherein the first nutritional supplement comprising:
Vitamin A at or about 1157 mcg (3,857 IU);
Vitamin C at or about 75 mg;
Vitamin D3 at or about 21.4 mcg (856 IU);
Vitamin E at or about 8.57 mg;
Vitamin K at or about 38.6 mcg;
Vitamin B1 at or about 2.57 mg;
Vitamin B2 at or about 0.86 mg;
Vitamin B3 at or about 15 mg;
Vitamin B6 at or about 4.29 mg;
Folate at or about 257 mcg DFE (151.3 mcg folic acid);
Vitamin B12 at or about 10.3 mcg;
Biotin at or about 42.9 mcg;
Pantothenic Acid at or about 4.29 mg;
Choline at or about 150 mg;
Calcium at or about 182.14 mg;
Iron at or about 19.29 mg;
Iodine at or about 94.3 mcg;
Magnesium at or about 111.43 mg;
Zinc at or about 10.71 mg;
Selenium at or about 25.7 mcg;
Copper at or about 0.51 mg;
Manganese at or about 0.43 mg;
Chromium at or about 42.9 mcg;
Molybdenum at or about 10.7 mcg;
Potassium at or about 42.86 mg; and
Inositol at or about 214 mg;
wherein the second nutritional supplement comprising:
Vitamin A at or about 1222 mcg (4,073 IU);
Vitamin C at or about 111 mg;
Vitamin D3 at or about 27.8 mcg (1,112 IU);
Vitamin E at or about 8.33 mg;
Vitamin K at or about 50 mcg:
Vitamin B1 at or about 3.33 mg;
Vitamin B2 at or about 1.11 mg;
Vitamin B3 at or about 22.22 mg;
Vitamin B6 at or about 5.56 mg;
Folate at or about 333 mcg DFE (196.1 mcg folic acid);
Vitamin B12 at or about 20 mcg;
Biotin at or about 55.6 mcg;
Pantothenic Acid at or about 5.56 mg;
Choline at or about 333.33 mg;
Calcium at or about 291.67 mg;
Iron at or about 33.33 mg;
Iodine at or about 122.2 mcg;
Magnesium at or about 194.44 mg;
Zinc at or about 16.67 mg;
Selenium at or about 38.9 mcg;
Copper at or about 0.61 mg;
Manganese at or about 0.56 mg;
Chromium at or about 55.6 mcg;
Molybdenum at or about 13.9 mcg;
Potassium at or about 55.6 mg;
Fish Oil Concentrate at or about 1138 mg;
Docosahexaenoic acid at or about 500 mg; and
Inositol at or about 278 mg;
AND,
wherein the third nutritional supplement comprising:
Vitamin A at or about 978 mcg (3,260 IU);
Vitamin C at or about 89 mg;
Vitamin D3 at or about 22.2 mcg (888 IU);
Vitamin E at or about 6.67 mg;
Vitamin K at or about 40 mcg;
Vitamin B1 at or about 2.67 mg;
Vitamin B2 at or about 0.89 mg;
Vitamin B3 at or about 17.78 mg;
Vitamin B6 at or about 4.44 mg;
Folate at or about 267 mcg DFE (156.9 mcg folic acid);
Vitamin B12 at or about 16 mcg;
Biotin at or about 44.4 mcg;
Pantothenic Acid at or about 4.44 mg;
Choline at or about 266.67 mg;
Calcium at or about 233.33 mg;
Iron at or about 26.67 mg;
Iodine at or about 97.8 mcg;
Magnesium at or about 155.56 mg;
Zinc at or about 13.33 mg;
Selenium at or about 31.1 mcg;
Copper at or about 0.49 mg;
Manganese at or about 0.44 mg;
Chromium at or about 44.4 mcg;
Molybdenum at or about 11.1 mcg;
Potassium at or about 44.4 mg;
Fish Oil Concentrate at or about 569 mg;
Docosahexaenoic acid (DHA) at or about 250 mg; and
Inositol at or about 222 mg.

26. The method of claim 25, further comprising repeating steps (b) and (c) in a fixed cadence, and making an updated recommendations of (d1) through (d4).

27. The method of claim 26, wherein the fixed cadence is monthly calculated backward from the subject's due date.

28. (canceled)

29. A kit comprising 31 individual doses of the nutritional supplement of claim 7, directions for use during the 2^{nd} trimester.
